(19) United States
(12) Patent Application Publication
(10) Pub. No.: US 2018/0113682 A1
(43) Pub. Date: Apr. 26, 2018

(54) BUILDING CONTROL MANAGER WITH INTEGRATED ENGINEERING TOOL AND CONTROLLER APPLICATION FILE APPLICATION PROGRAM INTERFACE (API)

(71) Applicant: Johnson Controls Technology Company, Milwaukee, WI (US)

(72) Inventors: Jeffrey D. Horvath, Brookfield, WI (US); Dana A. Guthrie, St. Francis, WI (US); Jacob P. Hicks, Milwaukee, WI (US); Shaun M. Bogan, Brown Deer, WI (US); Jason T. Sawyer, Greendale, WI (US)

(73) Assignee: Johnson Controls Technology Company, Milwaukee, WI (US)

(21) Appl. No.: 15/787,874

(22) Filed: Oct. 19, 2017

Related U.S. Application Data
(60) Provisional application No. 62/410,785, filed on Oct. 20, 2016.

(51) Int. Cl. G06F 8/34; G06F 8/71; G06F 8/65; G05B 17/02

(52) U.S. Cl. CPC G06F 8/34; G06F 8/71; G06F 8/65; G05B 15/02; G05B 17/02; G05B 2219/2614; G06F 9/4443

(57) ABSTRACT

A building control system including an engineering tool used to create and load controller application files (CAFs). The engineering tool includes a controller application file manager configured to generate one or more controller application files. The engineering tool further comprises a load manager configured to load the controller application files onto one or more control devices. The engineering tool further comprises a controller application file application programming interface that can be used to build a variety of applications.

### CROSS-REFERENCE TO RELATED PATENT APPLICATION

This application claims the benefit of and priority to U.S. Provisional Application No. 62/410,785 filed Oct. 20, 2016, the entire disclosure of which is incorporated by reference herein.

### BACKGROUND

The present disclosure relates generally to building management systems and associated devices. The present disclosure relates more particularly to Building Control Manager (BCM) systems for providing for management and control of HVAC, lighting, power, and other building subsystems in smaller building or facilities that do not need a full Building Automation System (BAS) installed.

A building management system (BMS) is, in general, a system of devices configured to control, monitor, and manage equipment in or around a building or building area. A BMS can include a heating, ventilation, and air conditioning (HVAC) system, a security system, a lighting system, a fire alerting system, another system that is capable of managing building functions or devices, or any combination thereof. BMS devices can be installed in any environment (e.g., an indoor area or an outdoor area) and the environment can include any number of buildings, spaces, zones, rooms, or areas. A BMS can include a variety of devices (e.g., HVAC devices, controllers, chillers, fans, sensors, etc.) configured to facilitate monitoring and controlling the building space. Throughout this disclosure, such devices are referred to as BMS devices or building equipment.

In some buildings or facilities, a full featured BAS system, such as a Metasys system from Johnson Controls, may not be desired or cost effective. For example, small facilities such as warehouses, small manufacturing sites, regional clinics, etc., may require a system to provide automation and/or control over HVAC or other subsystems of the building. Thus, a scalable BAS system for smaller installations is desirous. Further, in some instances, other engineering or commissioning tools are already used in the above mentioned facilities. Thus, a scalable BAS with accessible engineering tools is further desired for ease of use in existing systems.

### SUMMARY

One implementation of the present disclosure is a building control system. The system includes a database and a processing circuit in communication with the database. The processing circuit includes an engineering tool. The engineering tool includes a controller application file manager configured to generate one or more controller application files.

Another implementation of the present disclosure is a building control system. The system includes a database and a processing circuit in communication with the database. The processing circuit includes an engineering tool. The engineering tool further comprises a load manager configured to load the controller application files into one or more control devices.

Yet another implementation of the present disclosure is a method of configuring a building control system. The method includes determining a list of parameters associated with a building control system and importing the list of parameters into an engineering tool. The method further comprises generating and loading one or more controller application files.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building equipped with a HVAC system, according to an exemplary embodiment.

FIG. 2 is a block diagram of a waterside system that may be used in conjunction with the building of FIG. 1, according to an exemplary embodiment.

FIG. 3 is a block diagram of an airside system that may be used in conjunction with the building of FIG. 1, according to an exemplary embodiment.

FIG. 4 is a block diagram of a building management system (BMS) that may be used to monitor and/or control the building of FIG. 1, according to an exemplary embodiment.

FIG. 5 is a block diagram illustrating a typical building control manager (BCM) system, according to some embodiments.

FIG. 6 is a block diagram illustrating a further embodiment of the BCM of FIG. 5.

FIG. 7 is a flow chart illustrating a workflow of the BCM of FIG. 5, according to some embodiments.

FIG. 8 is a block diagram illustrating the BCM ET of FIG. 5, according to some embodiments.

FIG. 9 is a flow chart illustrating a basic workflow of the BCM ET of FIG. 8, according to some embodiments.

FIG. 10 is a block diagram of a BCM core, according to some embodiments.

FIG. 11 is a block diagram illustrating a typical BCM, according to some embodiments.

FIG. 12 is a block diagram illustrating a BCM with a single workstation, according to some embodiments.

FIG. 13 is block diagram illustrating multiple BCM types, according to some embodiments.

FIG. 14 is a block diagram illustrating a detailed view of a BCM UI, according to some embodiments.

FIG. 15 is a block diagram illustrating a further embodiment of the BCM UI of FIG. 14, according to some embodiments.

FIG. 16 is a block diagram illustrating a further embodiment of the BCM UI of FIG. 14, according to some embodiments.

FIG. 17 is a block diagram illustrating yet a further embodiment of the BCM UI of FIG. 14, according to some embodiments.

FIG. 18 is a block diagram illustrating a BCM backup process, according to some embodiments.

FIG. 19A is a flow chart illustrating a process for generating Controller Application Files (CAFs), according to some embodiments.

FIG. 19B is a block diagram illustrating a set of libraries containing redistributable logic and data, according to some embodiments.

FIG. 19C is a flow chart illustrating a process for loading Controller Application Files (CAFs), according to some embodiments.

FIG. 20 is a flow chart illustrating a process for performing a network view on an online ET is shown, according to some embodiments.

FIG. 21 is a flow chart illustrating a process for updating point values on UI is shown, according to some embodiments.

FIG. 22 is a flow chart illustrating a process for a device discovery process, according to some embodiments.

FIG. 23 is a process chart for generating a project is shown, according to some embodiments.

FIG. 24 is a flow chart illustrating a process for adding an interlock is shown, according to some embodiments.

FIG. 25 is a screenshot illustrating an administrative module interface of the ET is shown, according to some embodiments.

FIG. 26 is a screenshot illustrating the user role interface, according to some embodiments.

FIG. 27 is a screenshot illustrating a systems interface of a master module of the ET, according to some embodiments.

FIG. 28 is a screenshot illustrating a system type sub tab of the systems interface, according to some embodiments.

FIG. 29 is a screenshot illustrating the components and sub-components tab, according to some embodiments.

FIG. 30 is a screenshot illustrating a parameter I/O port interface, according to some embodiments.

FIGS. 31 and 32 are a screenshot illustrating a mapped parameter list of the parameter I/O port interface, according to some embodiments.

FIG. 33 is a screenshot illustrating a device interface, according to some embodiments.

FIG. 34 is a screenshot illustrating the controller interface, according to some embodiments.

FIG. 35 is a screenshot illustrating the Router/Gateway interface, according to some embodiments.

FIG. 36 is a screenshot illustrating a profiles interface, according to some embodiments.

FIG. 37 is a screenshot illustrating a profile view, reflecting previously added profiles.

FIG. 38 is a screenshot illustrating an active project list interface, according to some embodiments.

FIG. 39 is a screenshot illustrating an archived project list interface, according to some embodiments.

FIG. 40 is a screenshot illustrating a new project information interface, according to some embodiments.

FIG. 41 is a screenshot illustrating an embodiment of the new project information interface, according to some embodiments.

FIG. 42 is a screenshot illustrating an equipment information interface of the engineering module, according to some embodiments.

FIG. 43 is a screenshot illustrating an add equipment interface, according to some embodiments.

FIG. 44 is a screenshot illustrating a maximized view of one equipment type, according to some embodiments.

FIGS. 45-47 are screenshots illustrating adding equipment via the maximized view of FIG. 44, according to some embodiments.

FIG. 48 is a screenshot illustrating an I/O point configuration table, according to some embodiments.

FIG. 49 is a screenshot illustrating a pop up display, according to some embodiments.

FIG. 50 is a screenshot illustrating a sequence of operations pop-up screen, according to some embodiments.

FIG. 51 is a screenshot illustrating a group configuration sub tab, according to some embodiments.

FIG. 52 is a screenshot illustrating a further expanded equipment type interface, according to some embodiments.

FIG. 53 is a screenshot illustrating an expanded equipment type interface as shown in FIG. 52.

FIG. 54 is a screenshot illustrating an equipment summary interface, according to some embodiments.

FIG. 55 is a screenshot illustrating a panel information interface, according to some embodiments.

FIG. 56 is a screenshot illustrating a network information interface, according to some embodiments.

FIG. 57 is a screenshot illustrating a network definition interface, according to some embodiments.

FIG. 58 is a screenshot illustrating a room schedule interface, according to some embodiments.

FIG. 59 is a screenshot illustrating a submittal section, according to some embodiments.

FIG. 60 is a screenshot illustrating a control process interface, according to some embodiments.

FIG. 61 is a screenshot illustrating a load, update CAF file inputs of the control process interface, according to some embodiments.

FIG. 62 is a screenshot illustrating a manual logic entry interface, according to some embodiments.

FIG. 63 is a screenshot illustrating a schedule view tab, according to some embodiments.

FIG. 64 is a screenshot illustrating an all items tree tab, according to some embodiments.

FIG. 65 is a screenshot illustrating a global data sharing object interface, according to some embodiments.

FIG. 66 is a screenshot illustrating a signal selection object interface, according to some embodiments.

FIG. 67 is a screenshot illustrating an interlock object interface, according to some embodiments.

FIG. 68 is a screenshot illustrating a number of logic types, according to some embodiments.

FIG. 69 is a screenshot illustrating a user of a number of the logic types of FIG. 68, according to some embodiments.

FIG. 70 is a screenshot illustrating a MCO object interface, according to some embodiments.

FIG. 71 is a screenshot illustrating a view/edit screen of the MCO object interface of FIG. 70, according to some embodiments.

FIG. 72 is a screenshot illustrating a calendar object interface, according to some embodiments.

FIG. 73 is a screenshot illustrating a BCM UI home screen, according to some embodiments.

FIG. 74 is a screenshot illustrating a floor plan interface of the BCM UI, according to some embodiments.

FIG. 75 is a screenshot illustrating a detailed equipment view, according to some embodiments.

FIG. 76 is a screenshot illustrating a change background user interface, according to some embodiments.

FIG. 77 is a screenshot illustrating a floor summary interface of the BCM UI, according to some embodiments.

FIG. 78 is a screenshot illustrating a zone details interface, according to some embodiments.

FIG. 79 is a screenshot illustrating a schedule interface, according to some embodiments.

FIG. 80 is a screenshot illustrating a global data interface, according to some embodiments.

### DETAILED DESCRIPTION

Referring generally to the FIGURES, systems, devices and methods for integrating BMS devices into a BMS network are described, according to various exemplary embodiments. The devices, systems and methods described herein may be used to integrate one or more network devices onto a BMS network such as BACnet. A network interface controller may be used to provide the communication with the BMS device. The network interface controller can include a device interface for interfacing with the BMS device and a network interface for interfacing with a network. The network interface controller may communicate with the host device via a communication interface, such as a universal asynchronous receiver/transmitter. The device interface may have an equipment object which can include all of the desired parameters from the BMS device. Data associated with the BMS device may be provided to the equipment object via the communication interface. The equipment object may allow for the network interface to map standard network objects to the attributes in the equipment object. The network interface controller may further include control logic for controlling the host device.

### Building Management System and HVAC System

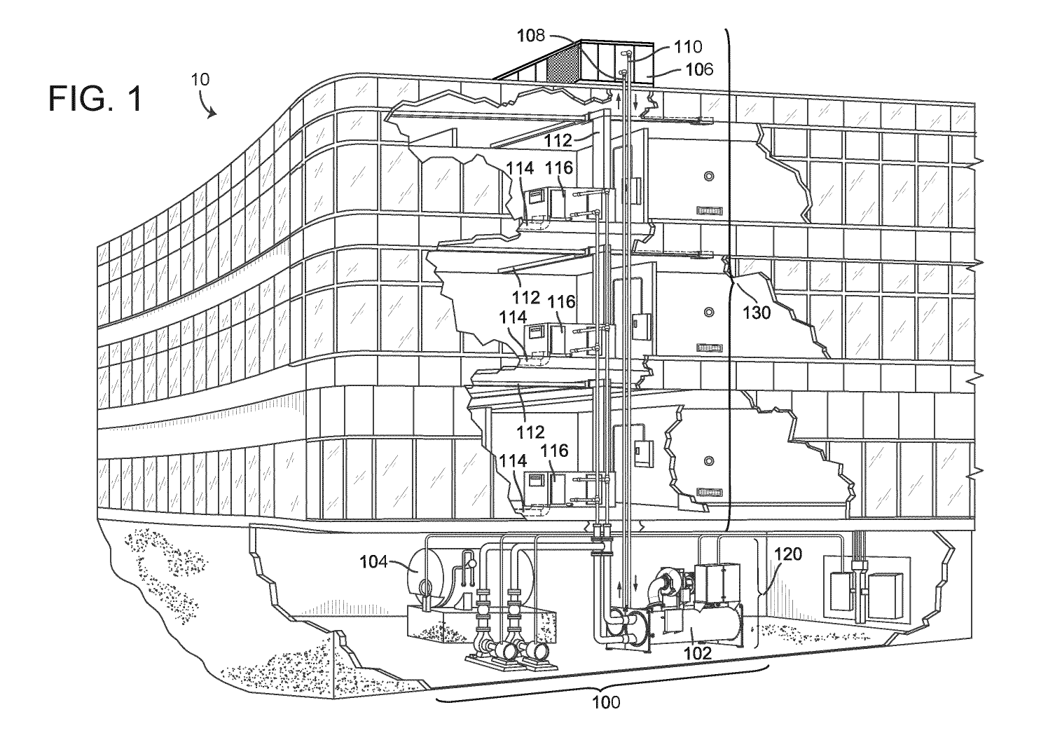

Referring now to FIGS. 1-4, an exemplary building management system (BMS) and HVAC system in which the systems and methods of the present invention may be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, an HVAC system, a security system, a lighting system, a fire alerting system, or any other system that is capable of managing building functions or devices, or any combination thereof.

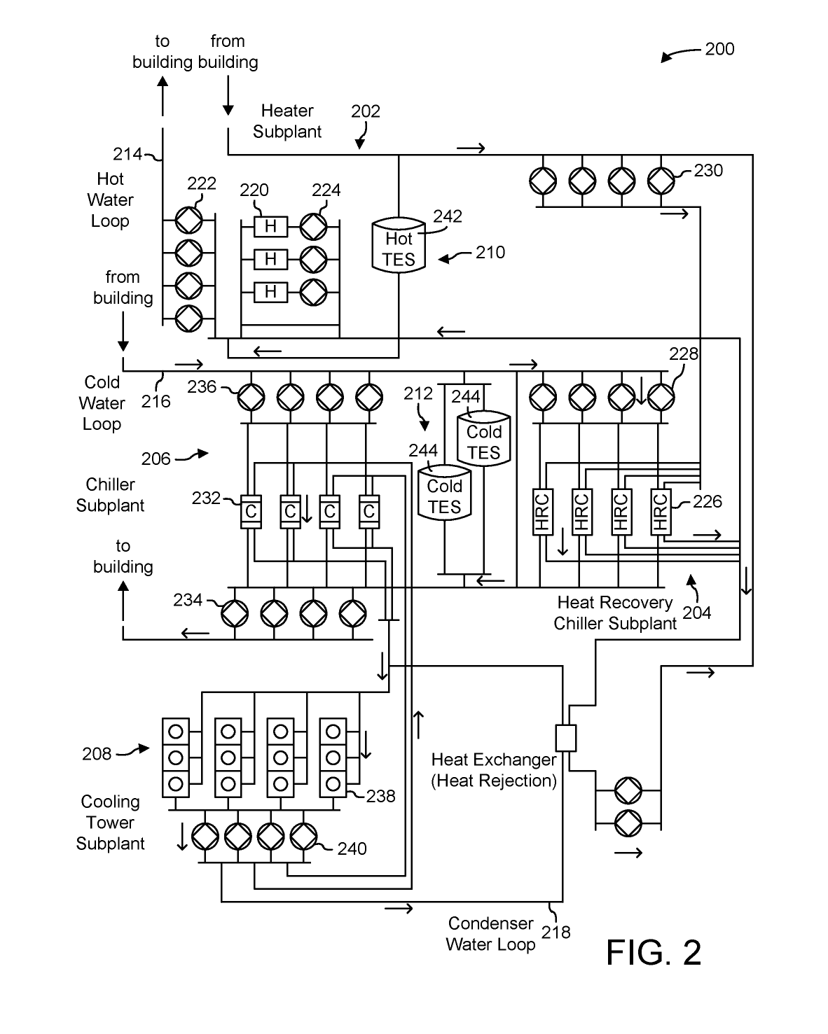

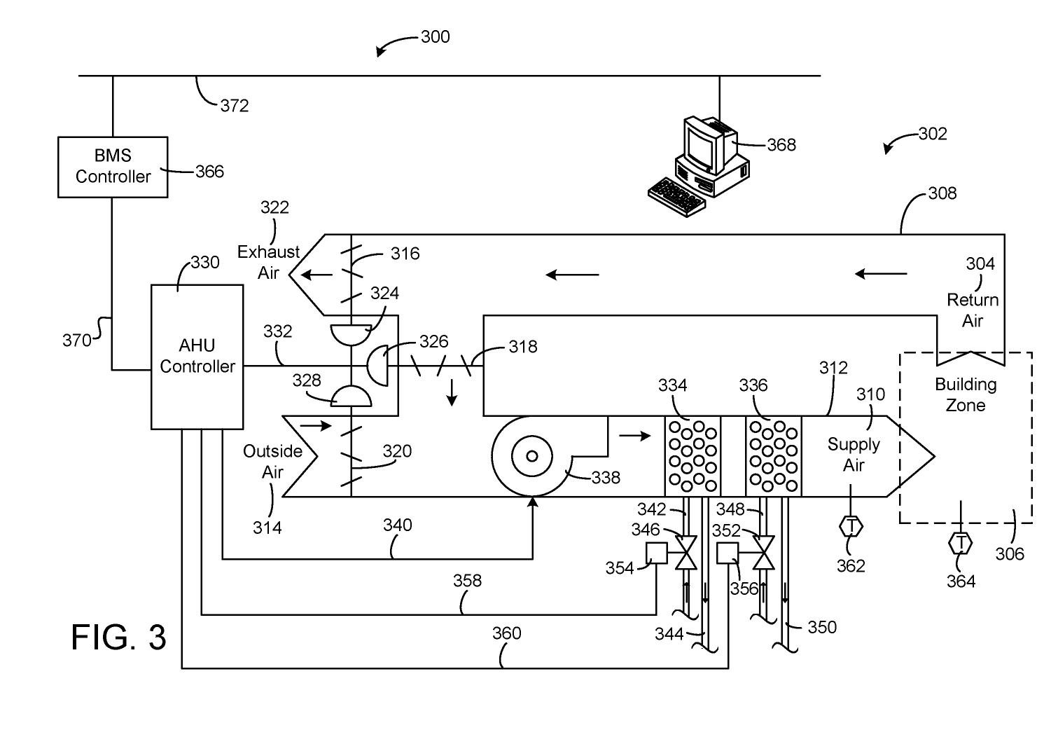

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a waterside system 200 is shown, according to some embodiments. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between the chiller subplant 206 and the building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

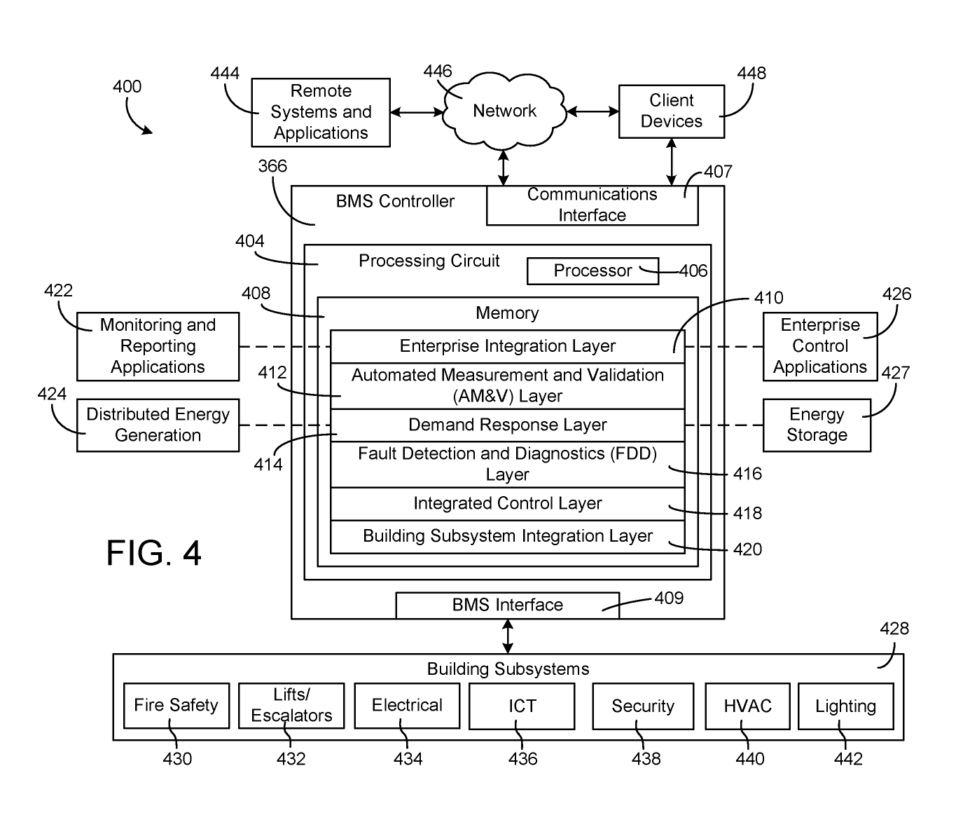

Referring now to FIG. 4, a block diagram of a building management system (BMS) 400 is shown, according to an exemplary embodiment. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 may be distributed across multiple servers or computers (e.g., that can exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Building Control Manager

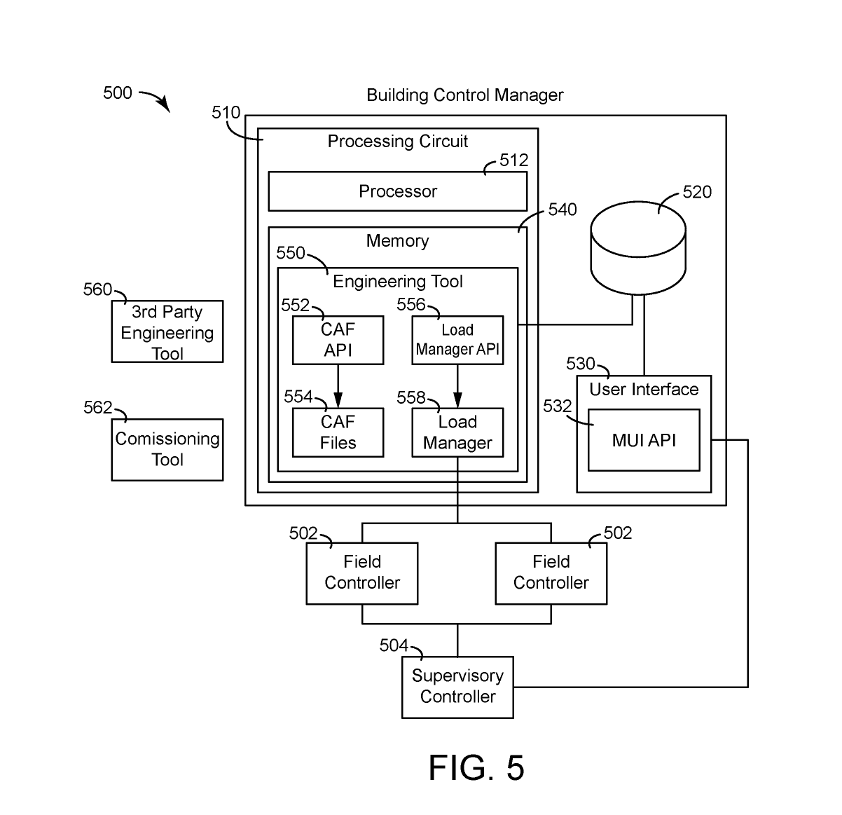

Referring now to FIG. 5, a block diagram illustrating a typical building control manager system is shown, according to an exemplary embodiment. The system can include a building control manager 500 (BCM), one or more field controllers 502, and a supervisory controller 504. BCM 500 can also include a processing circuit 510, a database 520, and a user interface 530. In one embodiment, BCM 500 is a server or other dedicated device. For example, BCM 500 may be a server, which can be accessed via one or more devices. As another example, BCM 500 may be accessed via a workstation, such as a personal computer (PC) or other dedicated device. In some embodiments, BCM 500 may be accessed via a mobile device, such as a laptop computer, a tablet computer (iPad, Android tablet, etc.), smartphone (iPhone, Windows Phone, Android phone, etc.), or a dedicated interface device.

Processing circuit 510 can include a processor 512 and a memory 540. Processor 512 may be a general purpose or specific purpose processor, an application specific integrated circuit (ASIC), one or more field programmable gate arrays (FPGAs), a group of processing components, or other suitable processing components. Processor 512 can be configured to execute computer code or instructions stored in memory 540 or received from other computer readable media (e.g., CDROM, network storage, a remote server, etc.).

Memory 540 may include one or more devices (e.g., memory units, memory devices, storage devices, etc.) for storing data and/or computer code for completing and/or facilitating the various processes described in the present disclosure. Memory 540 may include random access memory (RAM), read-only memory (ROM), hard drive storage, temporary storage, non-volatile memory, flash memory, optical memory, or any other suitable memory for storing software objects and/or computer instructions. Memory 540 may include database components, object code components, script components, or any other type of information structure for supporting the various activities and information structures described in the present disclosure. Memory 540 may be communicably connected to processor 512 via processing circuit 510 and may include computer code for executing (e.g., by the processor) one or more processes described herein. When processor 512 executes instructions stored in memory 540, processor 512 generally configures a network interface device (and more particularly the processing circuit) to complete such activities.

In one embodiment, memory 540 includes an engineering tool 550. Engineering tool 550 may be used to configure BCM 500. In some embodiments, engineering tool 550 may act as a single tool to configure a BCM job site. For example, engineering tool 550 can configure a workstation, generate one or more controller application files (CAFs), and download the CAFs to one or more other devices, as described below. In one embodiment, engineering tool 550 includes one or more CAFs 554, a CAF application program interface (API) 552, a load manager 558, and a load manager API 556. A CAF 554 can be used to operate a field controller 502. For example, a CAF 554 may include control logic, operating parameters, data values, timers, schedules, or other data required to operate a field controller 502. In one embodiment, CAFs 554 are used to control the work flow of one or more of field devices. In some embodiments, CAFs 554 are proprietary files, and are generated by engineering tool 550. CAF API 552 can be used to allow other engineering tools, such as a 3^{rd} party engineering tool 560 and/or a commissioning tool 562, to generate CAFs 554 using BCM 500, without having to use a proprietary tool to do so. CAF API 552 may further allow for 3^{rd} party engineering tool 560 and/or commissioning tool 562 to modify existing CAFs 554. Further, CAF API 552 may allow for access to CAFs 554 by other devices or tools. This interoperability can be advantageous when different installations use different workflows than the workflows typically associated with the CAFs 554.

Third party engineering tool 560 can be any engineering tool associated with an entity other than the entity associated with the BCM 500. For example, third party engineering tool 560 can be an existing tool used to control portions of an existing HVAC, or other building system. The commissioning tool 562 may be any tool used to configure a BMS or BCM system. In one embodiment, commissioning tool 562 is a MAP gateway from Johnson Controls. The MAP gateway may run a CCT commissioning program from Johnson Controls to configure one or more CAFs.

Load manager 558 can be configured to load CAFs 554 onto one or more field controllers 502. Load manager API 556 can be configured to work with different field controllers 502 to allow load manager 558 to load CAFs 554 onto field controllers 502 of different types, and/or using different operating systems, firmware, etc. Database 520 can include data relevant to the creation of the CAFs 554, as well as basic data related to the operation of BCM 500. Further, data provided to BCM 500 when generating a CAF may be stored in database 520 as well. Database 520 can further include object data, device data, and/or other data related to BCM 500, as well as field controllers 502 and/or supervisory controllers 504. Additionally, database 520 can further include security information, such as user roles and permissions, that are associated with one or more users.

BCM 500 can further include a user interface 530. User interface 530 can provide a visual interface to a user along with one or more input devices. In one embodiment, the user interface is a workstation, such as a personal computer. The workstation may be a fixed computer, such as a desktop, or a mobile computer such as a laptop. In some embodiments, user interface 530 can be integrated directly into the BCM 500. In further embodiments, user interface 530 can be a mobile device, such as a tablet computer (iPad, Android tablet), smartphone (iPhone, Windows Phone, Android phone, etc.) or other mobile device in communication with BCM 500. In some embodiments, user interface 530 can include a multiple user interface (MUI) API 532. MUI API 532 can be used to allow additional user interfaces, such as mobile devices or a user interface associated with a supervisory controller 504, to access user interface 530 of BCM 500 via a separate interface. MUI API 532 can allow BCM 500 to provide a scalable user interface for use with multiple types of user interfaces. In some embodiments, MUI API 532 can allow other devices, such as supervisory controller 504 or another user interface, to directly access BCM user interface 530 and provide visibility into the BAS/BCM user interfaces. For example, MUI API 532 can allow a remote user interface to access a Metasys (Johnson Controls) UI associated with BCM 500.

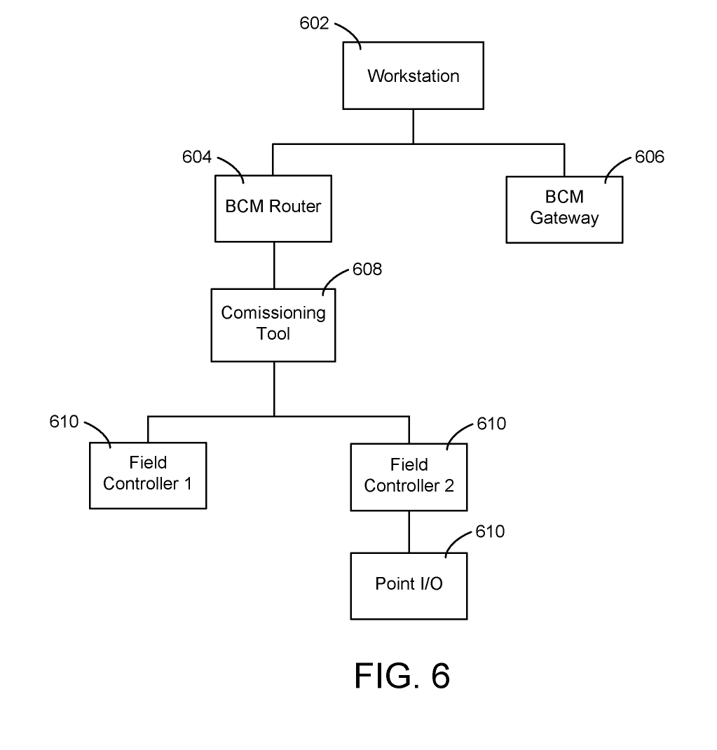

Turning now to FIG. 6, a further embodiment of a BCM (such as BCM 500) can be seen. The BCM system can include a workstation 602, a BCM router 604, a BCM gateway 606, a commissioning tool 608, a number of field controllers 610, and an I/O module 612. Workstation 602 can be a BCM UI server, such as described above. In one embodiment, workstation 602 can be configured to provide historical data storage, tending/alarming for third party devices, as well as BCM compatible devices, time synchronization, and/or BACnet communications. BCM router 604 can be configured to provide BACnet IP to MSTP communication routing. BCM gateway 606 can be used to connect the workstation to other networks. For example, BCM gateway 606 can be configured to convert from a proprietary network, such as Modbus, to a BACnet. Commissioning tool 608 can be used to commission field controllers 610. In one embodiment, commissioning tool 608 is a MAP gateway device from Johnson Controls. The BCM system is further shown to include a first network and a second network. The first network can be a BACnet/IP network. The second network may be a controller level network, such as BACnet/MSTP. As described above, BCM router 604 may provide an interface between the first network and the second network.

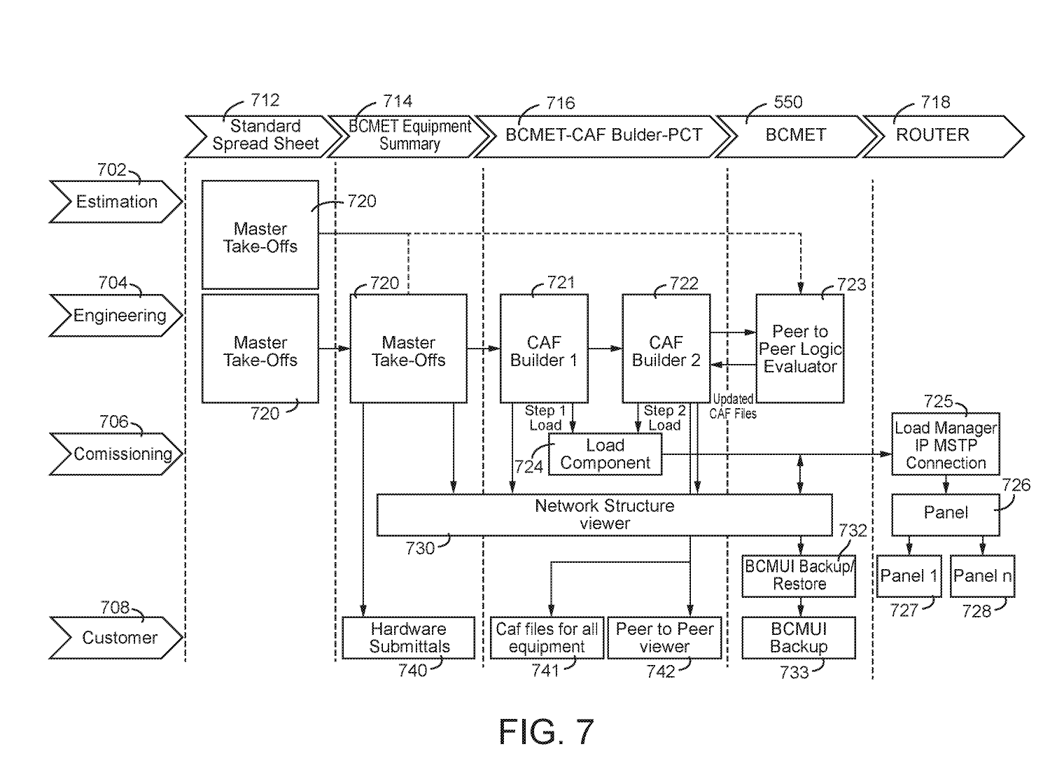

Turning now to FIG. 7, a flow diagram illustrating a BCM (such as BCM 500) system workflow is shown, according to some embodiments. The workflow is divided into four phases: estimation phase 702, engineering phase 704, commissioning phase 706, and customer phase 708. During estimation phase 702, a standard spreadsheet 712 can be generated to estimate system details, and can be referred to as a Master Take-Offs sheet 720. Master Take-Offs sheet 720 can include information such as equipment definitions, floor locations, a list of what the equipment is serving, I/O counts, and controller selections. This list can be determined based on the needs of the system to be implemented. Master Take-Offs sheet 720 can then be provided to engineering phase 704. Master Take-Offs sheet 720 can be imported into a BCM engineering tool (BCMET) 550.

Once BCMET 550 has received Master Take-Offs sheet 720, BCMET 550 can utilize one or more CAF builders to generate CAF files. In the CAF builder-1 phase 721, the CAF is provided with I/O allocation edges for all equipment objects associated with the CAF. Further, trends and/or alarms may be totalized. At CAF builder-2 phase 722, CAFs with basic logic are generated. In some embodiments, CAF builder 716 may utilize peer to peer logic editor 723 of BCMET 550 to provide value passing, signal selection, and interlocks to the logic, as will be described in more detail below. Peer to peer logic editor 723 can receive Master Take-Offs sheet 720 for generating logic. Once the CAFs have been completed by the BCMET-CAF builder 716, the CAFs can be loaded into one or more devices via load component 724. In some embodiments, load component 724 loads the CAFs onto one or more devices, such as panels 726, 727, and 728 via load manager 725. Load manager 725 can be configured to provide an IP to MSTP connection via a router 718 to the devices from the BCM.

During commissioning phase 706, CAFs can be loaded onto a network structure viewer 730 for viewing by a user. For example, network structure viewer 730 can generate a view of an entire BMS network including all devices and controllers. In some embodiments, CAF builder 716 can directly load CAF files onto network structure viewer 730. In other embodiments, the load component 724 can load the CAFs onto network structure viewer 730. In some embodiments, network structure viewer 730 can be in communication with a workstation and/or a user interface associated with the BCM (such as BCM UI 530) to display a network structure to a viewer. Network structure viewer 730 can further pass CAF information to a BCMUI backup/restore module 732 to perform a BCMUI backup 733. The BCMUI backup may then save the most recent network structure.

In customer phase 708, a BCMET equipment summary 714 can convert a Master Take-Offs sheet 720 into one or more hardware submittals 740 to be provided to a customer. Further, CAFs 741 for all devices and equipment as well as a peer to peer viewer 742 can be generated and provided to a customer as well. For example, the CAFs 741 may be provided to the user as a data file.

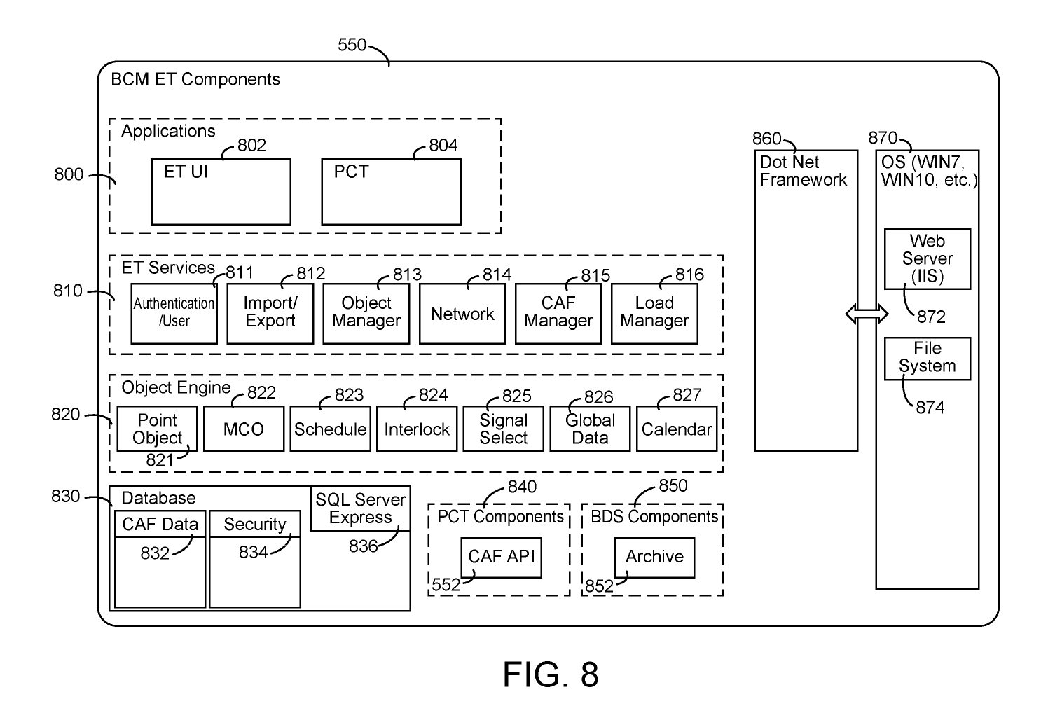

Turning now to FIG. 8, a more detailed view of a BCM engineering tool 550 is shown, according to some embodiments. BCM ET 550 is shown to include an applications module 800, an ET services module 810, an object engine module 820, a database module 830, one or more PCT components 840, one or more BDS components 850, a Dot Net framework 860 and an operating system (OS) 870. Applications module 800 may include an engineering tool user interface (ET UI) 802 and a PCT module 804. ET services module 810 can include an authentication/user permissions module 811, an import/export module 812, an object manager module 813, a network module 814, a CAF manager module 815, and a load manager module 816. Application/user permissions module 811 can provide authentication APIs. Application/user permissions module 811 can further provide creation and setup of permission APIs. Import/export module 812 can be configured to handle importing and exporting of an engineering input sheet (i.e., Master Take-Offs sheet 720) into ET 550. Import/export module 812 can further add necessary data into database 520, as described with reference to FIG. 5. Furthermore, import/export module 812 can be configured to process validation of data entered by a user (e.g., an engineer).

Object manager module 813 can be configured to allow a user to setup peer to peer connections using one or more objects within object engine 820. In one embodiment, object manager 813 can be configured to use global data objects, signal select objects, and interlock objects to setup peer to peer connections. Network module 814 can be configured to take care of organizing points, controllers and router information into a tree like structure. For example, if a user were to select a node associated with the system, network module 814 could provide details associated with the selected node. CAF manager 815 can be configured to interface with the CAF API 552. CAF manager 815 can further be configured to generate CAFs 554. Finally, load manager module 816 can be configured to transfer the CAFs 554 onto field controllers 502 and/or other devices associated with the system.

Object engine 820 can include one or more objects associated with the system. In one embodiment, object engine 820 includes point objects 821, MCD objects 822, schedule objects 823, interlock objects 824, signal select objects 825, global data objects 826, and calendar objects 827. The database 830 can include CAF data 832 and security data 834. CAF data 832 can include controller data, equipment data, and points data. Security data 834 can include user data, user roles, and user permissions. Database 830 can further include an SQL server express module 836 to allow database 830 to operate as a SQL database. PCT components 840 can include CAF API 552, as described above. BDS components 850 can include an archive 852 for storing backup information related to a BMS (e.g., BMS 400). Dot Net framework 860 can communicate with OS module 870 to provide an interface to BCM engineering tool 550. In one embodiment, OS module 870 can be a Microsoft operating system such as Windows 7, Windows 10, etc. However, other operating systems, such as those from Apple, Linux, Android, or other providers is also contemplated. OS module 870 can further include a webserver 872 and one or more file systems 874. Webserver 872 can be configured to allow BCM engineering tool 550 to be accessed via an internet connection.

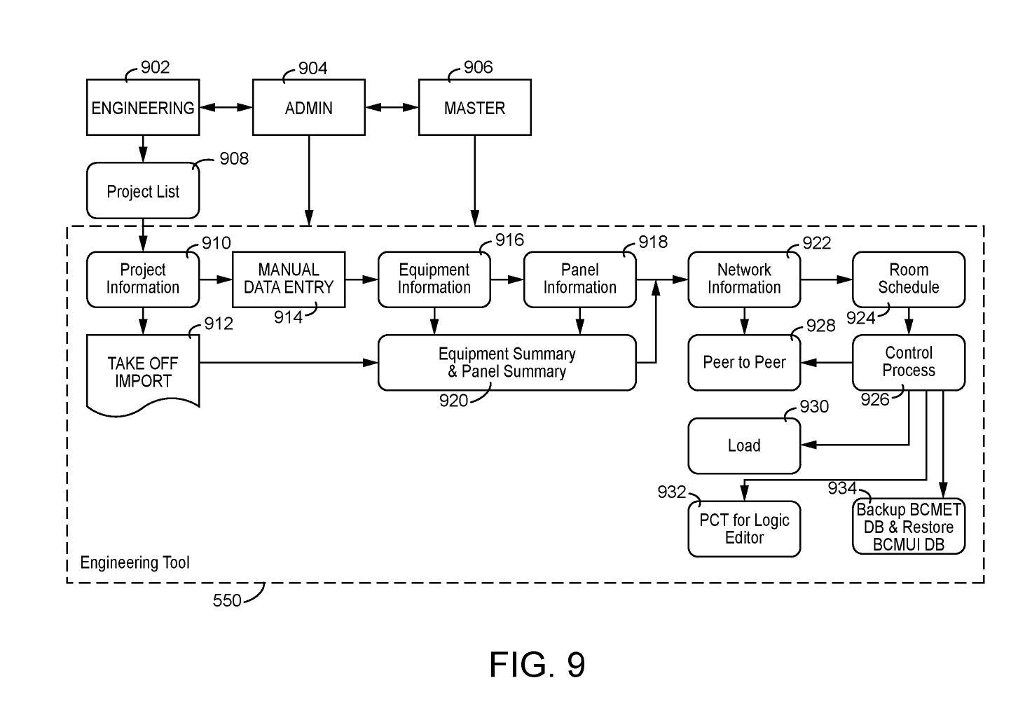

Turning now to FIG. 9, a flow diagram illustrating the basic workflow of a BCM engineering tool (such as ET 550) is shown, according to some embodiments. As shown in FIG. 9, one or more engineers 902 can generate a project list 908. Project list 908 can then be provided to BCM engineering tool 550 as project information 910. Project information 910 can then be placed into a “take off” import file 912. After the project information 910 has been entered, a user may be able to provide additional data manually (block 914) to a BCM 500. In some embodiments, the user has administrative privileges 904 or master privileges 906. After all the data has been entered, equipment information 916 and panel information 918 can be generated and placed into an equipment and panel summary 920. After the equipment and panel summary 920 has been generated, network information 922, room scheduling 924 and control processes 926 can further be generated. Control process 926 can be used to generate peer to peer relationships 928. Once the data has been generated, BCM engineering tool 550 can load the data into one or more associated devices (block 930). Further, a PCT 932 can be used for editing the logic, and a backup 934 of the BCM ET 550 as well as a restore file associated with the BCM UI 530 can be created. In some embodiments, ET 550 can be used to add third party references in a peer to peer configuration (e.g. Interlock). However, as ET 550 is an offline tool, it may not be able to discover third party points on its own. The discovery capability can be part of a BCM UI 530. Once the UI discovers the points associated with the third party references, the user may be required to take a UI backup file and restore it in the ET 550. In the case of point name mismatches, a user would need to export the points into a spreadsheet, rename the points, and restore the spread sheet within the ET 550. After restoring in the ET 550, the third party points would be available and a user may use the points for peer to peer connections.

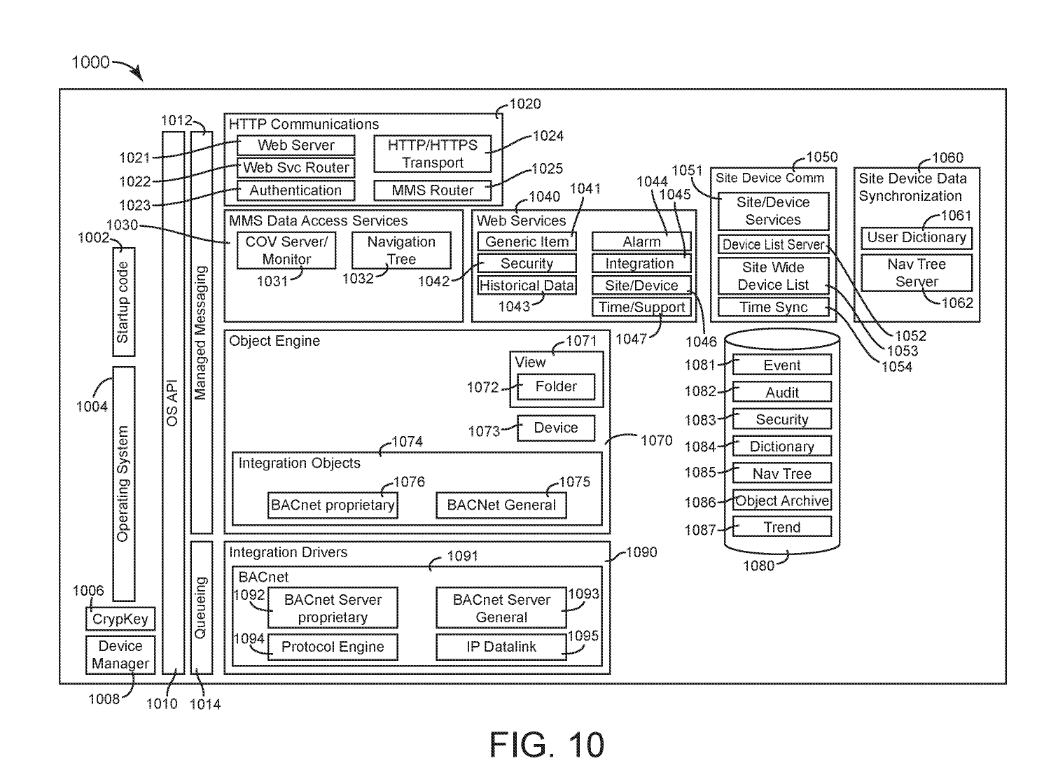

Turning now to FIG. 10, a functional representation of a BCM (such as BCM 500) core is shown. The BCM core may be referred to as a BCM Data Server (BDS) 1000. BDS 1000 can have a startup code layer 1002, an operating system layer 1004, a CrypKey 1006 and a device manager 1008. BDS 1000 can have an OS API 1010 for interfacing with an operating system. BDS 1000 can further include a managed messaging stack 1012 and a queueing stack 1014 from processing data. BDS 1000 can further include an HTTP communications module 1020, an MMS data access services module 1030, a web services module 1040, a site device communication module 1050, a site device data synchronization module 1060, an object engine 1070, a database 1080, and an integration drivers module 1090. HTTP communications module 1020 may include a web server module 1021, a web services router module 1022, an authentication module 1023, an HTTP/HTTPS transport module 1024, and an MMS router 1025. MMS data access services module 1030 can include a COV Server/Monitor module 1031 and a navigation tree 1032. Web services module 1040 can include a generic items module 1041, a security module 1042, a historical data module 1043, an alarm module 1044, an integration module 1045, a site/device module 1046, and a time/support module 1047. Site device communication module 1050 can include a site/device services module 1051, a device list server module 1052, a site wide device list module 1053, and a time sync module 1054. Site device data synchronization module 1060 can include a user dictionary 1061 and a nav tree server module 1062. Database 1080 can include event data 1081, audit data 1082, security data 1083, dictionary data 1084, navigation tree data 1085, object archive data 1086, and/or trend data 1087. Object engine 1070 can include a viewing module 1071 which can contain one or more folders 1072. Object engine can further include one or more device objects 1073 and one or more integration objects 1074. Integration objects can include BACnet objects such as general BACnet objects 1075 or proprietary BACnet objects 1076 (e.g., JCI family BACnet objects). Integration drivers 1090 may include BACnet objects such as BACnet Server proprietary objects 1092 and BACnet Server general objects 1093. BACnet objects 1091 can further include a protocol engine 1094 and an IP datalink 1095. While the above example uses BACnet as a primary means of communication, other communication protocols are also contemplated (Modbus, CAN, TCP/IP, Zigbee, etc.).

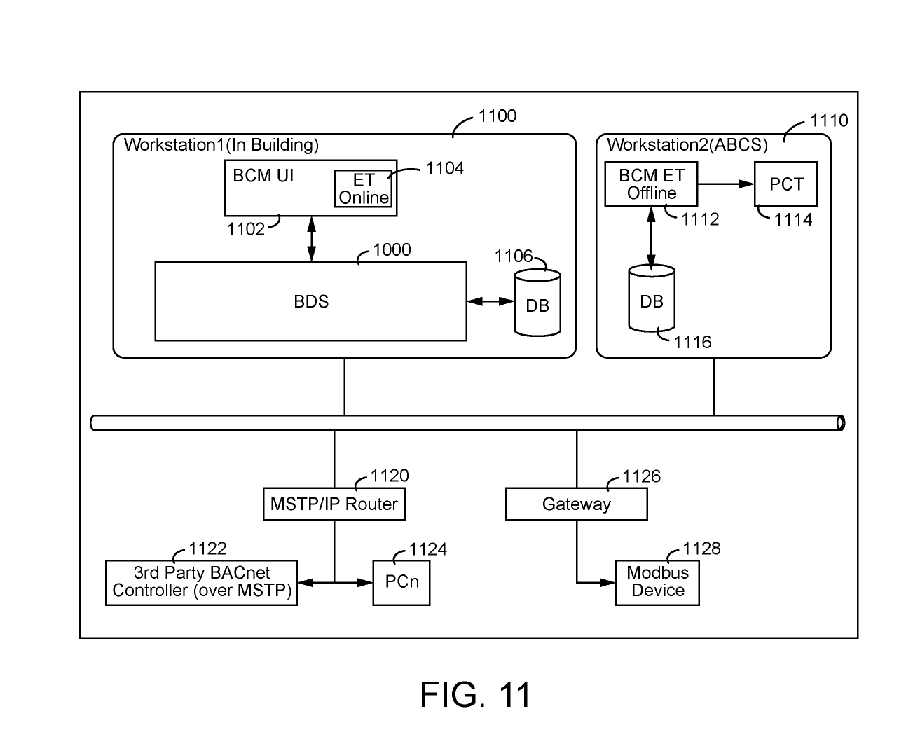

Turning now to FIG. 11, a block diagram illustrating some components of a typical BCM (such as BCM 500) is shown, according to some embodiments. As shown, the BCM includes a primary workstation 1100. Primary workstation 1100 can include a BDS 1000, a BCMUI 1102, and a single shared database 1106. BDS 1000 can be accessed by BCMUI 1102 for all points and controller related information. BCMUI 1102 can further include a configuration mode. For example, BCMUI 1102 can have a configuration mode called ET online 1104. ET online 1104 can discover points and add alarms, trends, or other data to the workstation for the discovered points. The configuration mode can further allow a user to edit object attributes as well as command them. A secondary workstation 1110 can further be included in the BCM. Secondary workstation 1110 can contain an offline configuration tool, referred to as BCM ET Offline 1112. Secondary workstation 1110 can further include a PCT module 1114 and a database 1116. BCM ET Offline application 1112 can be installed on secondary workstation 1110 and have its own database 1116. ET Offline application 1112 can be a client-server application where multiple clients can work on different projects at one time. In some embodiments, ET Offline application 1112 can restrict the number of client connections that may occur at one time. For example, ET Offline application 1112 can allow only two client connections at once. However, more than two client connections or fewer than two client connections are also contemplated. In some embodiments, ET Offline application 1112 can be installed on primary workstation 1100, and can be configured to operate independently of ET Online application 1104.

The BCM can further include a first network, such as BACnet IP, as well as an MSTP/IP router 1120 to convert the first network to a second network, such as BACnet MSTP. The second network can have one or more 3^{rd} party BACnet controllers 1122 and field devices such as PCn devices 1124. The BCM can further include a gateway device 1126 for connecting devices on a 3^{rd} party network, such as Modbus device 1128, to the BCM.

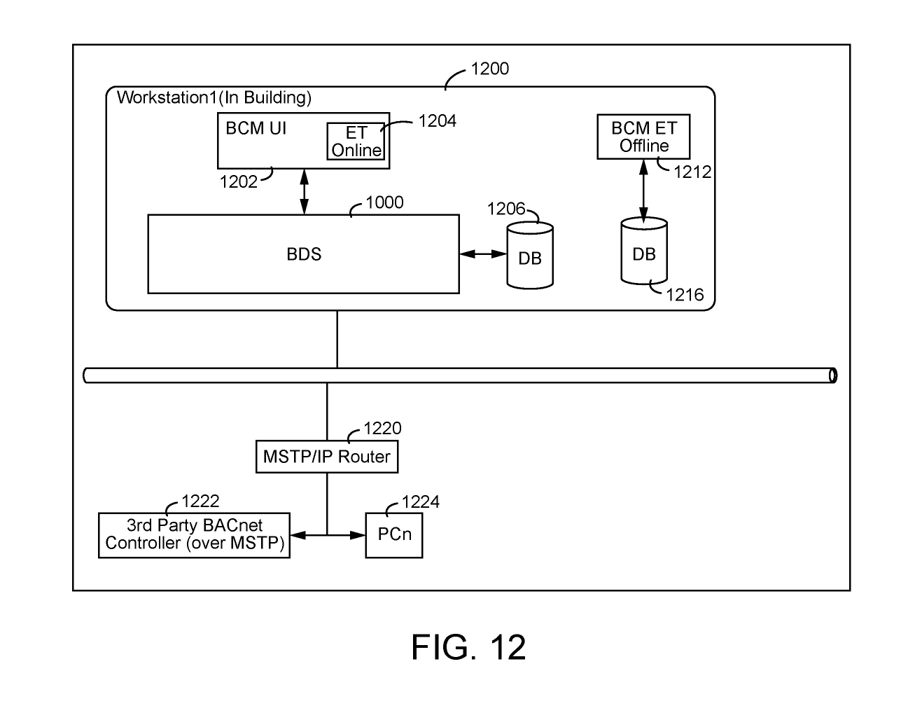

Turning now to FIG. 12, a block diagram illustrating a BCM with a single workstation is shown, according to some embodiments. Workstation 1200 is shown to include a BDS 1000, a BCMUI 1202 having an ET Online application 1112, and a first database 1206 shared by BCMUI 1202 and BDS 1000. Workstation 1200 is shown to further include a BCM ET Offline application 1126 and associated database 1124. The BCM is also shown to include a first network, such as BACnet IP. The BCM may further include an MSTP/IP router 1220 to convert the first network into a second network, such as BACnet MSTP. The second network can have one or more 3^{rd} party BACnet controllers 1222 and field devices, such as PCn devices 1224.

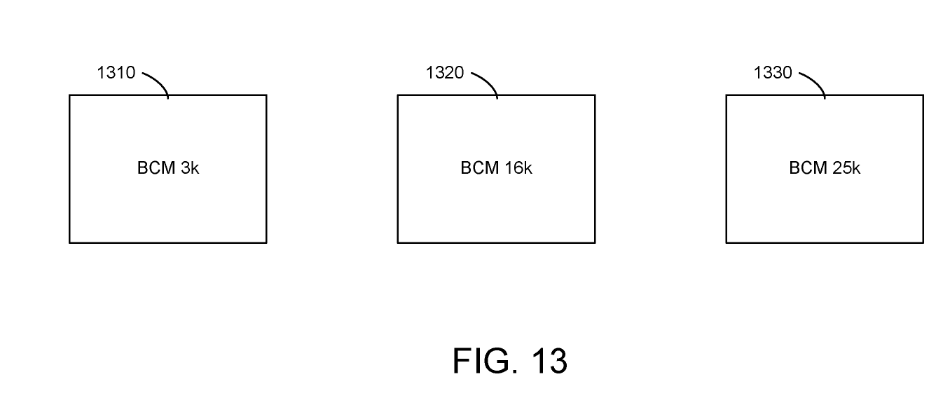

Turning now to FIG. 13, a block diagram illustrating three different BCM types is shown. The first type is a 3 k point BCM 1310. For BCM 1310, applications can operate on the same workstation as the BCM, but can also be remotely accessed. BCM 1310 can run on a Windows-based operating system such as Windows 7, Windows 10, etc. Further, the data for BCM 1310 can be stored on a local database. The second type is a 16 k point BCM 1320. For BCM 1320, the BCM may only be able to log in remotely. BCM 1320 can be configured to run on a Windows-based server operating system, such as Windows Server 2008 and later. Data for BCM 1320 may be stored in local databases. The third type is a 25 k point BCM 1330. BCM 1330 may only be able to run via remote log in. BCM 1330 can be configured to run on a Windows-based server operating system, such as Windows Server 2008, and later versions thereof. Data for BCM 1330 can be stored on a local database temporarily and then sent to a server-based database using SQL procedures.

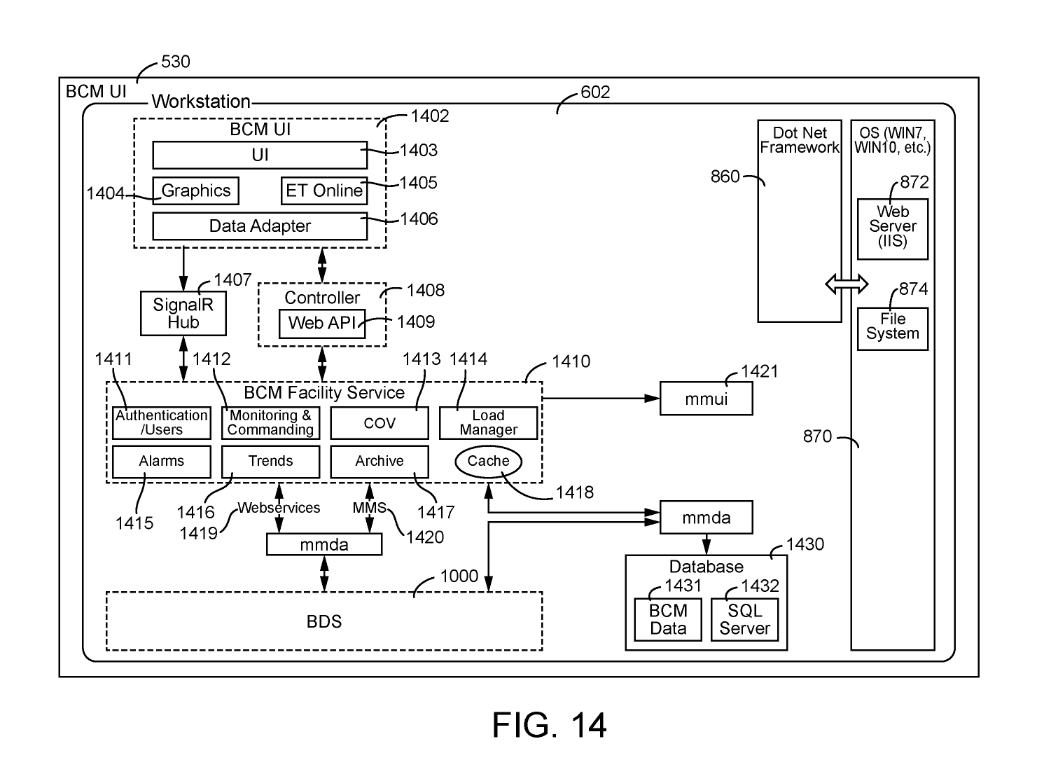

Turning now to FIG. 14, a block diagram illustrating a detailed view of a BCMUI 530 is shown, according to some embodiments. In one embodiment, BCMUI 530 can be loaded onto a workstation 602. BCMUI 530 may include a UI module 1402. UI module 1402 can include a UI layer 1403, a graphics layer 1404, an ET online application 1405, and a data adapter layer 1406. UI layer 1403 can be configured to communicate with AngularJS controllers and can further be configured to bind data returned from the Angular JS controllers to HTML elements. Data adapter layer 1406 can be configured to understand SignalR messages and JSON responses from a Web API, and subsequently provide the data to the UI layer. UI module 1402 can be in communication with a SignalR Hub 1407. SignalR Hub 1407 can be used to get and update point data on the user interface graphics in real time. In one embodiment, SignlR Hub 1407 can get data from a BDS layer 1000. UI module 1402 can further be in communication with a controller 1408 which can include a Web API 1409. In one embodiment, controller 1408 is a software controller. Controller 1408 can provide a restful service to expose JSON data to a separate controller such an AngularJS controller service. Controller 1408 and SignalR hub 1407 can be in communication with a BCM service layer 1410. BCM service layer 1410 can be configured to act as an adapter between BCM UI 1402 and BDS 1000. Further, BCM service layer 1410 can be configured to fetch data and to package the data in a meaningful object required for BCMUI 1410 operation. BCM service layer 1410 can include applications or objects such as an authentication/user application 1411, a monitoring and command application 1412, a COV application 1413, a load manager application 1414, an alarms application 1415, a trends application 1416, an archive application 1417, and a cache application 1418. BCM service layer 1410 can interact with BDS 1000 via web services tools 1419 or via a BAS interface, such as Metasys Messaging Services (MMS) 1420. Load manager 1414 may be in communication with a MMUI module 1421.

BCM services layer 1410 can also be in communication with a database 1430. Database 1430 can include BCM data 1431 which can include equipment, customers, and spaces information. Further, database 1430 can include data related to events, trends, and security of a BCM. Database 1430 can use SQL server software 1432 to organize data within. In some embodiments, database 1430 can be structured to use and merge into a BDS 1000 database to support existing functionalities of a BCMUI 530. BDS 1000, as described above, can be the core and source of real time point values for a BCMUI 530. BDS 1000 can communicate to BACnet based controllers via routers and gateways. In some embodiments, BDS 1000 can communicate with 3^{rd} party devices to create alarms and trends for those devices. A BCMUI 530 can further include a .Net Framework 860 and an operating system (OS) 870. In one embodiment, the OS is a Windows based operating systems, such as Windows 7, Windows 10, etc. The OS can further include a web server 872 and a file system 874. In some embodiments, a user can communicate with a BCMUI 530 over HTTP via the web server. In further embodiments, data can be communicated in JSON format between an internet browser and a BCMUI 530.

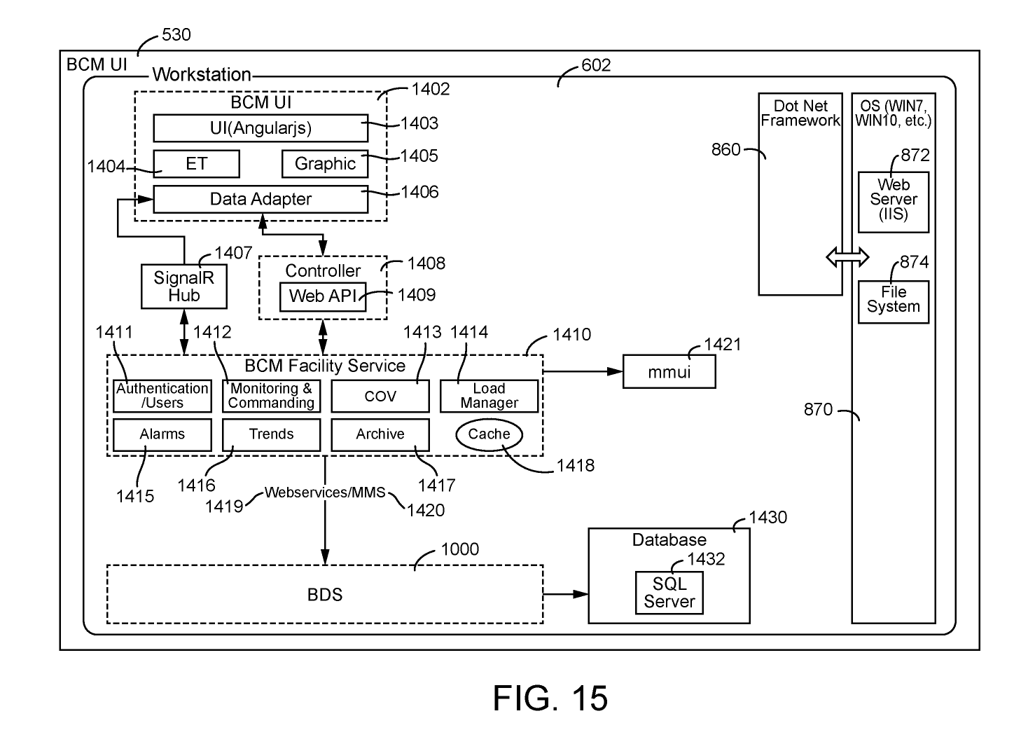

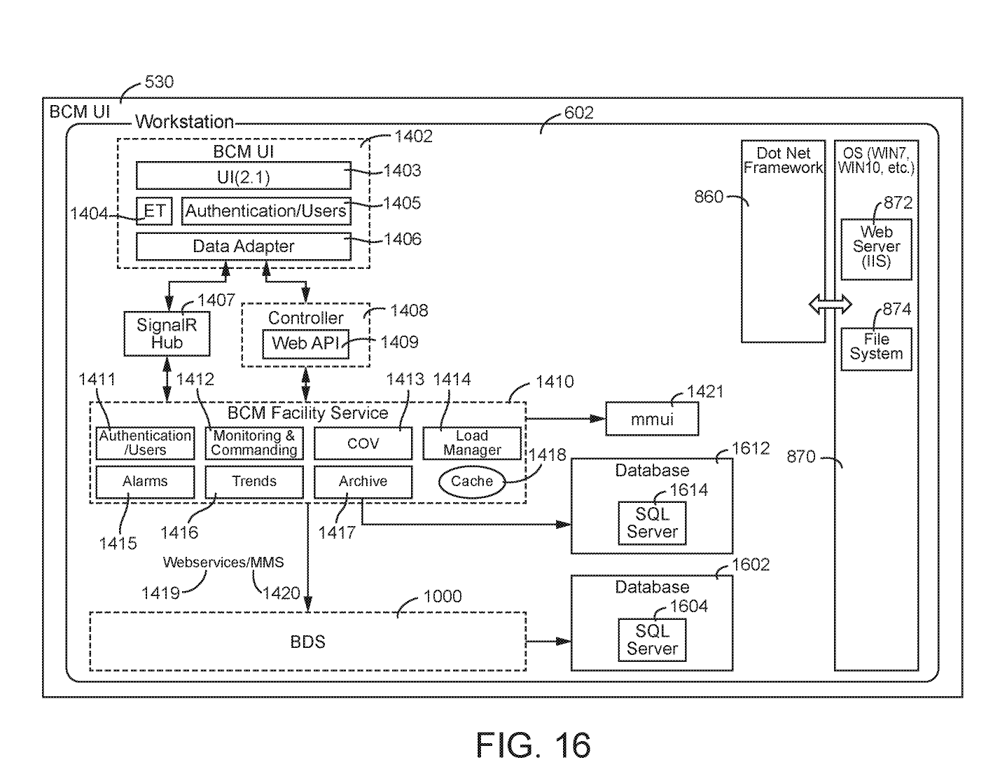

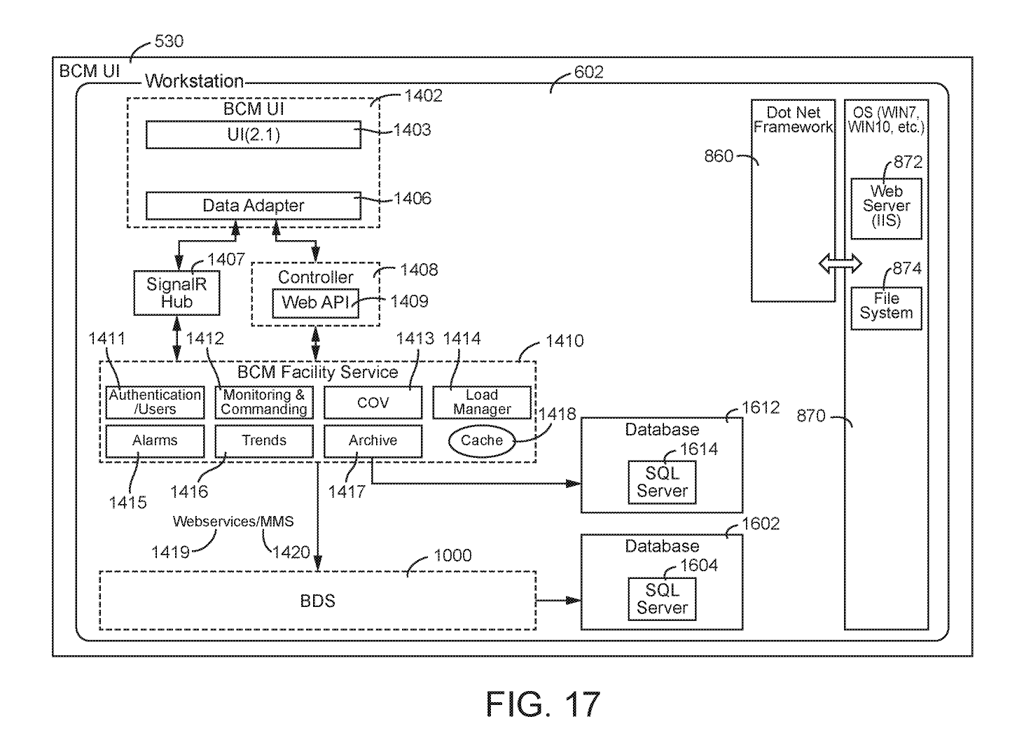

Turning now to FIG. 15, a block diagram showing a further embodiment of a BCM UI 530 is shown. As shown in FIG. 15, BDS 1000 can communicate directly to a BDS database 1430 having an SQL server 1432. FIG. 16 is a block diagram illustrating a further embodiment of a BCM UI 530. In FIG. 16, BDS 1000 can communicate directly with a BDS database 1602 having an SQL server 1604, and BCM Facility Services module 1410 can communicate directly with a BCMUI database 1612 having an SQL server 1614. FIG. 17 is a block diagram illustrating yet another embodiment of a BCMUI 530. As shown in FIG. 17, a BCMUI module 1402 may only include a UI layer 1403 and a data adapter layer 1406.

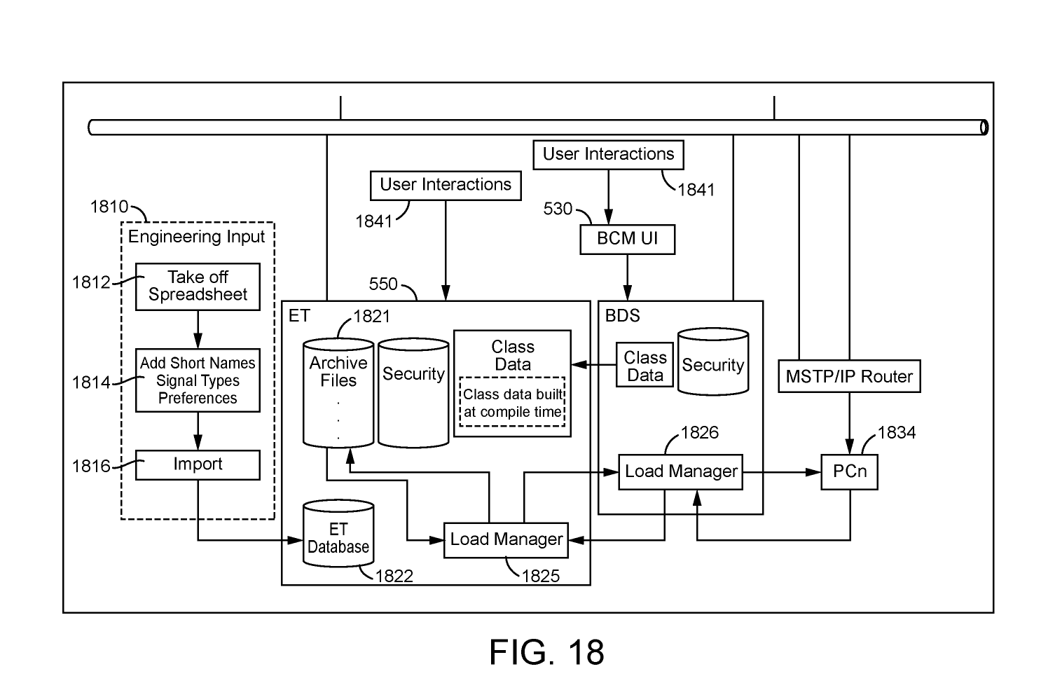

Turning now to FIG. 18, a block diagram 1800 illustrating a BCM (such as BCM 500) backup process is shown, according to some embodiments. First, an engineering input 1810 can be created by a user. The first component of engineering input 1810 is a take-off spreadsheet 1812. Short names and signal type preferences 1814 can also be added to take-off spreadsheet 1812, which can then be imported (block 1816) into an ET 550 database 1822. A load manager 1825 associated with an ET 550 can then communicate with a database 1821 within an ET 550 that can contain archive files 1821. Archive files 1821 can include workstation archive files, security database files (e.g. user roles and permissions), and CAFs. Load manager 1825 can further communicate with a load manager 1826 associated with a BDS 1000. The data received from BDS load manager 1826 can further be stored in archive files 1821 as backup data. BDS load manager 1826 can be in communication with one or more field devices 1831 (PCn) and can store data associated with those devices in archive files 1821. Further, a user may interact (block 1841) directly with an ET 550 to perform functions such as building a site, setting up a network, setting up logic and/or setting up users. A user can further interact with BDS 1000 via a BCMUI 530. Via BCM UI 530 the user can perform functions such as request a UI backup/restore or an ET backup/restore.

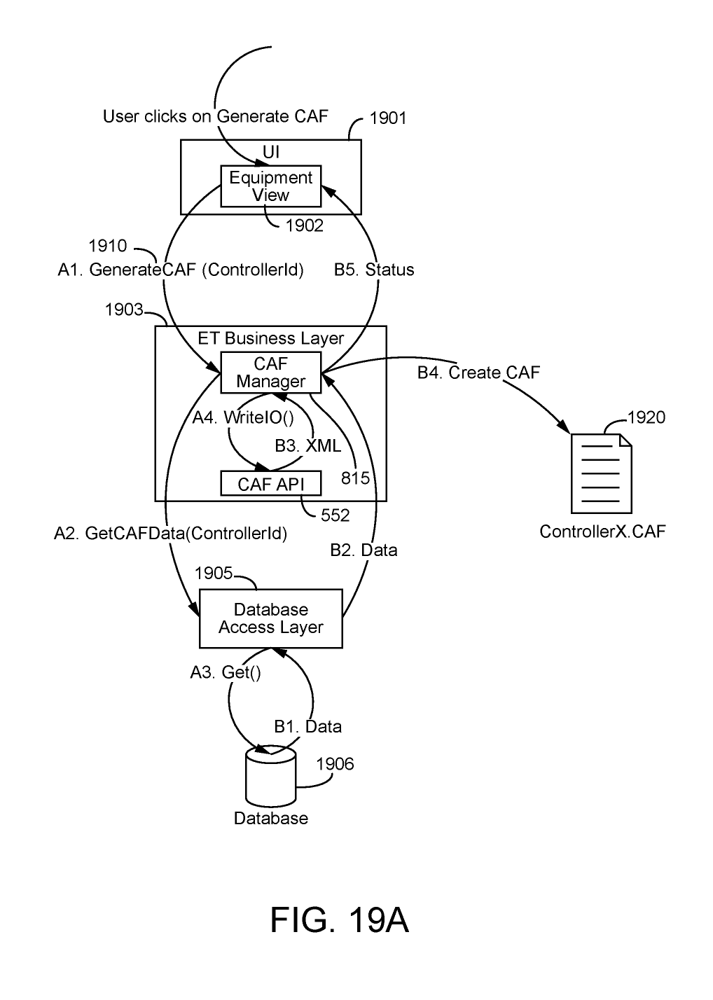

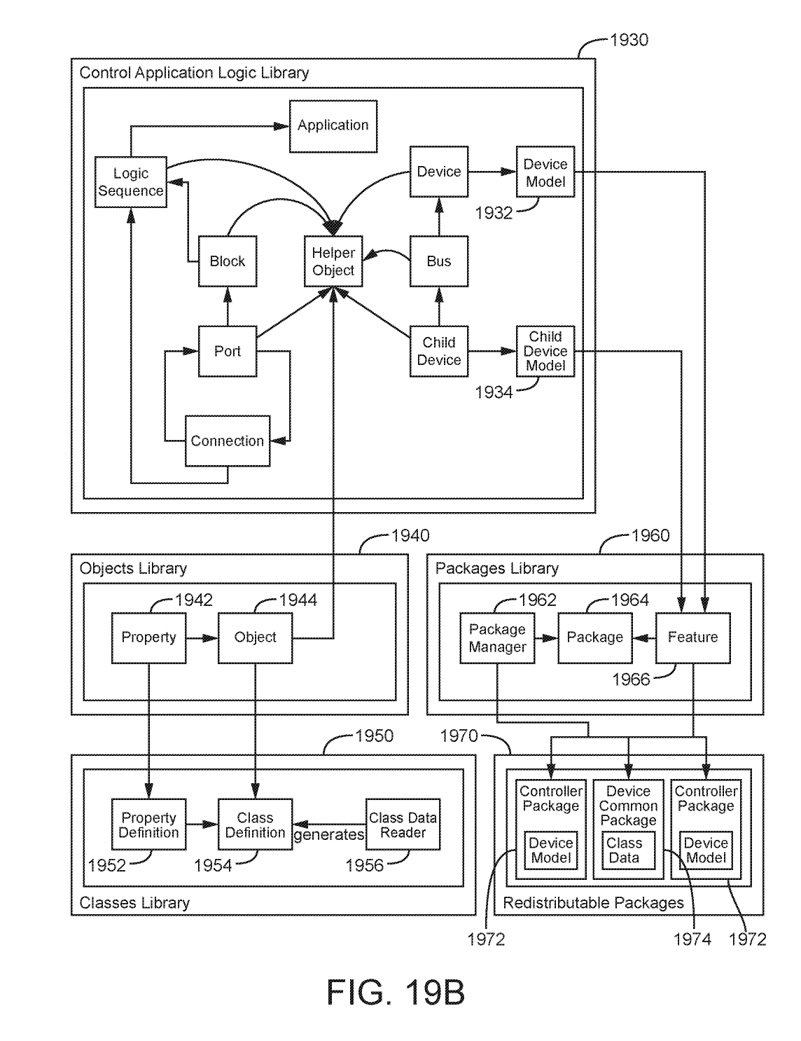

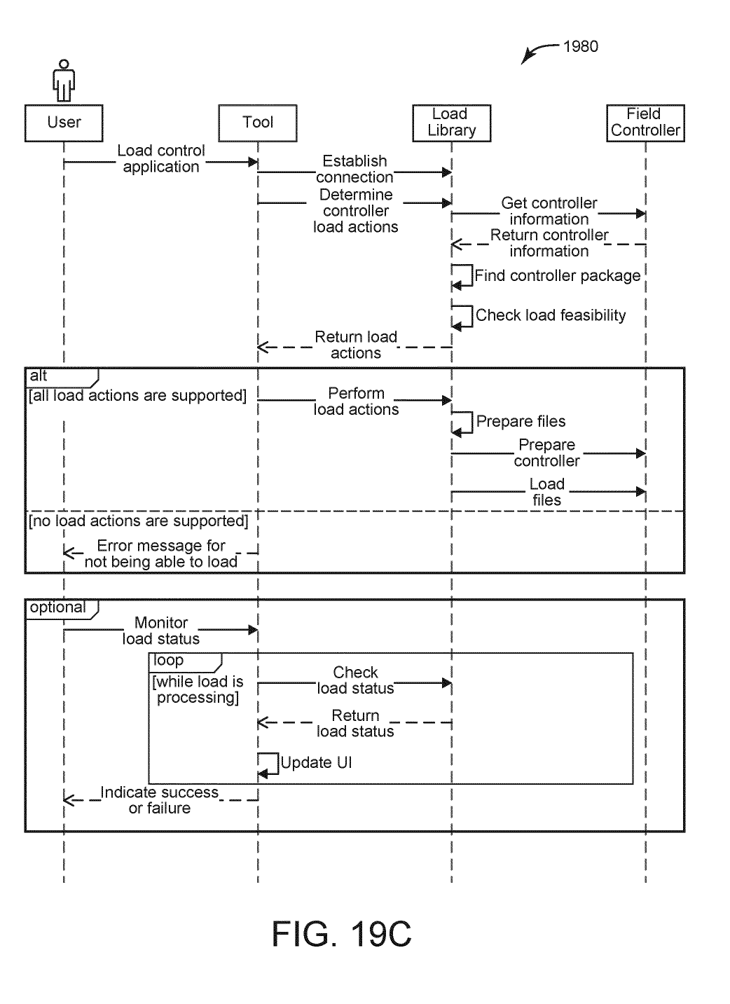

Turning now to FIG. 19A, a flow chart illustrating a process for generating CAFs is shown, according to some embodiments. A user first selects an option to generate CAFs via a UI 1901 equipment view 1902. A generateCAF command 1910 can then be sent to a business layer 1903 of an ET 550, and specifically to a CAF manager 815 contained therein. CAF manager 815 can then coordinate with a CAF API 552 to generate or write a CAF as well as exchange data such as XML data to use during CAF generation. In some embodiments, CAF API 552 can allow a third party engineering tool 560 to access CAF manager 815 for use in creating or modifying CAFs. CAF manager 815 can further access a database 1906 via a database access layer 1905 to gather data required for CAF generation. CAF manager 815 can then generate a CAF 1920 using CAF API 552.

Turning now to FIG. 19B, a set of redistributable libraries containing various data and logic is shown, according to some embodiments. The set of libraries is shown to include a control application logic library 1930, an objects library 1940, a classes library 1950, and a packages library 1960. In some embodiments, each of libraries 1930, 1940, 1950, and 1960 are dynamic-link libraries (DLLs). Each DLL can contain redistributable data and/or logic that can be used by other modules (e.g., other DLLs, applications, etc.).

Classes library 1950 is shown to include a class data reader 1956 as well as class definitions 1954 and property definitions 1952. Classes library 1950 can be used as a template to create objects. Class data reader 1956 can be configured to generate class definitions 1954 by reading class data information via a feature 1966 that is associated with a redistributable package 1970 that contains class data 1974. Objects library 1940 is shown to include properties 1942 and objects 1944. Objects 1944 can be generated according to a class definition 1954 (an object can be referred to as an “instance” of a class). Class definition 1954 can consist of a set of property definitions 1952 that can define which properties 1942 can be instantiated with an object. Control application logic library 1930 can contain data and logic associated with control applications of a system. In some embodiments, a helper object can assist in providing any functionality needed gather and prepare control application data. Library 1930 is shown to include device models 1932 and 1934 which can be configured to gather data from packages library 1960. A child device model 1934 can have an associated dependence on a parent device model 1932. The device information contained in device models 1932 and 1934 can be used to configure control applications for specific devices. Packages library 1960 is shown to include a package manager 1962, packages 1964, and features 1966. Package manager 1962 can be configured to read information from redistributable packages 1970. This data can include meta-data, device information, and directory listings to name some examples. In some embodiments, package manager 1962 can be configured to maintain various dependencies and version information to prevent mismatches and missing prerequisites. Features 1966 can include separable functionality or data within a package (e.g., class data or device model information). Redistributable packages 1970 are shown to include for example controller packages 1972 and a device common package 1974. Each redistributable package may contain multiple features that can be loaded by packages library 1960.

The redistributable data and logic contained within libraries 1930, 1940, 1950, and 1960 can be used within engineering tool 550 by components such as CAF API 552, CAF manager 815, and a load manager 816. The interoperability provided by these libraries can allow various control applications to be developed for a control system such as BCM 500.

Turning now to FIG. 19C, a flow diagram 1980 illustrating a process for loading controller application files (CAFs) is shown, according to some embodiments. A CAF can be compressed and prepared for loading onto a field controller by an engineering tool 550. Various components within an engineering tool 550, such as load manager 816, can be used during a load process 1980. A redistributable load library can be used to communicate between a tool such as engineering tool 550, 3^{rd} party engineering tool 560, or a commissioning tool 562 and a field device such as a field controller 502. The load library can define methods of communication between an engineering tool and a field device in order to load controller application files onto a device. Load process 1980 can involve getting information from a field controller and preparing a field controlled for a load. For example, process 1980 can include checking a current firmware version of a field controller and installing a new firmware version if necessary. A user interface such as BCMUI 530 can be used to perform a load process 1980.

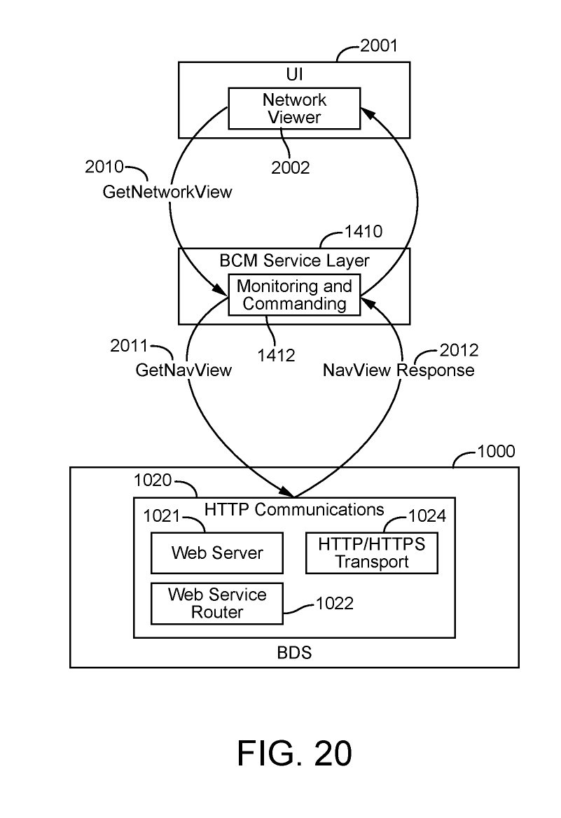

Turning now to FIG. 20, a flow chart illustrating a process for performing a network view on an online ET is shown, according to some embodiments. A UI 2001 can send a GetNetworkView command 2010 to a BCM service layer 1410 via a network viewer 2002 associated with UI 2001. BCM service layer 1410 can include a monitoring and command module 1412, as described above, which can send a GetNavView command 2011 to a BDS 1000. BDS 1000 can process a GetNavView command 2011 within an HTTP communications module 1020 which can include a web server 1021, a web service router 1022, and an HTTP/HTTPS transport module 1024, as described above. HTTP communication module 1020 can provide a NavView response 2012 which can be received by monitoring and command module 1412. Module 1412 can then processes the response and send an appropriate view to a UI Network Viewer 2002.

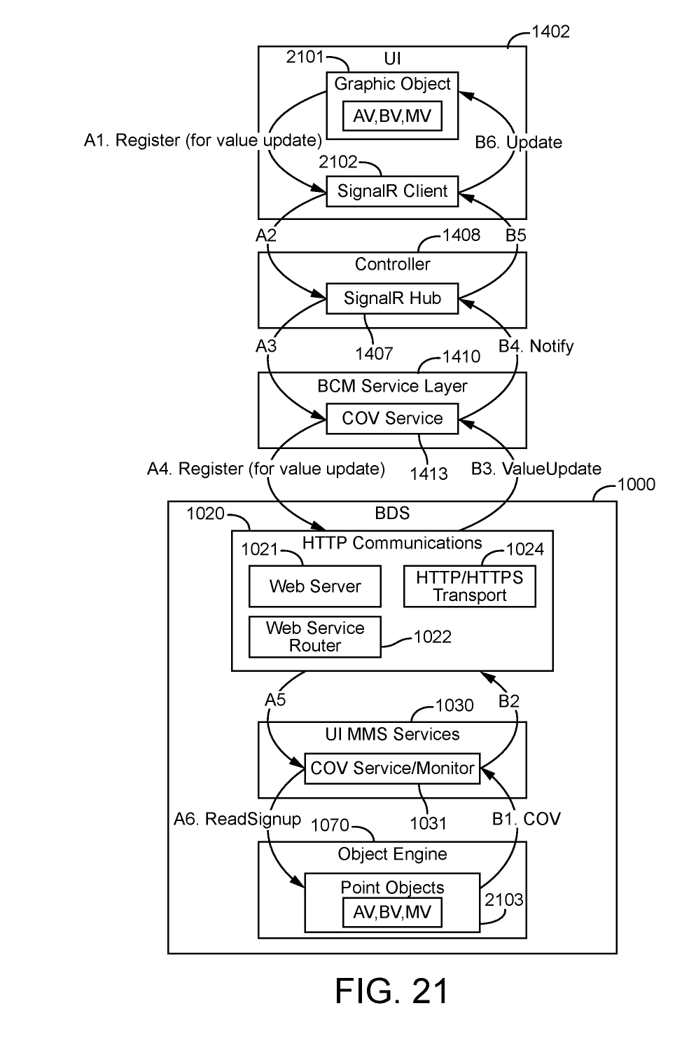

Turning now to FIG. 21, a flow chart illustrating a process for updating point values on UI is shown, according to some embodiments. A UI 1402 can include a graphics object 2101 with object data and a SignalR client 2102. Graphics object 2101 can allow a user to view graphics associated with one or more pieces of equipment within a system. Graphics object 2101 can include a register with point value data stored therein. SignalR client 2102 can access and update the register when it receives updated values. SignalR client 2102 can also transmit a request for point data to a SignalR hub 1407 within a controller 1408 of. SignalR hub 1407 can then send a point data request to a COV service module 1413 within a BCM service layer 1410. BCM service layer 1410 can then communicate with BDS 1000 to request point values. In one embodiment, COV service module 1413 communicates with an HTTP communications module 1020 of a BDS 1000. HTTP communications module 1020 can include a web server 1021, a web service router 1022 and a HTTP/HTTPS transport module 1024, as described above. HTTP communications module 1020 can be in communication with a UI MMS services module 1030 which can include a COV server/monitor 1031. COV server/monitor 1031 can send a COV request to one or more point objects 2103 that can be stored in an object engine 1070 of BDS 1000. Point objects 2103 can provide data values to COV server/monitor 1031 which can then be sent to COV services module 1413 via HTTP communications module 1020. COV services module 1413 can notify SignalR hub 1407 of new data which can be sent to SignalR client 2102 and used to update a graphic object 2101.

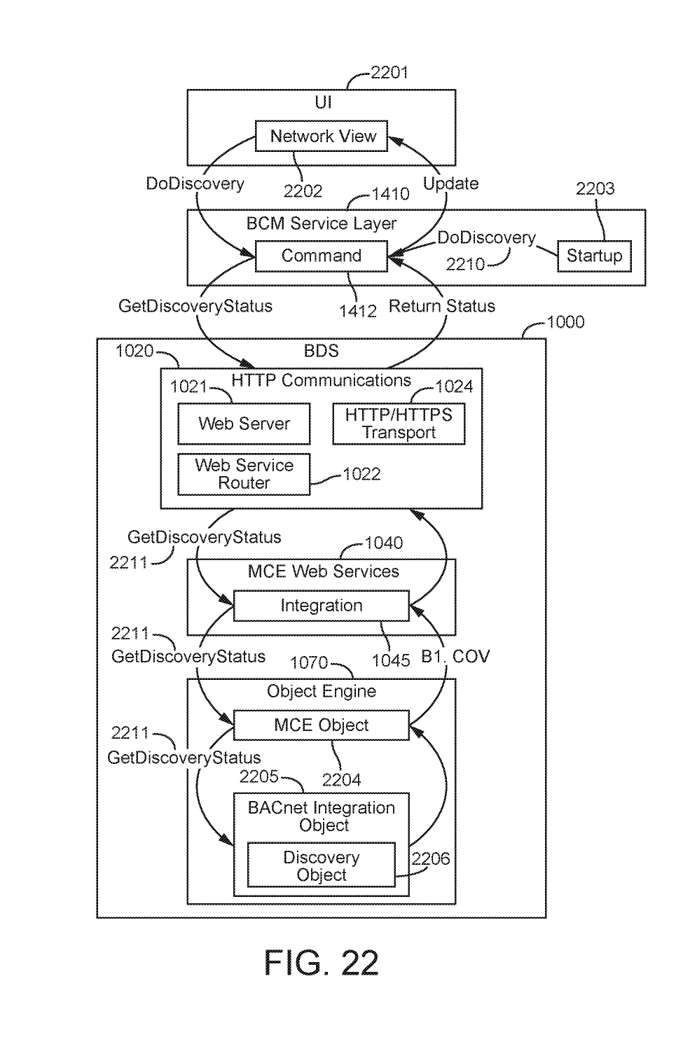

Turning now to FIG. 22, a flow diagram illustrating a process for a device discovery is shown, according to some embodiments. A network view module 2202 associated with a UI 2201 can transmit a DoDiscovery command to a command module 1412 within a BCM service layer 1410. In some embodiments, a startup module 2203 within BCM service layer 1410 may also issue a DoDiscovery command to command module 1412. Command module 1412 can transmit a GetDiscoveryStatus command to an HTTP Communications module 1020 within a BDS 1000. HTTP communications module 1020 can then transmit a GetDiscoveryStatus command 2211 to an integration module 1045 within a web services module 1040 of BDS 1000. Integration module 1045 can then transmit a GetDiscoveryStatus command 2211 to an MCE Object 2204 within an object engine 1070 of BDS 1000. MCE Object 2204 can then transmit a GetDiscoveryStatus 2211 command to a BACnet Integration Object 2205. The BACnet Integration object 2205 can include a discovery object 2206 for discovery of one or more devices on the object. BACnet Integration object 2205 can then communicate the discovery information back to UI 2201 via BCM service layer 1410.

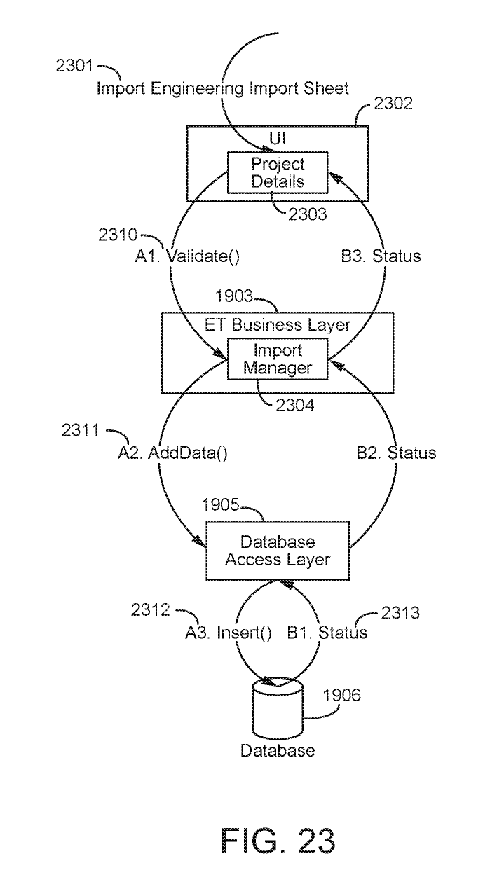

Turning now to FIG. 23, a flow diagram illustrating a process for generating a project is shown, according to some embodiments. An engineering import sheet 2301 can be imported into a project details module 2303 of a UI 2302. The project details module 2303 can then send a validation command 2310 to an import manager 2304 of an ET business layer 1903. Import manager 2304 can then send an AddData command 2311 to a database access layer 1905. Database access layer 1905 can then send an insert command 2312 to a database 1906 which can respond to database access layer 1905 with a status value 2313. Status value 2313 can then be passed to project details module 2303 via ET business layer 1903.

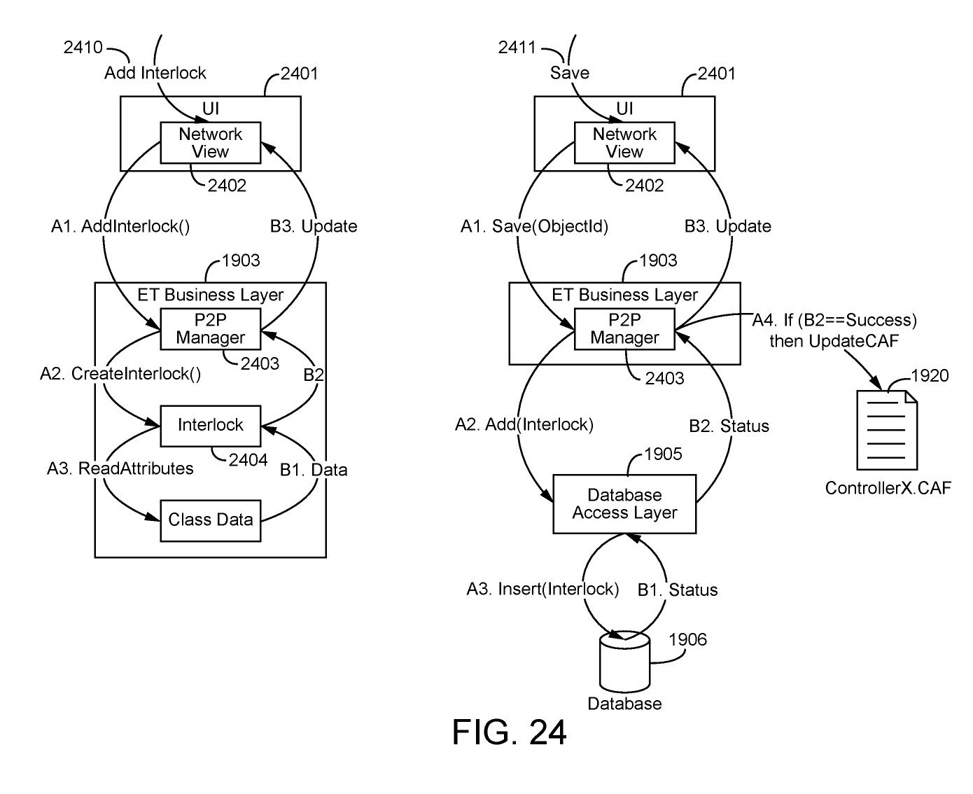

Turning now to FIG. 24, a flow chart illustrating a process for adding an interlock is shown, according to some embodiments. While FIG. 24 relates to an interlock being generated, other advanced objects such as multi command objects (MCO), global data, and/or signal data can also be generated via the process shown in FIG. 24. An add interlock command 2410 can be provided to a NetworkView module 2402 of a UI 2401. NetworkView module 2402 can then transmit an AddInterlock command 2410 to a peer to peer (P2P) manager 2403 of an ET business layer 1903. P2P manager 2403 can then create an interlock 2404 and read attributes and data of the interlock once it is generated. P2P manager 2403 can then send updates to NetworkView module 2402. Once an interlock 2404 is generated, a user can save the interlock. A save command 2411 can be provided to NetworkView module 2402, which can then issue a save command 2411 command to P2P Manager 2403. P2P manager 2403 can then add an interlock 2404 to a database 1906 via a database access layer 1905. Further, once an interlock 2404 has been successfully saved, one or more CAFs 1920 can be updated. Once an interlock object has been created, a user may be able to add more information to an interlock object and save it. The save will add an interlock to the database and update an associated CAF.

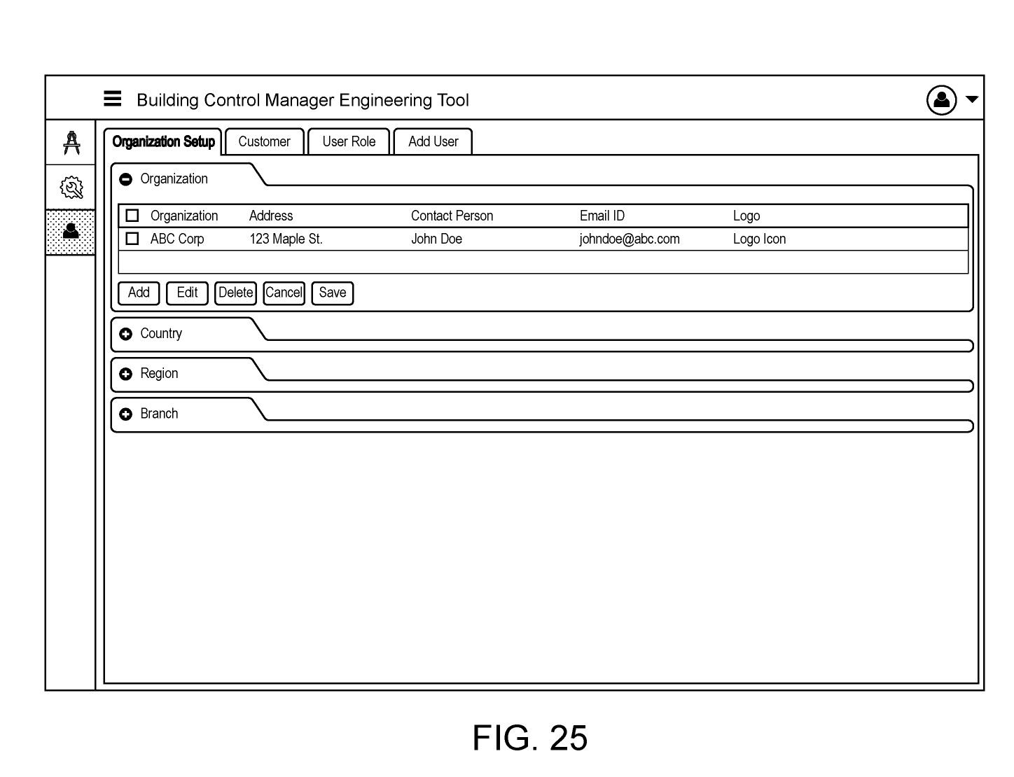

The following figures relate to various interfaces associated with the ET. Turning to FIG. 25, a screen shot illustrating an administrative module interface of the ET is shown, according to some embodiments. The administrative module may allow a user to create and maintain the organization and customer's portfolio. The administrative module may further help to maintain the user roles and rights for the ET. Administrators may have different modules, including organization setup, customer, user role and add-users. FIG. 25 represents an organization setup module. The organization setup module can allow for a user to create a master organization setup for the ET. The organization setup module may have sub tabs, such as organization, country, region and/or branch. The data entered and saved in the organization setup module may be used for individual project mapping. Organization details such as names and addresses may be entered and stored in the organization tab. A grid table may represent the filled details for further use of the ET. During the initial setup, all grid entries should be empty, and ready to fill using the data entry buttons (Add, Edit, Delete, Cancel, and Save), as shown in the grid table of FIG. 25.

The country tab may allow users to add different countries served by the organization into the organization tab. Information such as country name, country code, and date format used for a particular country may be filled while adding any country. The region tab may allow for a user to add different regions for the different countries added in the Country tab. The Branch tab may allow a user to add different branches and contact persons under each region. The customer tab may act as a repository for customer details. These details should be used during the project configuration process in the ET. The customer tab may further represent the customer details which are added by a user for ready to use purposes. The user may be able to add the number of customers as per the project requirements. The completed data may be shown in a grid table and be easy to edit at any time. While adding a new customer, the Country and Branch section information should be recalled from the data filled in the Organization setup screen.

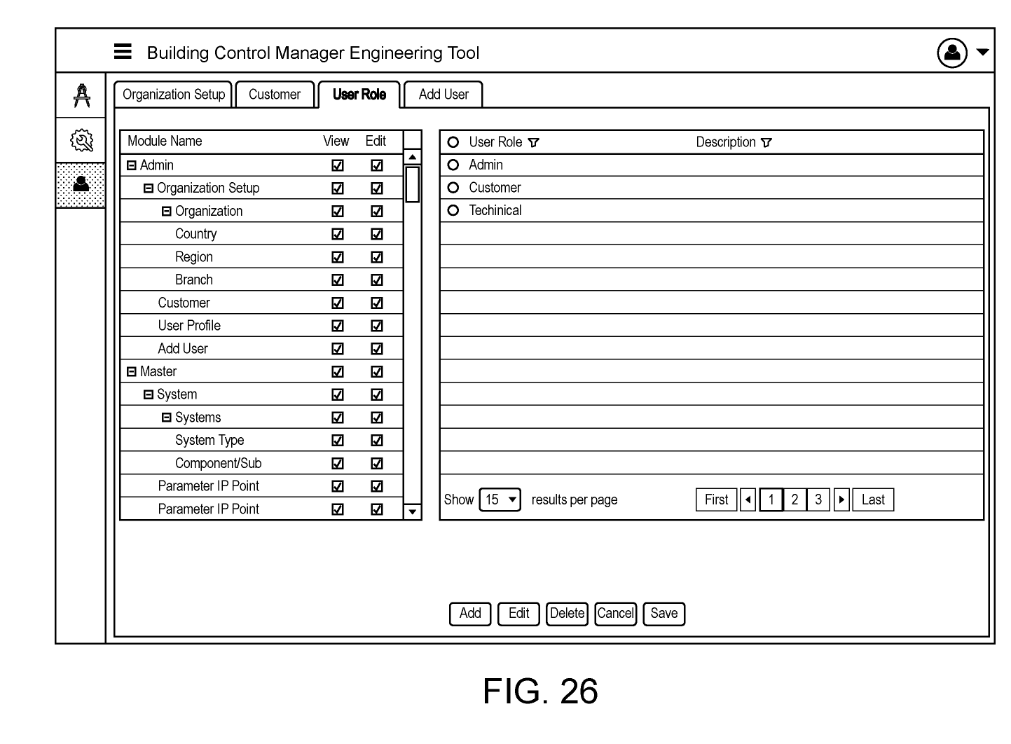

Turning now to FIG. 26, a screenshot illustrating the user role interface is shown, according to some embodiments. The user role interface may provide the functionality to maintain a portfolio of master users. The user role page should allow a user to add and adjust the activities for master users. The right side panel of the user role interface may display a master users list. The left side panel of the user role interface may represent a list of all modules and sub-modules present in the tool. Each module and sub module category may have the view and edit rights, which may be applied by selecting one of the checkbox options. The add user interface may allow for multiple users to be added under each Master user. Further, the add user interface may allow for user to add/map user under each master user category mapped in the user role interface. For example, a user may be able to provide data related to user type, user name, user ID, password, contact number, e-mail address, etc. to each newly added user. The added users may then be represented in a tabular grid format.

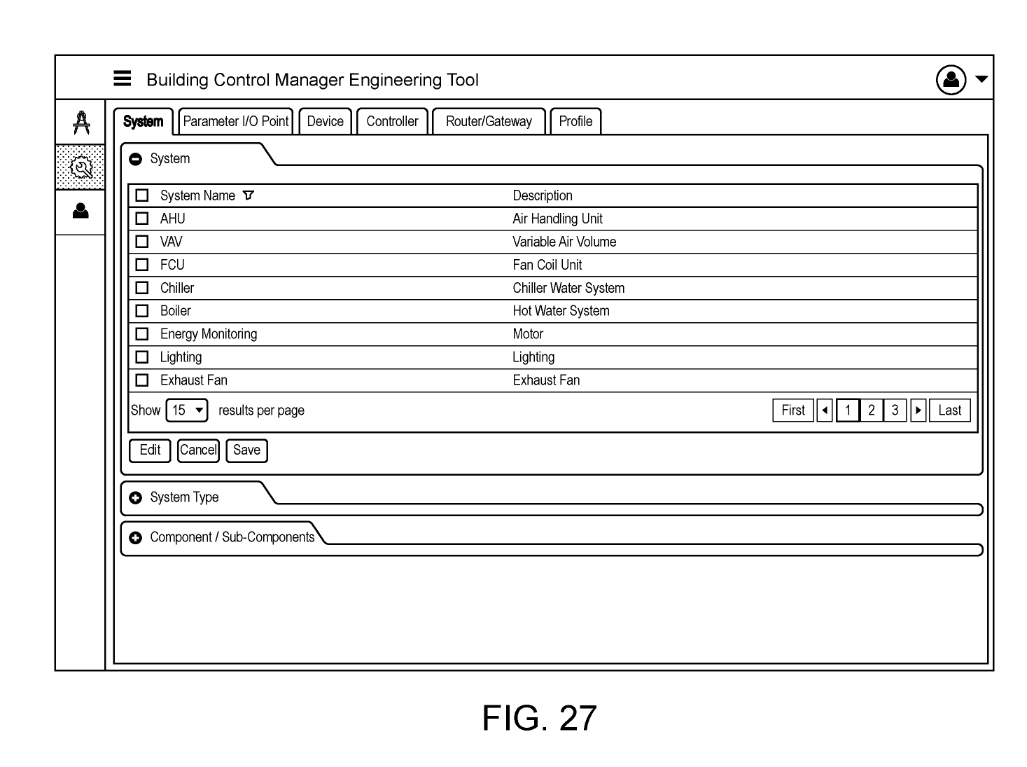

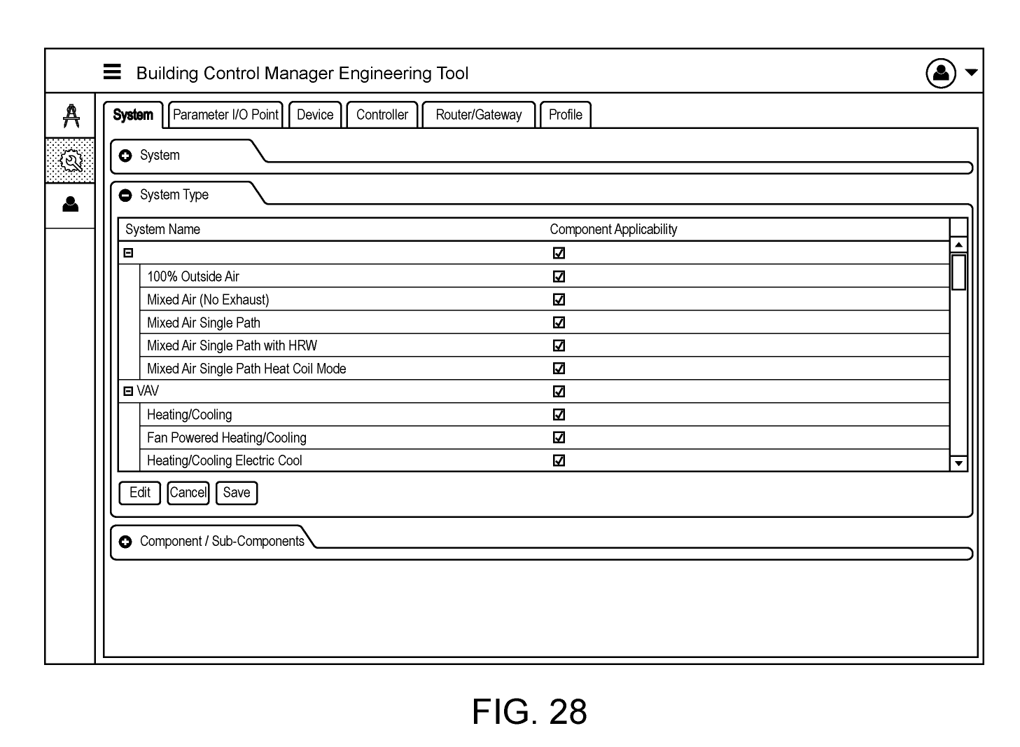

Turning now to FIG. 27, a screenshot illustrating a Systems interface of a Master Module of the ET is shown, according to some embodiments. The Master Module may capture the detailed data for all systems, I/O points, Devices, Controllers, Slaves and project profiles. A user may be able to modify the Master Module if any modifications are required, depending on the access of the user. Further, the Master Module may act as a repository database for the ET. The sub-modules included under the master module are shown in FIG. 27, as well as the FIGS. 28-38. The systems interface, as described in FIG. 27 may represent one or more equipment details. The systems interface further contains sub-tabs which represent the details for each piece of equipment, include base configuration type and associated components. The systems interface may further provide representations of the equipment added using the ET. The ET is synchronized with the systems interface via a BCM UI application. The systems interface may not have functionality to add or edit any new system into the ET.

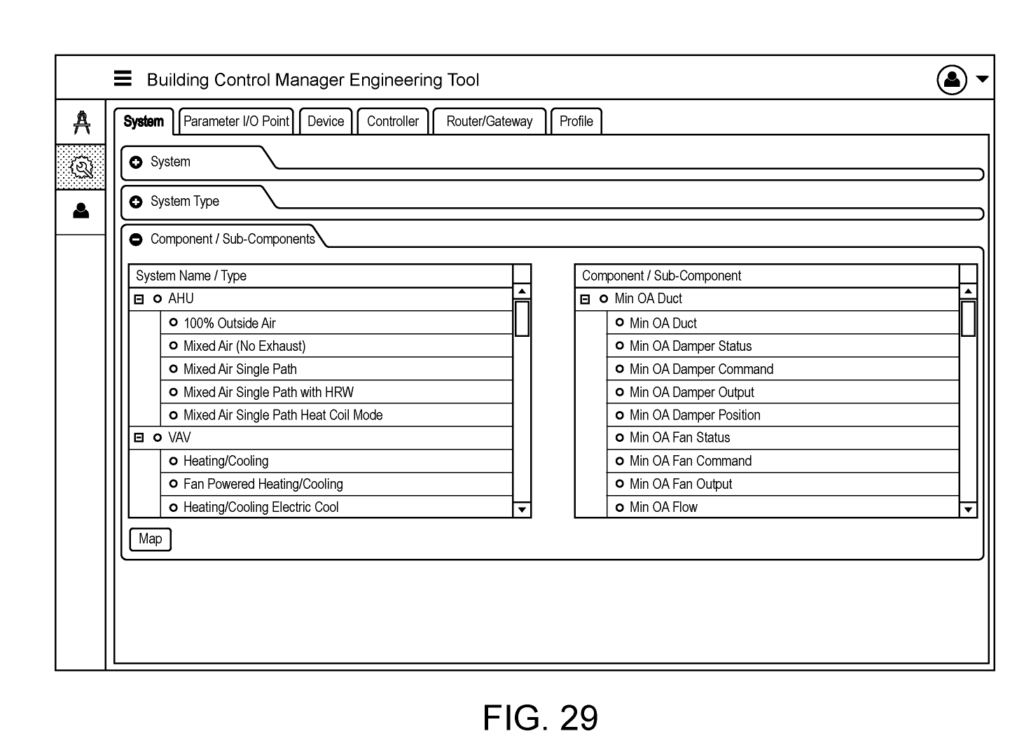

FIG. 28 is a screenshot illustrating the system type sub tab of the systems interface, according to some embodiments. The system type sub-tab may represent the data for system types for an individual system. The system types may be standard system types which are assigned to each system. The system type selection may aid in generating the point list. Turning now to FIG. 29, a screenshot illustrating the components and sub components tab is shown, according to some embodiments. The components and sub components tab may be designed based on standard system configurations. Standard categories and component list may already be entered into the ET master data file allowing a user to add or edit components into the system, and save for future use.

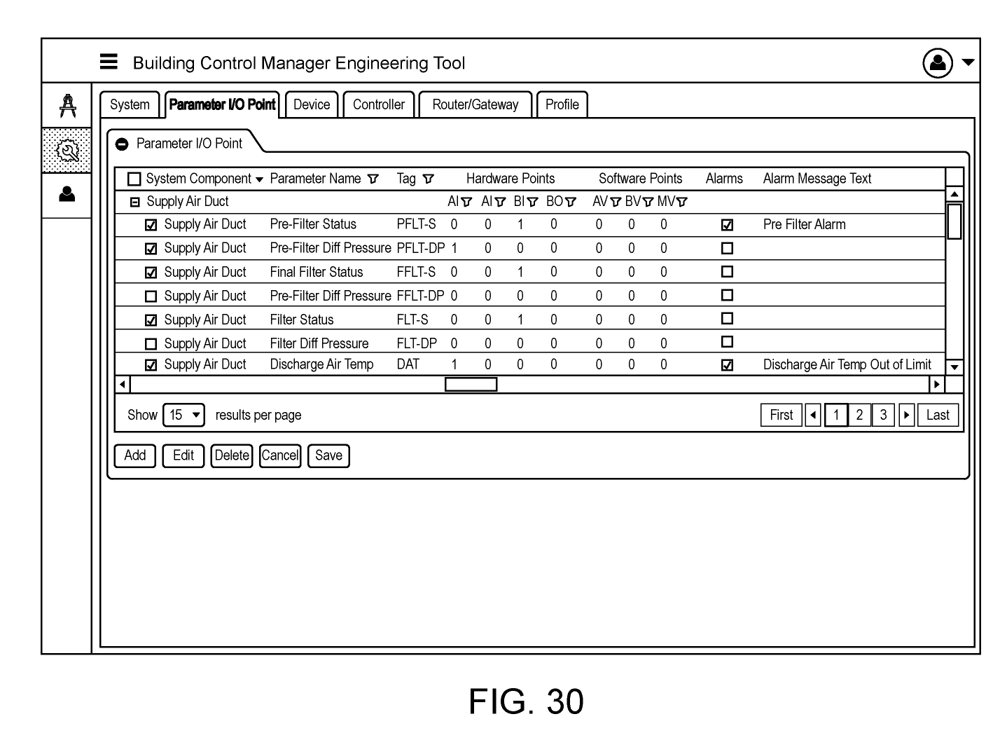

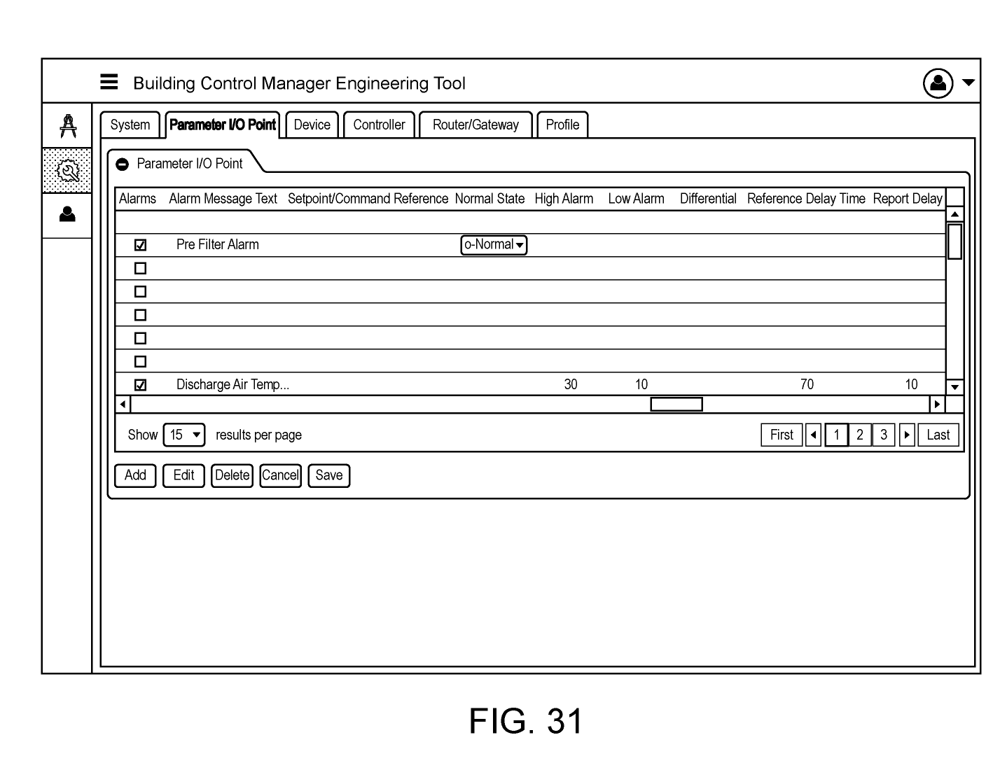

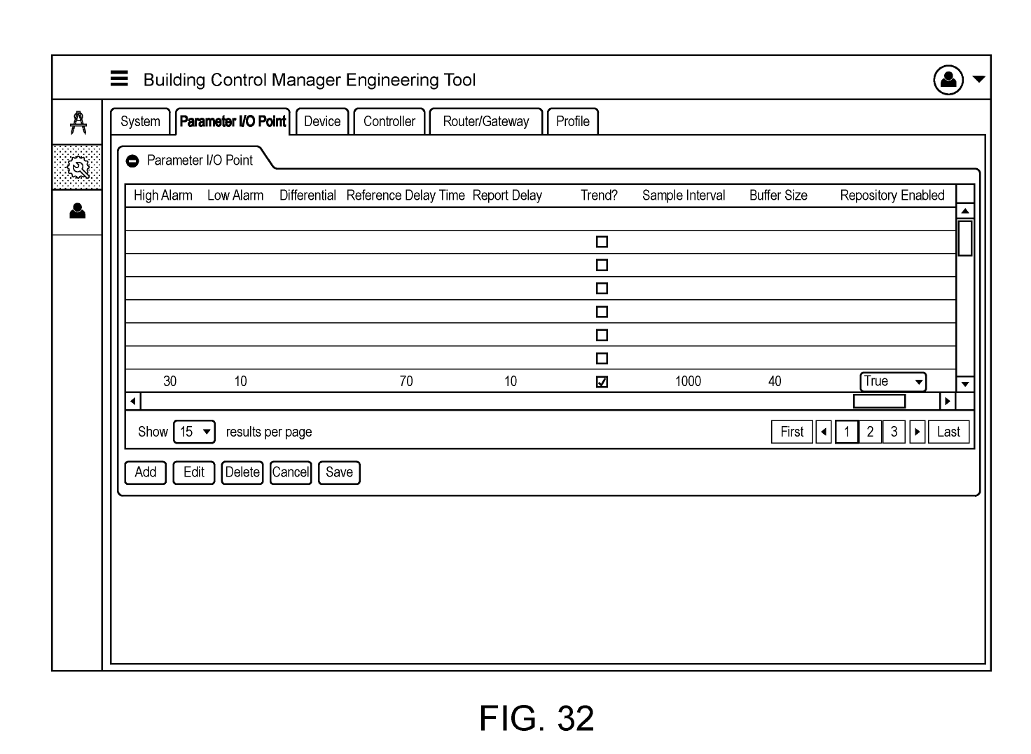

Turning now to FIG. 30, a screenshot illustrating the parameter I/O port interface is shown, according to some embodiments. As shown in FIG. 30, the parameter I/O port interface may include a Parameter I/O port point list. The Parameter I/O point list may represent the summary view of all parameters included in the ET. A user may be able to view all the details added for each parameter in this interface. Turning now to FIGS. 31 and 32, screenshots illustrating a mapped parameter list of the parameter I/O port interface are shown, according to some embodiments. A user may be able to add or edit the mapped parameter list using this interface. The parameters may be linked with the components and sub-components mapped using the system interface.

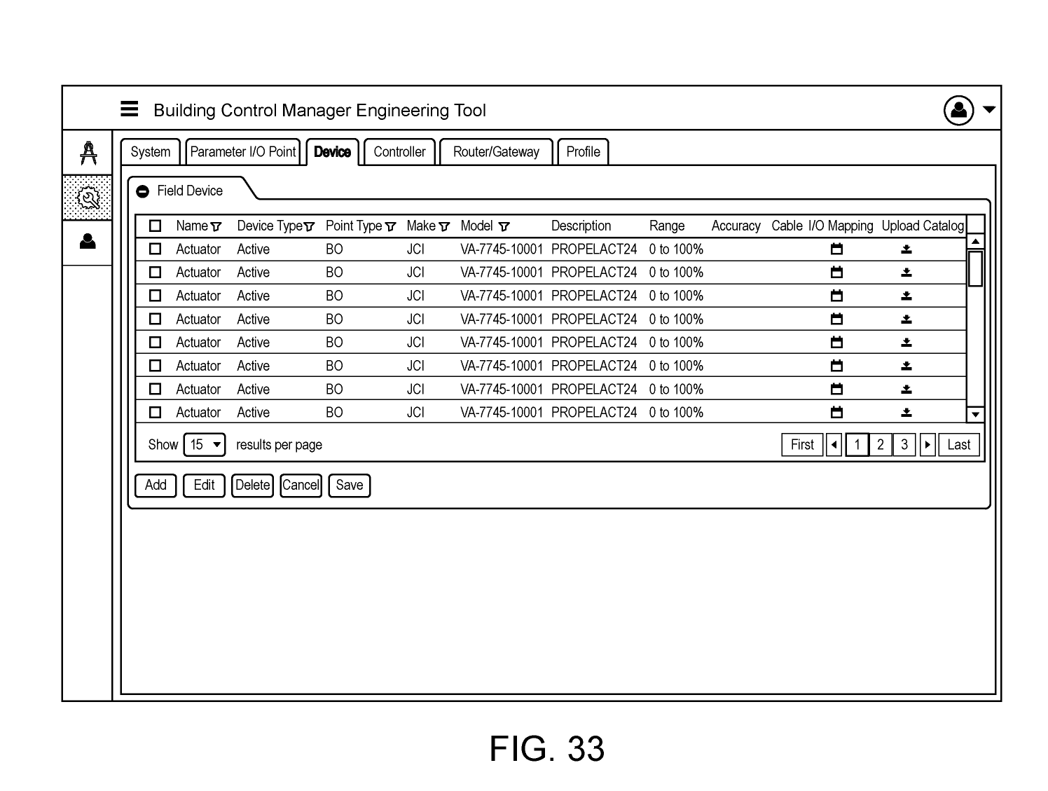

Turning now to FIG. 33, a screenshot illustrating the Device interface is shown, according to some embodiments. The device interface may provide a complete device list with all details associated with each device. A user may be able to add new devices or edit pre-defined devices using the Device interface. The Device interface may also include a search function to allow for a user to search among the devices. The user may further be able to map I/O points to each device using the Device interface. This can assist the user to auto populate the device model for selected parameters within the system engineering process. In some embodiments, a user may be able to upload a data file, such as a .zip file, for any newly added device.

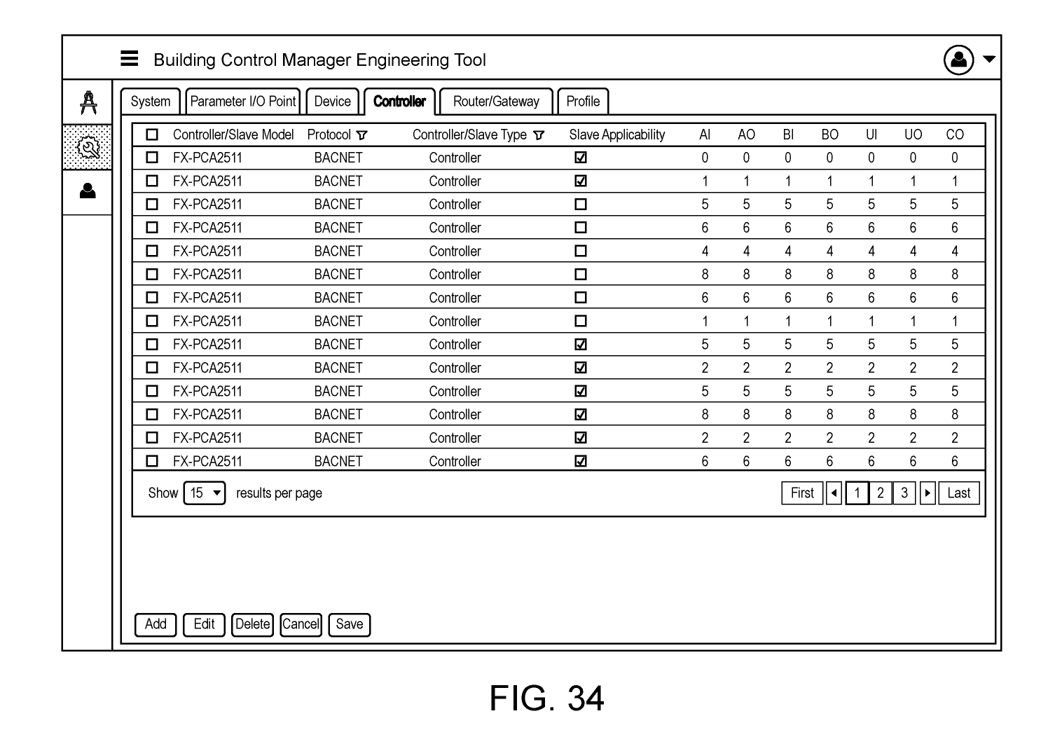

Turning now to FIG. 34, a screenshot illustrating the controller interface is shown, according to some embodiments. The controller interface provide the entire controller list with associated details. A user may be able to add new controllers or edit pre-defined controller details using the controller interface. When adding a new controller model into the controller list, an option may be provided to the user to define the controller type as a controller, a slave or a controller/slave. The slave applicability option may be checked if any slave controllers can connect with a controller. The slave applicability option may be configured to apply to controller or controller/slave categories of controllers only. Controller data point functions may also be listed to show the capacity of each controller. Data points can include analog inputs (AI), analog outputs (AO), binary inputs (BI), binary outputs (BO), universal inputs (UI) and/or universal outputs (UO).

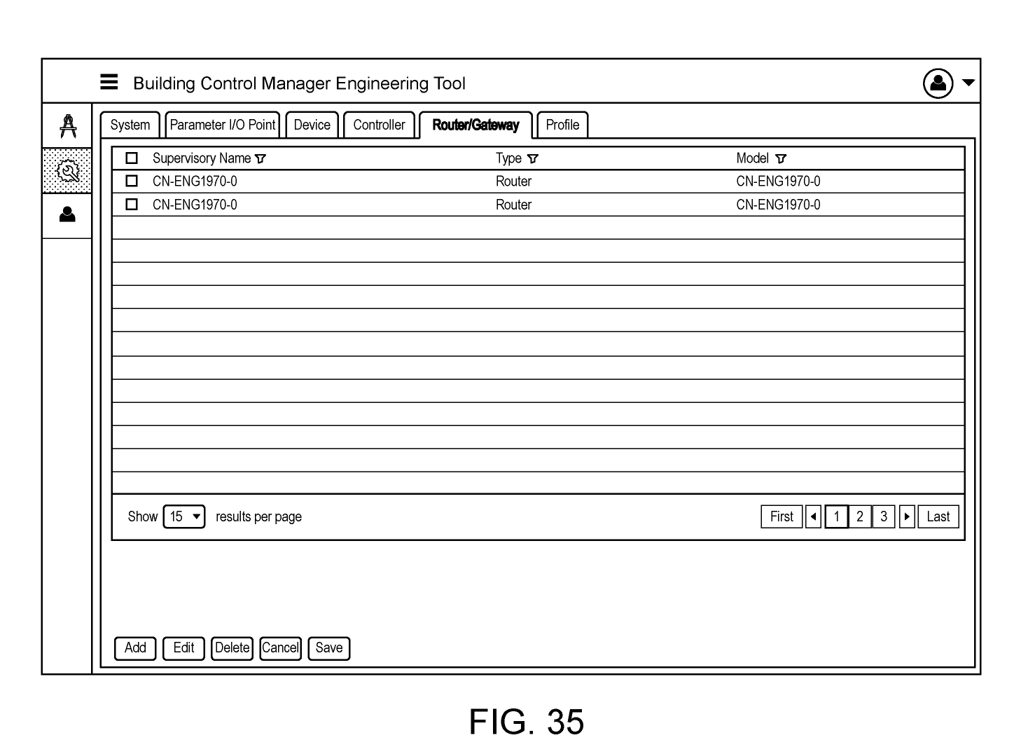

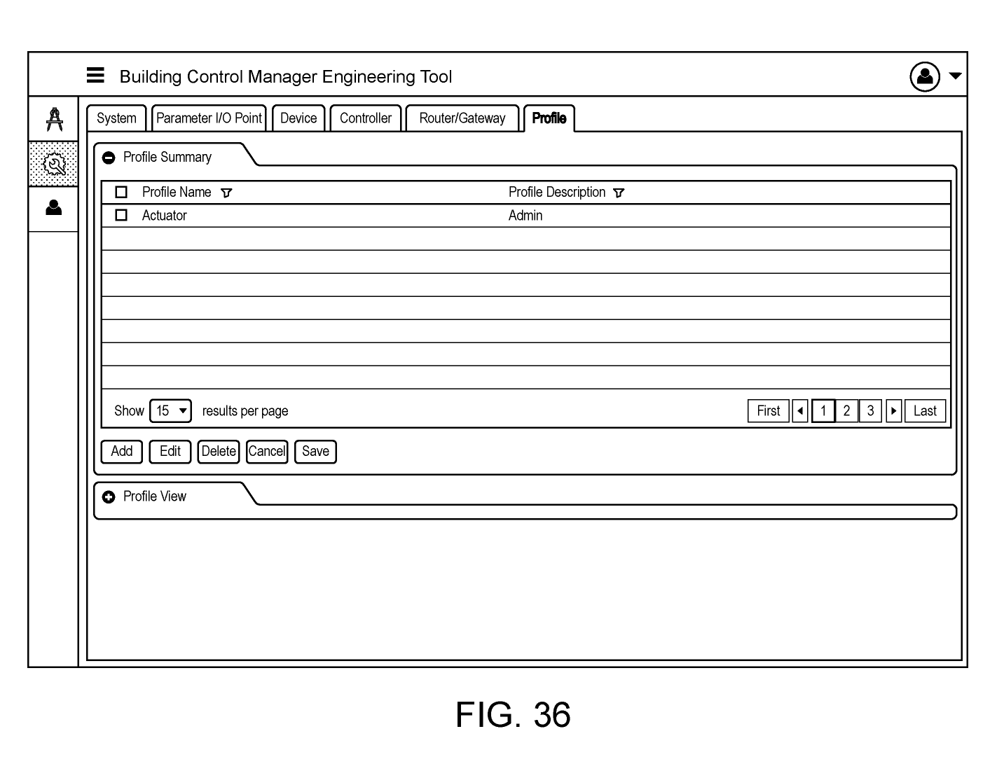

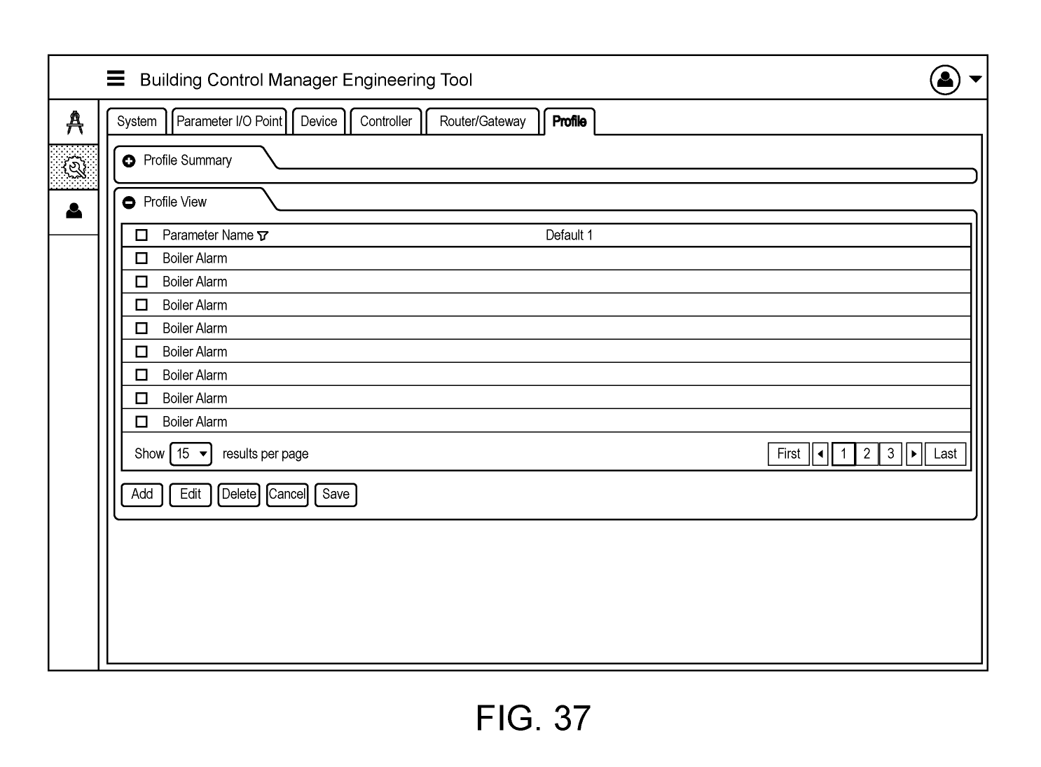

Turning now to FIG. 35, a screenshot illustrating the Router/Gateway interface is shown, according to some embodiments. The Router/Gateway module may provide a list of router and/or gateways, and their respective controller details. A user may be able to add new routers and/or gateways or edit predefined data associated with existing routers and/or gateways via the Router/Gateway interface. Turning now to FIG. 36, a screenshot illustrating the Profiles interface is shown, according to some embodiments. The profiles interface may allow for a user to create and use personalized profile setups which can be used for the engineering process. The profile summary view, as shown in FIG. 25, may allow users to add a required profile with names and descriptions. These added profile details can be modified at a later time. The profile view, as shown in FIG. 37, reflects the added profiles and allows for further editing. The profile view may allow a user to map the default device/model for each parameter. The profile details may be saved and used in project engineering to save time and effort required to select the details for devices, controllers, parameters, etc. A user may be able to create different profiles, such as for hospitals, schools, data centers, etc.

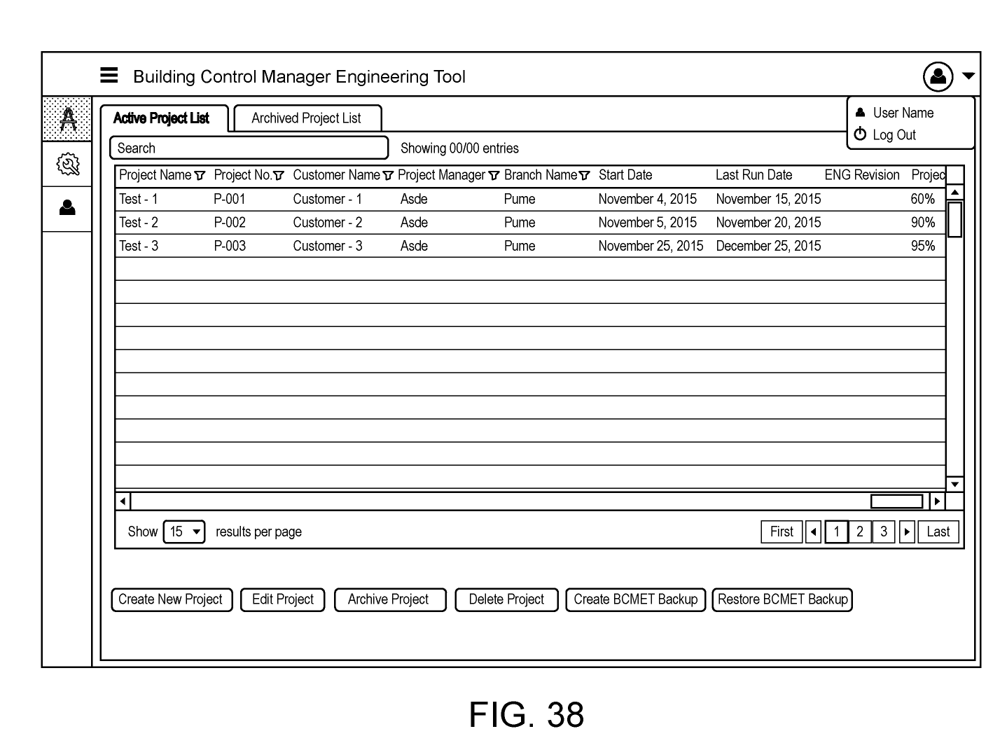

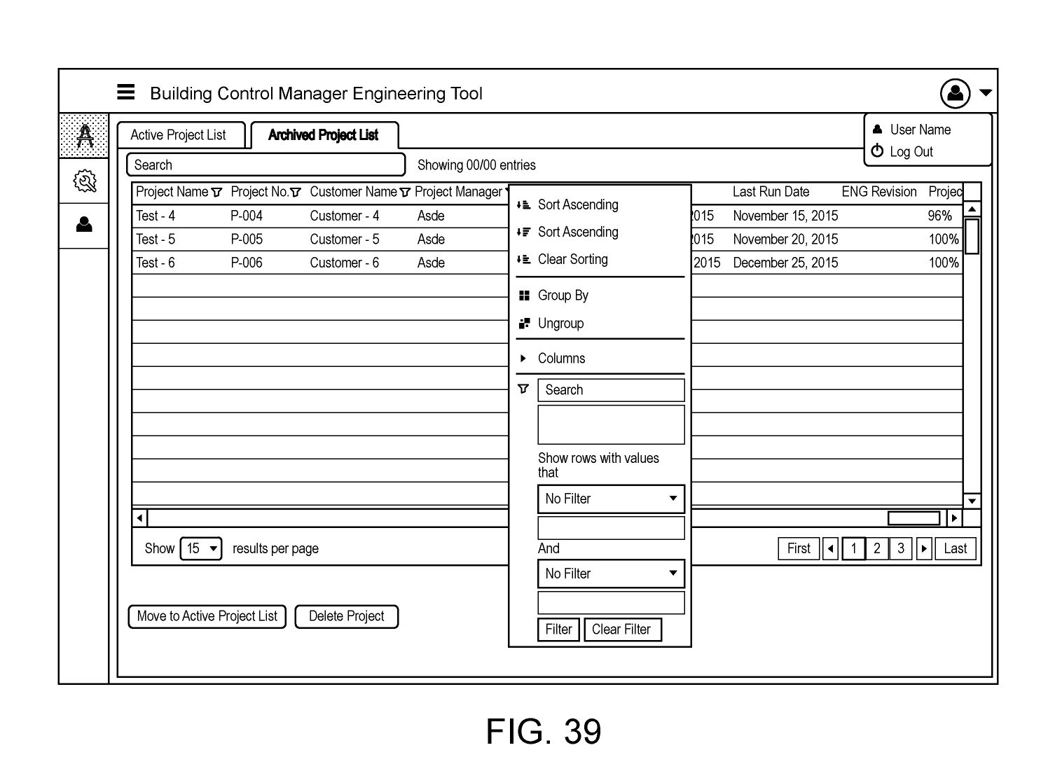

The ET interface may further include an Engineering module, which will be described in the following figures. Turning now to FIG. 38, a screenshot illustrating the active project list interface is shown, according to some embodiments. In one embodiment, the engineering process may start with the Active projects list summary. The active project list interface may allow a user to check projects already added in the ET. The active project list populates initial project information such as Project name, Project number, customer name, project manager, branch name, start date, last revised date, ENG revision, and project % completion. A user may be able to create a new project or edit existing projects via the active project list interface. Additionally, the user may be able to filter and sort the project details via the active project list interface. Turning now to FIG. 39, a screenshot illustrating the archived project list interface is shown, according to some embodiments. The archived project list may include a list of completed projects. The active project list interface and the archived project list interface may have options to “create a new project.”

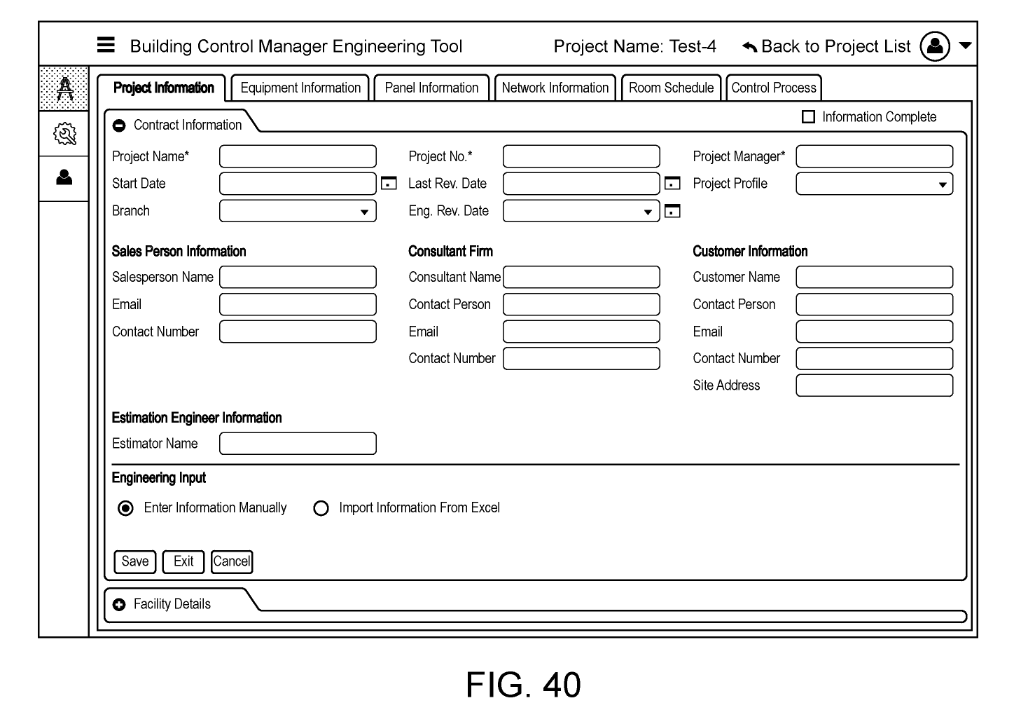

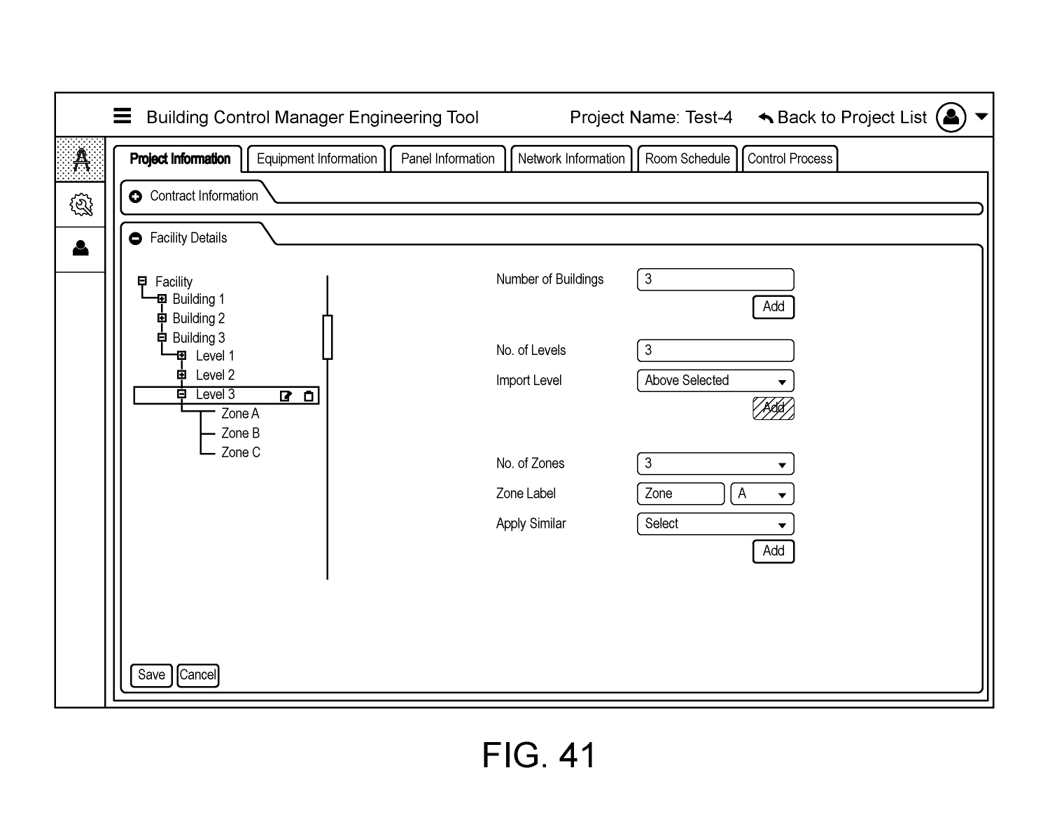

Turning now to FIG. 40, a screenshot illustrating a new project information interface is shown, according to some embodiments. The project information interface includes a contract information tab. The contract information tab may contain all the project related details which a user is able to fill manually. Once the contract information is saved, the filled information may be displayed in a project list grid for the respective project. The contract information tab may have mandatory fields and optional fields. Mandatory fields may include project name, project number, and project manager. The other fields may be optional fields. The project information interface may further include an engineering input field. The engineering input field may allow a user to select input options for the engineering process. Such as whether the information will be entered manually or imported via a standard template. The project information interface may further include a facility details tab, as shown in FIG. 41. The facility details tab can allow for a user to create the facility detailed tree structure and aid the user in mapping the system location details. For example, the user may be able to add buildings by filling in the numbers and names used in the facility. By selecting the add button, all listed building should get added to the facility drop down menu. Once any building from the tree view is selected, a user is able to add levels for the selected building. Once the level name from the tree view is selected, the user should be able to add zones for the selected level and should get default level names. The user may further have the ability to insert levels above or below the selected level. The user may further be able to insert the number of zones and zone names. The facility details tab may allow for standard zone level suffixes to be selected via a drop down menu. Once all the details are added, the user may get a proper tree view structure to view the entire facility details.

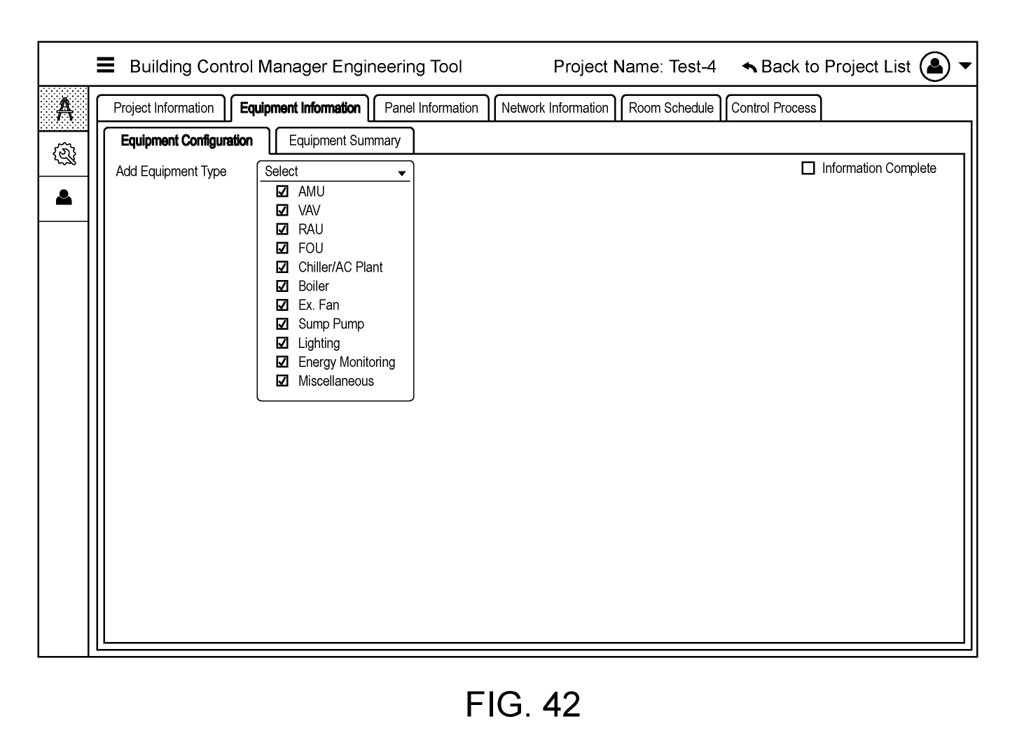

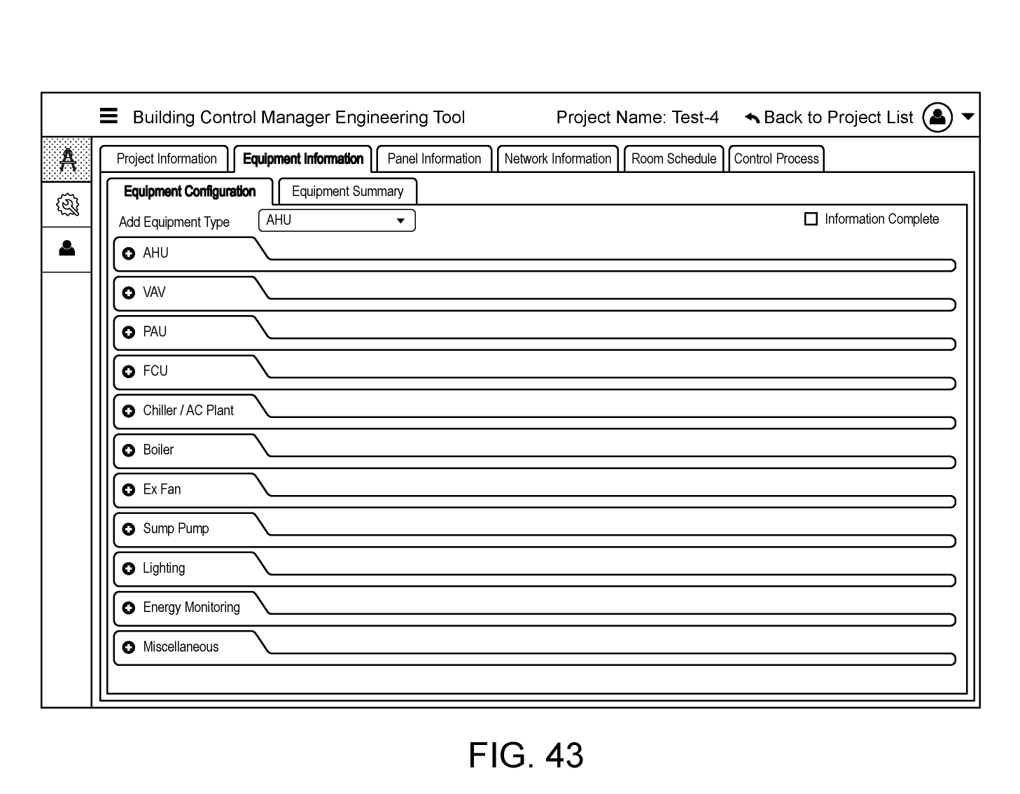

Turning now to FIG. 42, an equipment information interface of the engineering module is shown, according to some embodiments. The equipment information interface may include three sub-tabs: equipment configuration, equipment summary and group configuration. The group configuration tab may only be used for EF and lighting systems. As shown in FIG. 42, the equipment configuration tab may allow for a user to add equipment required for engineering configuration. FIG. 43 illustrates an add equipment interface of the equipment configuration tab. The add equipment interface may include a dropdown menu having all the equipment listed and allowing a user to select multiple pieces of equipment per the project requirements. Once the equipment selection is done, the add button may be selected to get the equipment section populated with all the selected equipment. Similarly, a user should be able to ‘deselect’ from the checkbox to remove the added equipment. If there are no child items created inside an equipment type, then the equipment type should get deselected. Each equipment section may be expandable and collapsible.

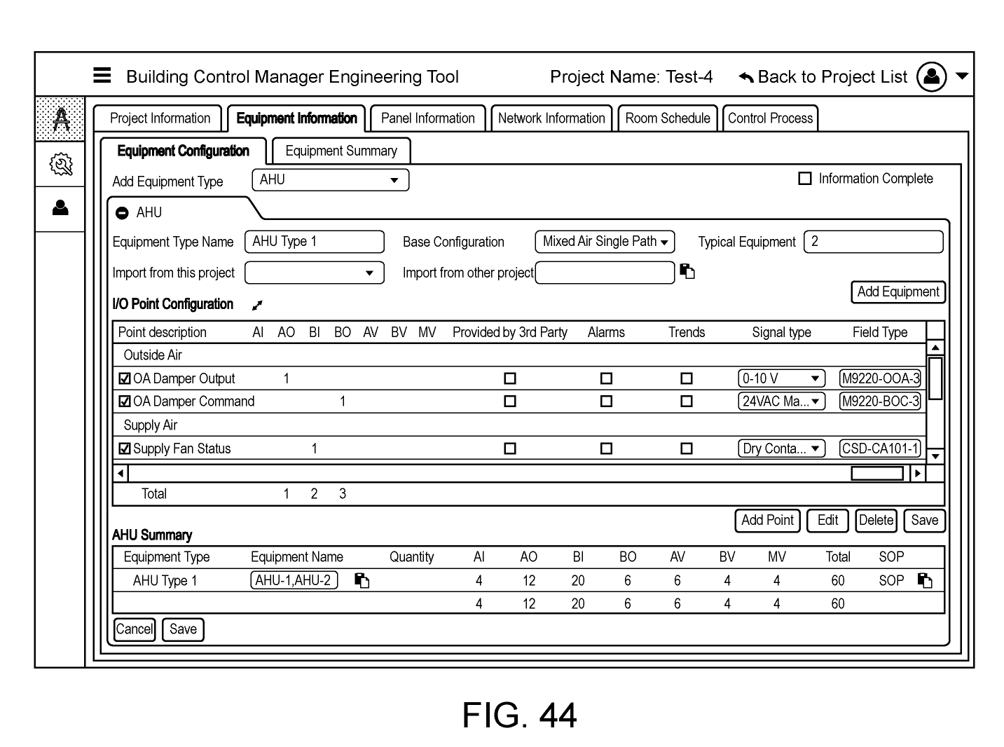

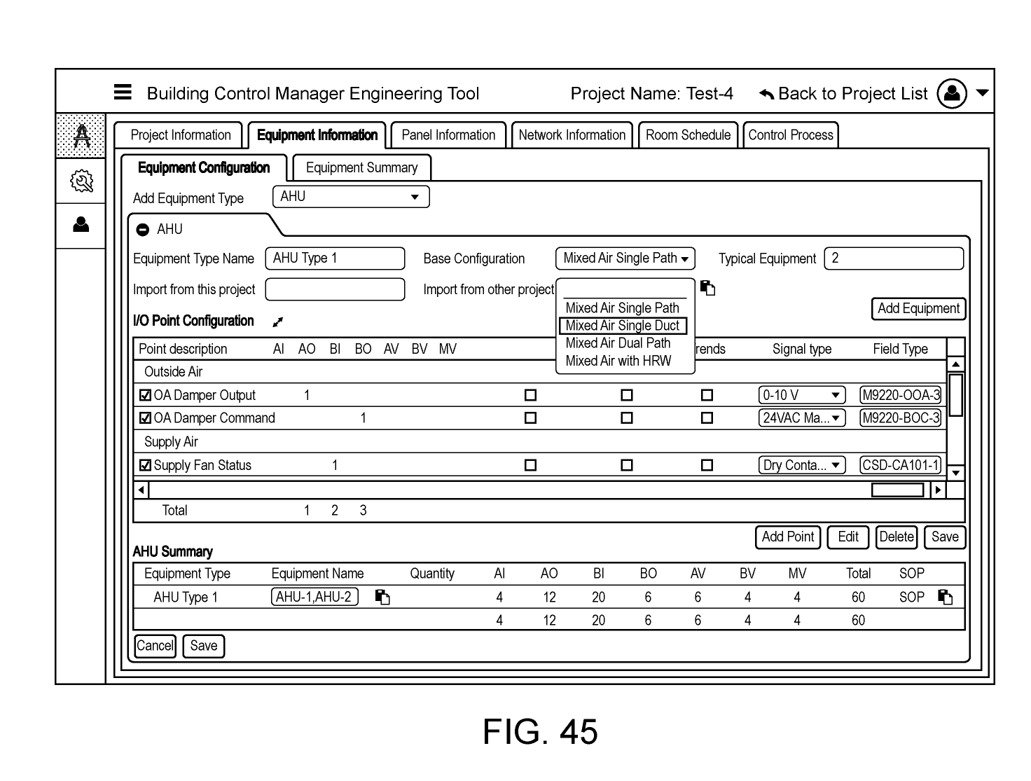

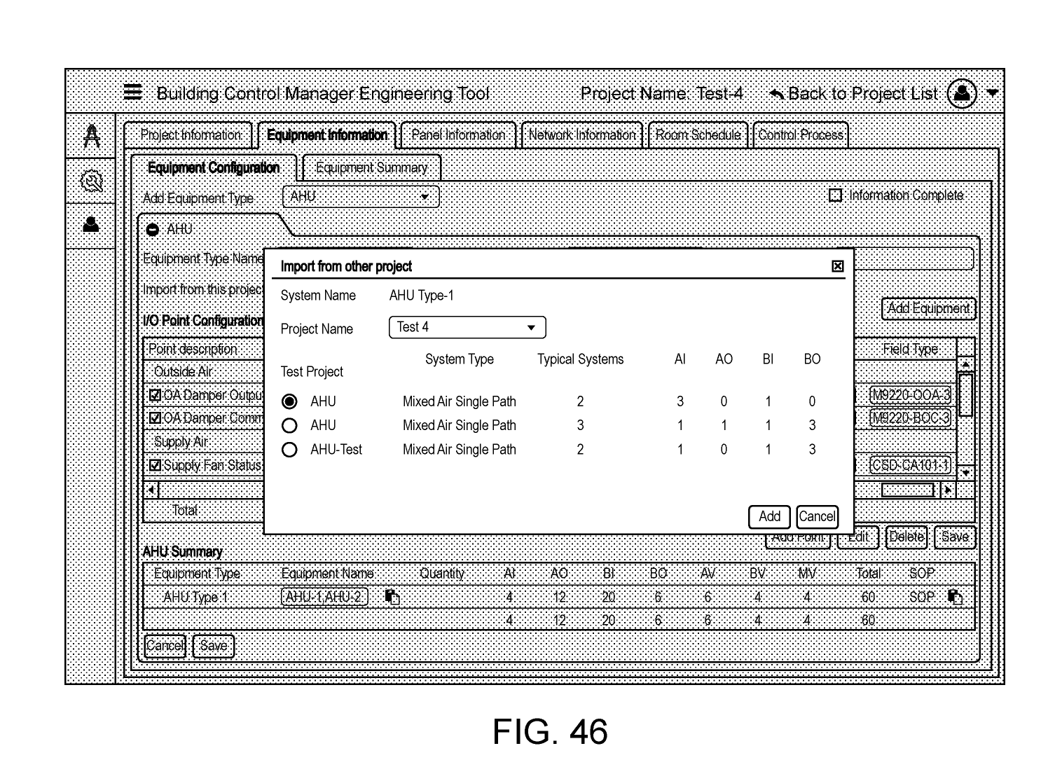

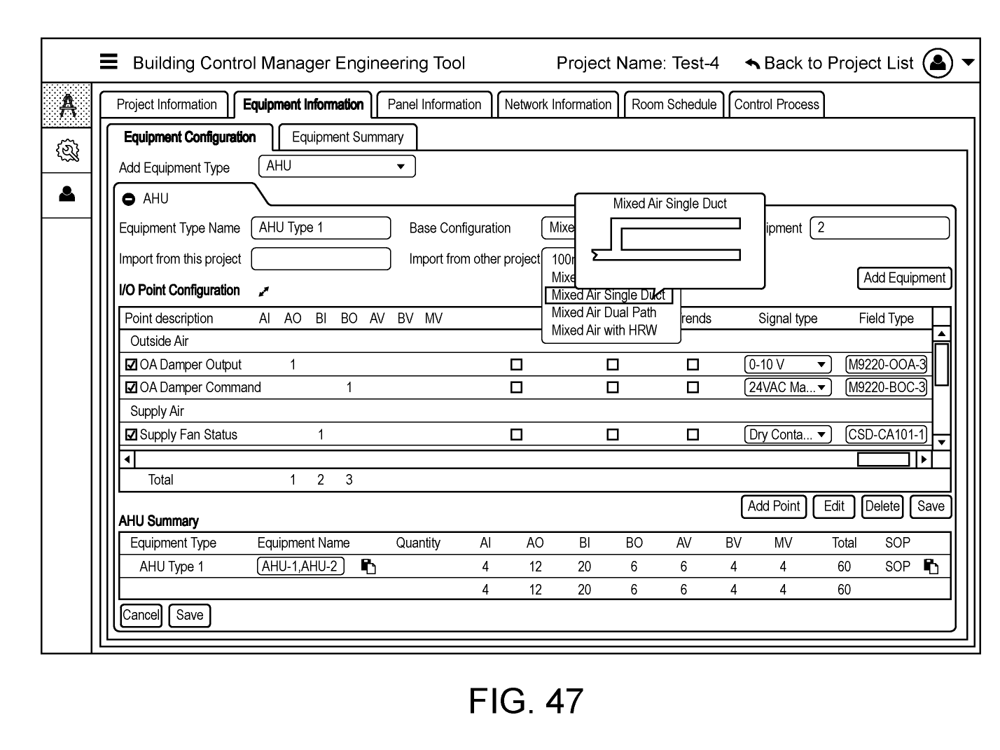

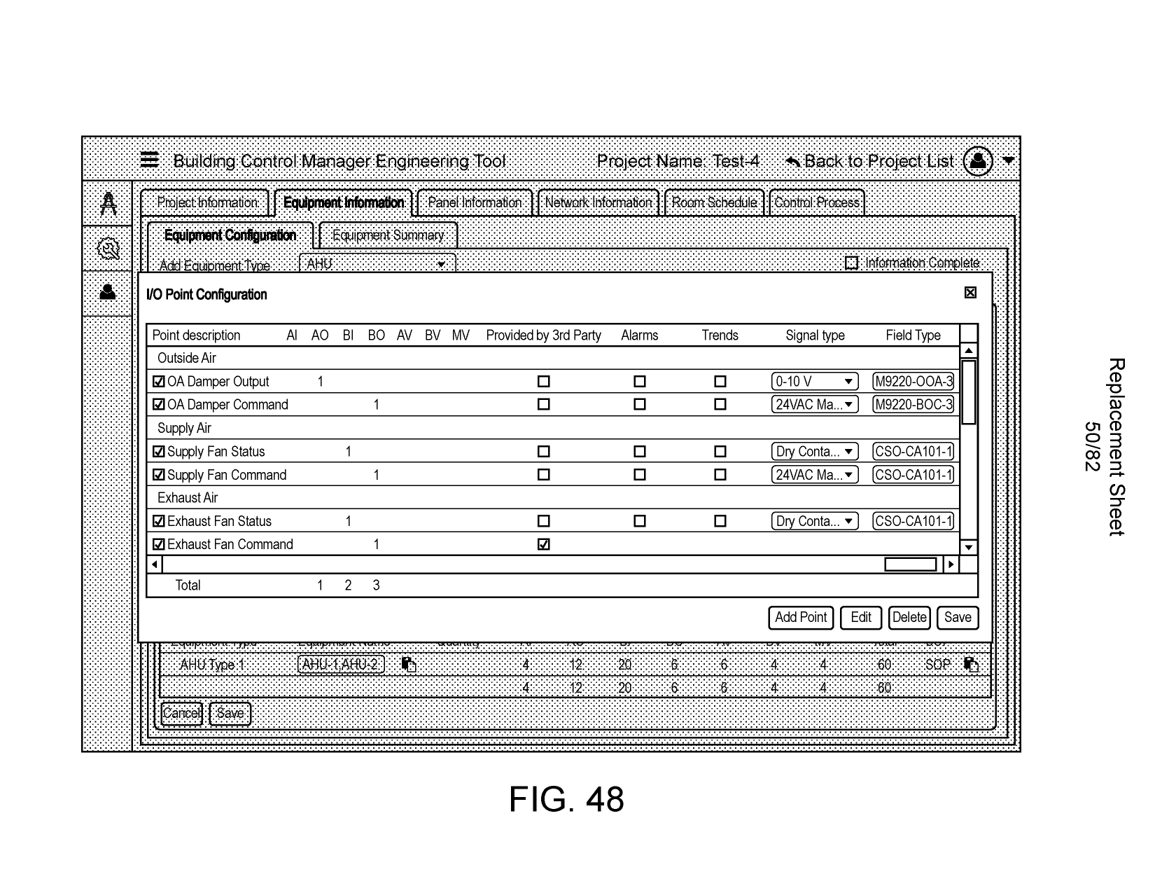

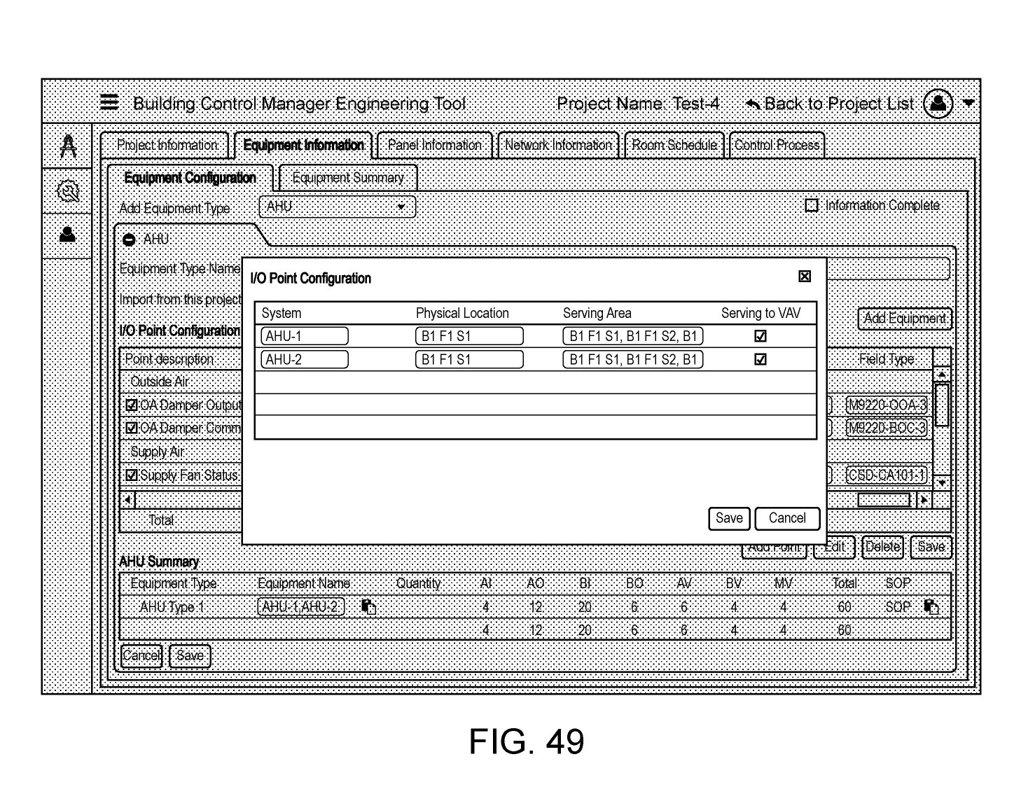

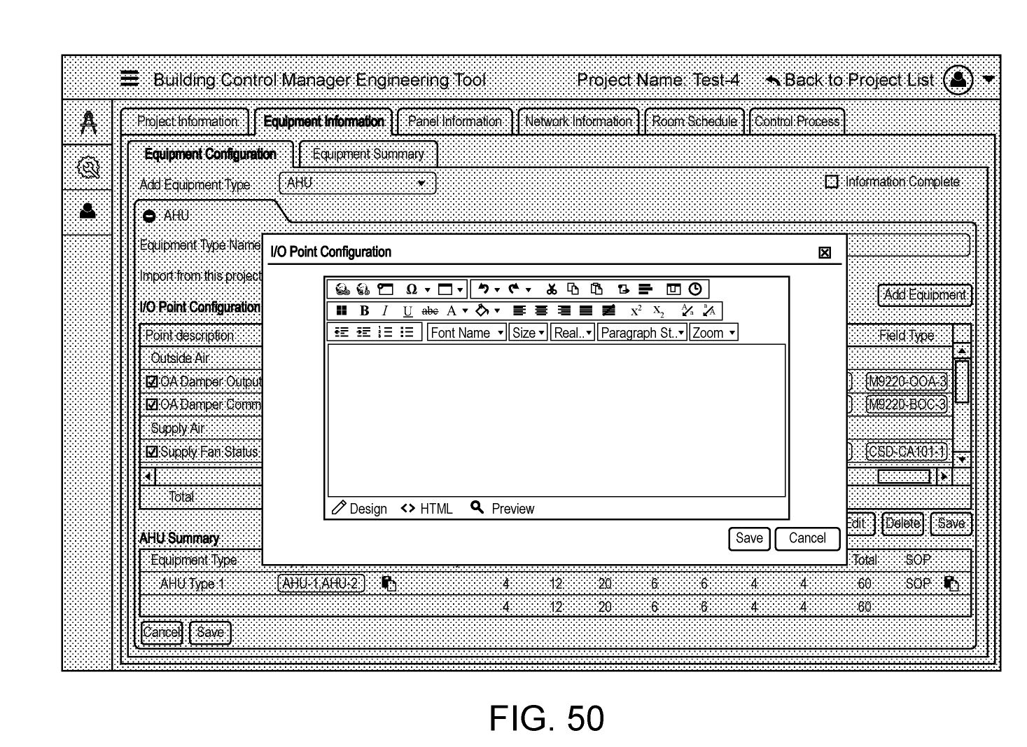

FIG. 44 shows a maximized view of one equipment type, an air handling unit (AHU). From this view, the user may be able to add equipment and select based configurations from the dropdown menu as shown in FIGS. 45 and 46. In some embodiments, by hovering a mouse cursor above the configuration will display a duct layout of the particular equipment type, as shown in FIG. 47. The base configuration selection may aid in populating the point information accordingly. It may also aid in mapping and can auto generate the graphics screen from the BCM UI. Further, a user may be able to use the dropdown options to copy for added equipment or copy from another project. The user may use the I/O point configuration table, shown in FIG. 48, to view all point information which is stored in the BCM database. The user may be provided with default signal types and field devices models as per the master database, and the user may be able to edit the database information as needed for the project. The I/O point configuration data depends as per the equipment and base configuration selected. Further, the user may be able to select the appropriate points needed for the system configuration. If any points have third party devices, then the user should be able to check the checkbox under that column. This should remove the point from hardware points selection and add the third party points for the system. Details can be added to the equipment type and typical systems via the details pop-up display shown in FIG. 49. The pop-up display may reflect the data for equipment type and typical systems added. The system name shown may be auto generated as per the standard naming, but a user may be able to edit the system name as needed. A sequence of operations pop-up may be selected by the user, as shown in FIG. 50. This can allow the user to manually enter the sequence operations.

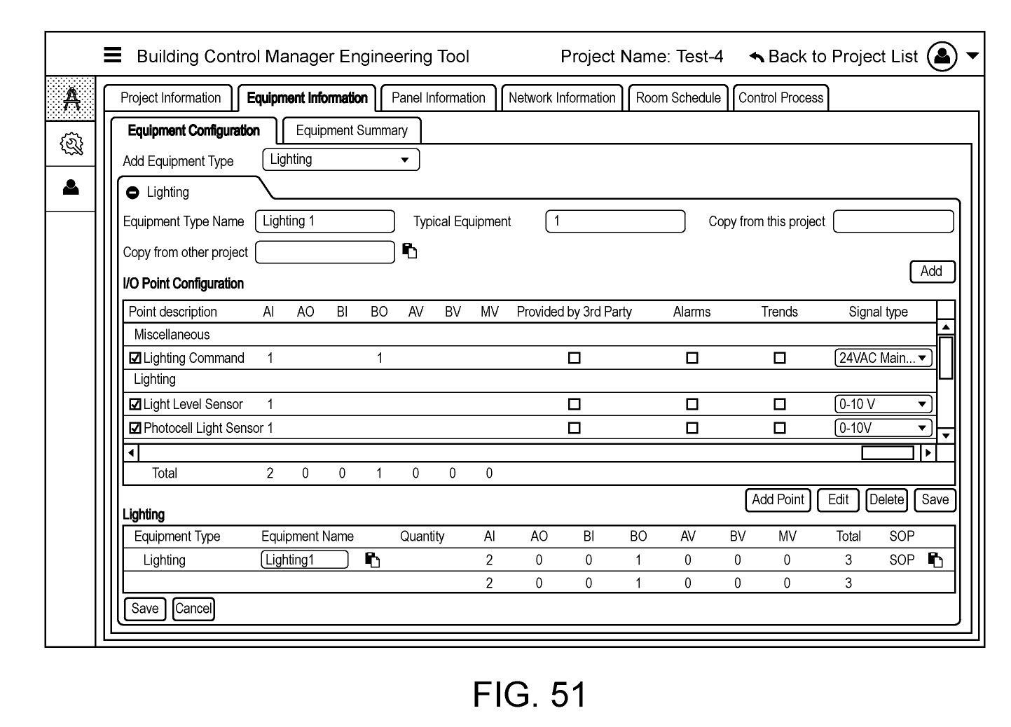

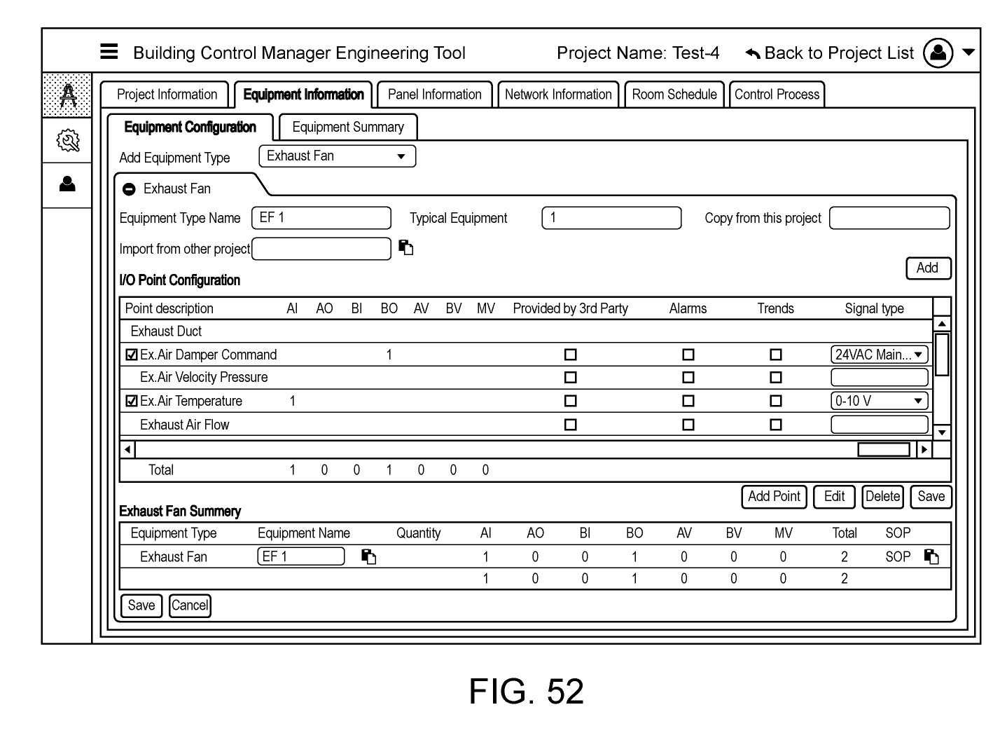

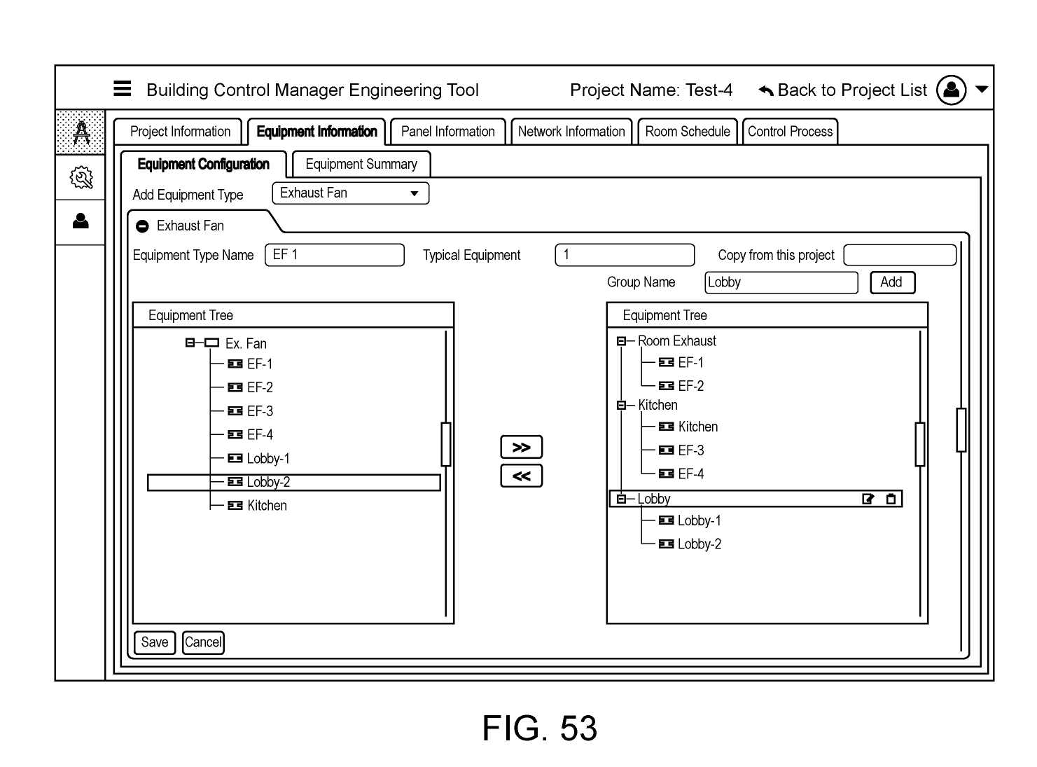

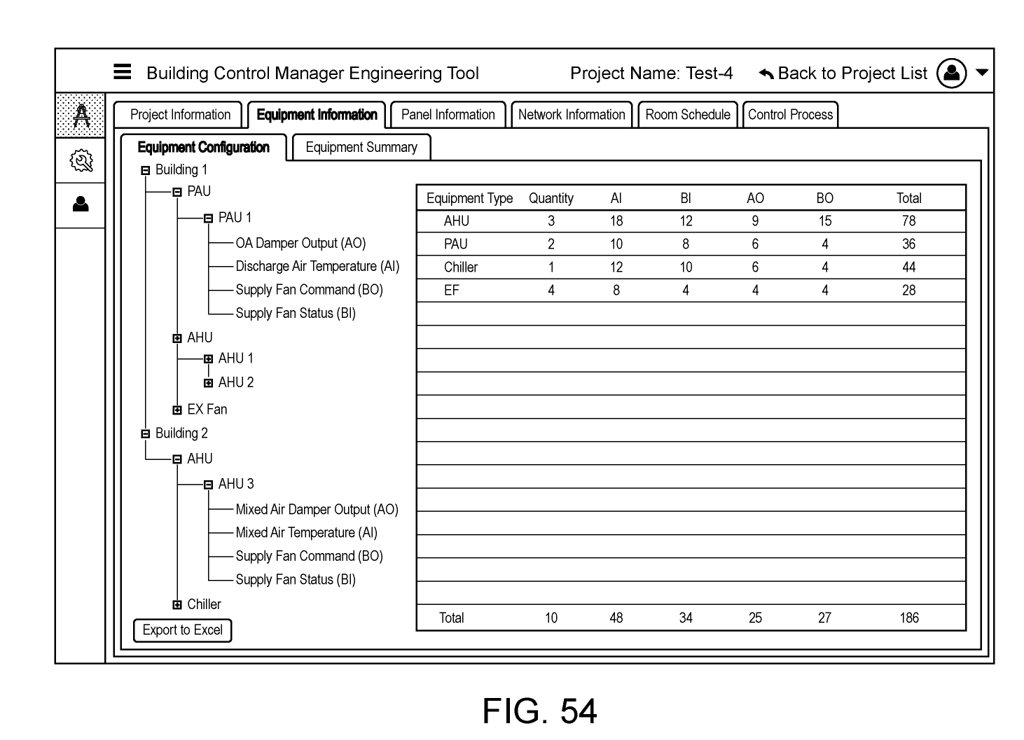

FIG. 51 is a screenshot illustrating the group configuration sub tab, according to some embodiments. FIG. 52 is a screenshot illustrating a further expanded equipment type interface, according to some embodiments. FIG. 53 is a screenshot illustrating the expanded equipment type interface of FIG. 52, with the group configuration interface provided to allow for illustrating the associated equipment tree and group tree. FIG. 54 is a screenshot illustrating an equipment summary interface, according to some embodiments. The equipment summary interface is auto generated by the system and should display all selected equipment and hardware points.

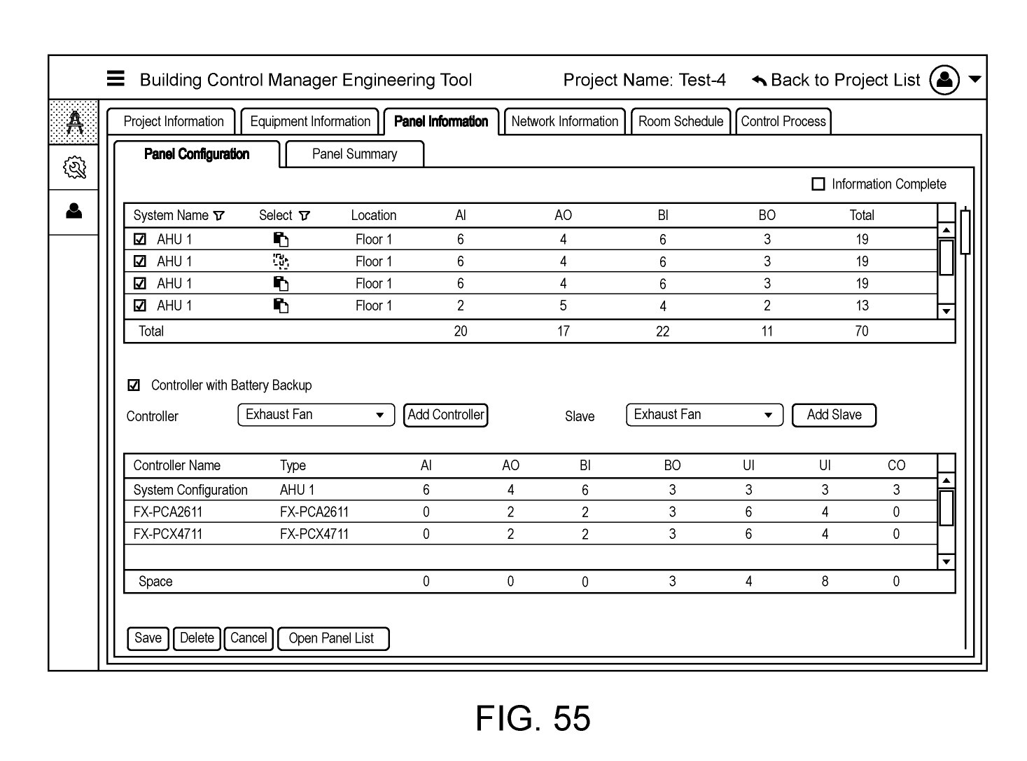

Turning to FIG. 55, a panel information interface is shown, according to some embodiments. The panel information interface may have a panel configuration interface, as shown in FIG. 55, and a panel summary interface. The panel configuration interface may represent the entire equipment summary which may be auto generated, as described above. By selecting one of the listed systems, a system information pop-up may be generated, containing the system name, the system type, and point selection details. A select button may be available to select one or more required points to be added to the controller and/or slave device. A controller summary table may further be generated which may represent the system configuration as per the system selection in the system summary. The system configuration may fulfil the requirements of the panel selection. The controller summary table may further allow a user to add details related to the controller and/or slave devices. Further, the user may be able to assign each system/equipment to a respective panel using the panel information interface. The panel summary interface may contain the details of all added controllers, slaves, and panels. Further, a point allocation function may be allowed for each added panel.

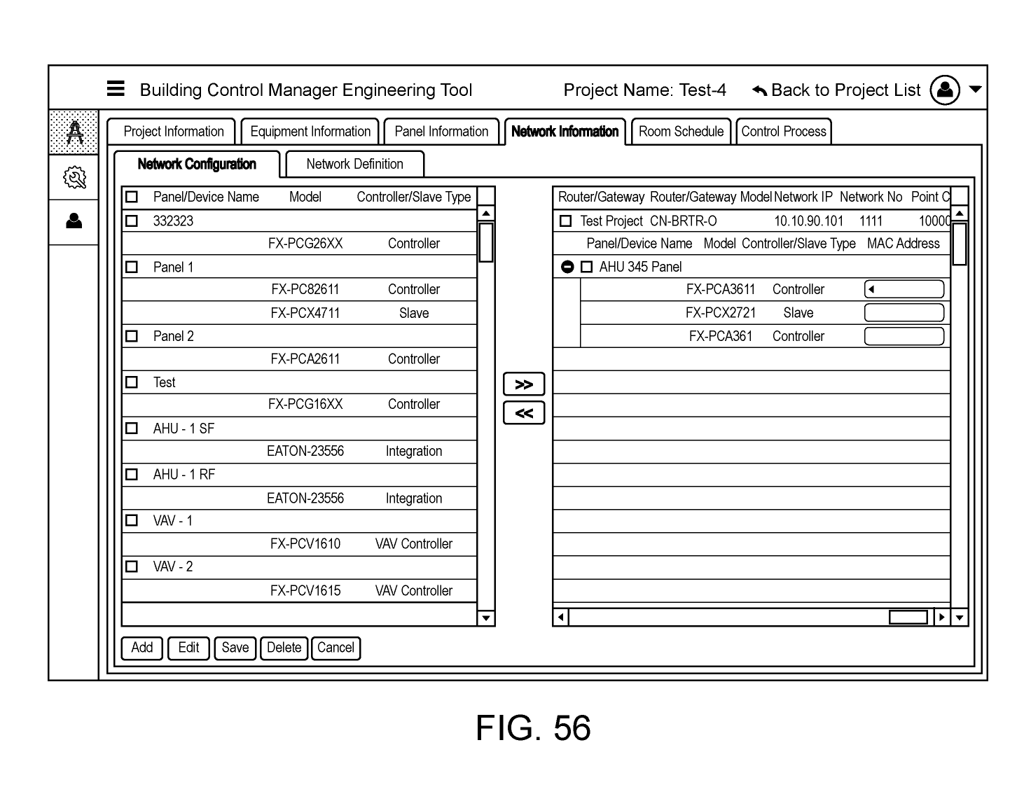

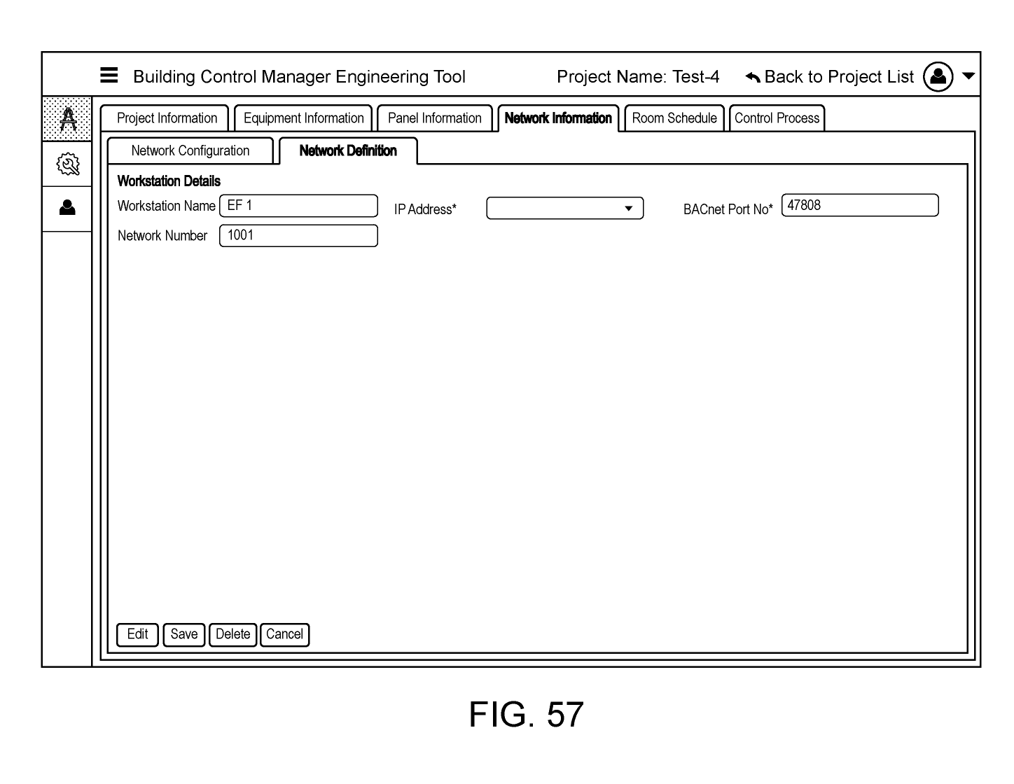

Turning now to FIG. 56, a network information interface is shown, according to some embodiments. The left side table of the network information interface can provide a summary of all panels added into the project. This summary may be auto generated by the ET. The right side panel can provide a provision to add routers and/or gateway controllers with IP addresses and network details. In one embodiment, a user can drag and drop a selected panel to a specific router to assign the panel s with a respective router/gateway. Turning now to FIG. 57, a network definition tab is shown, according to some embodiments. The user may be able to add workstation details using via the network definition tab, including address details, BACnet port numbers, and network numbers.

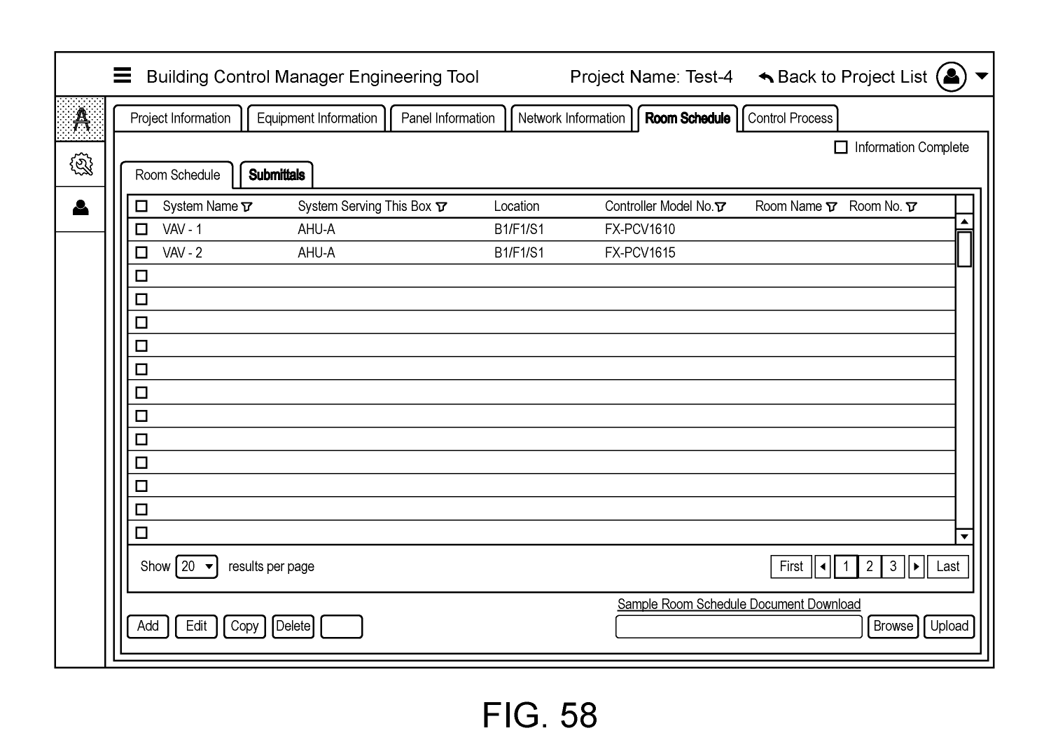

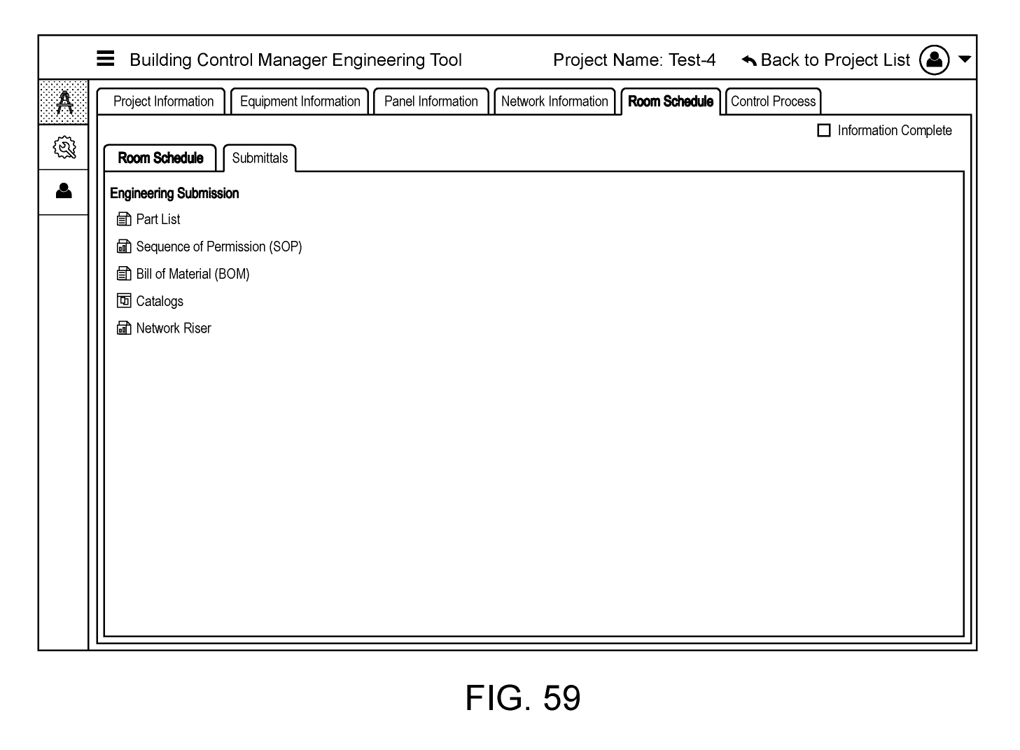

Turning now to FIG. 58, a screenshot illustrating a room schedule interface is shown, according to some embodiments. The room schedule interface is used to define details associated with one or more VAV devices. The room schedule interface may provide the box model, the serving AHU and serving details. The room schedule interface may further allow a user to create a room schedule by using one or more buttons provided in the room schedule interface. Alternatively, a user may be able to import a spreadsheet with the required data. The room schedule data may synchronize with the UI application to show the serving AHU, serving area, and VAV type. The submittal section, as shown in FIG. 59, is an area where the user can view or download the files from the project. These files are created automatically once the engineering flow completion is done. The submittal section may further provide a bill of materials for the project. In one embodiment, the bill of materials is provide via a spreadsheet.

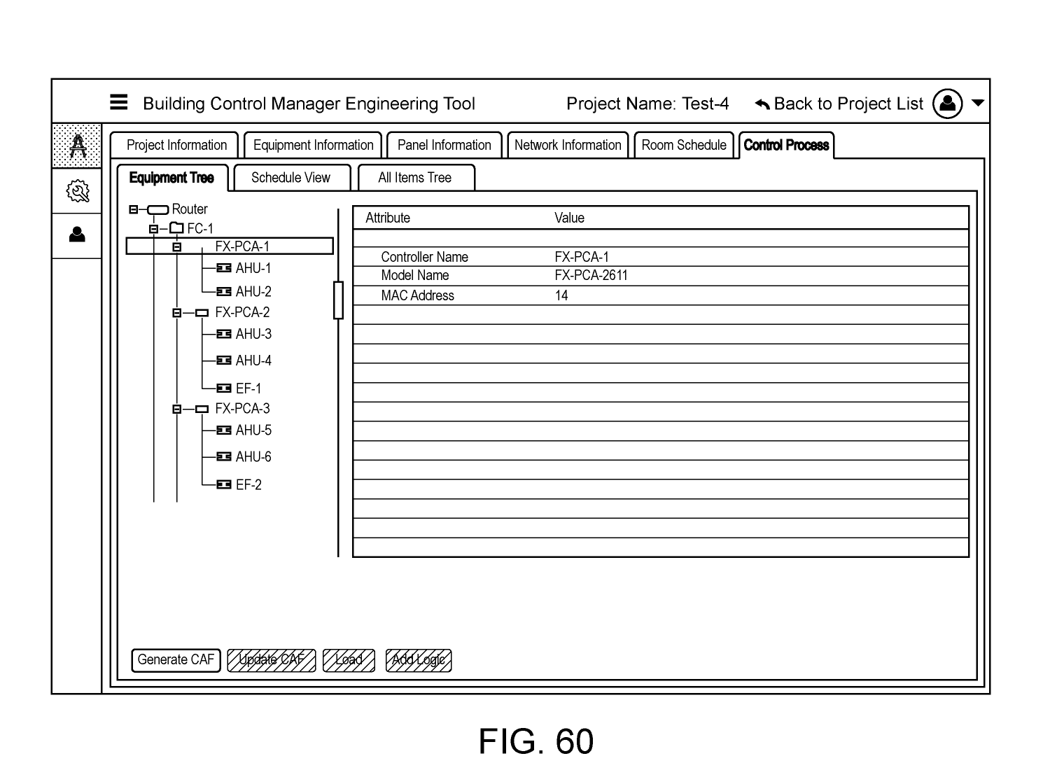

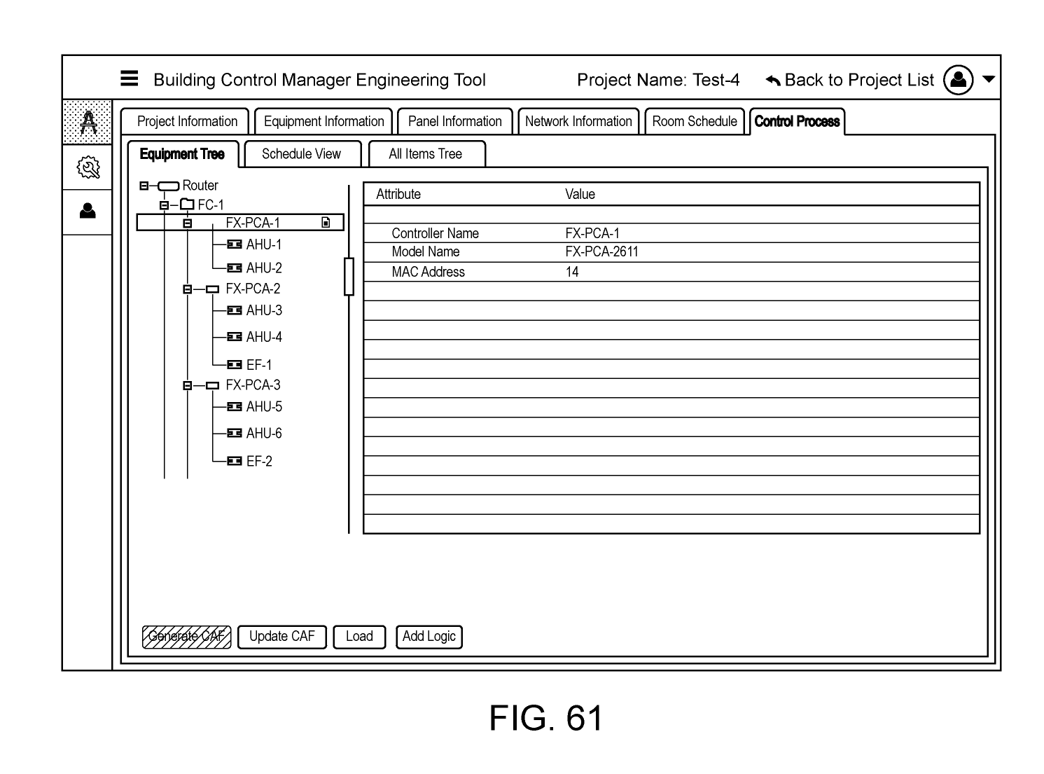

Turning now to FIG. 60, a control process interface is shown, according to some embodiments. The control process interface includes three tabs, an equipment tree tab, a schedule view tab, and an all items tree. The equipment tree, as shown in FIG. 60 lists all available controllers on a trunk and the respective equipment associated with each controller. The equipment tree may provide the controller name, model number and MAC address details in the right panel. In the equipment tree tab, the user may have the ability to generate a CAF, update a CAF, load a CAF, and add logic. By selecting the generate CAF button, the user is provided with CAF files for all controllers. The CAF files may have inputs and outputs added as per the Panel I/O configuration. The load, update CAF and add logic buttons may only be enabled if there is already a CAF file available for a selected controller, as shown in FIG. 61. The user should be able to load controllers at any time after generating the CAF files. The user may further be able to load I/O at the first stage of commissioning and can again load the files when logic and the control process objects are added.

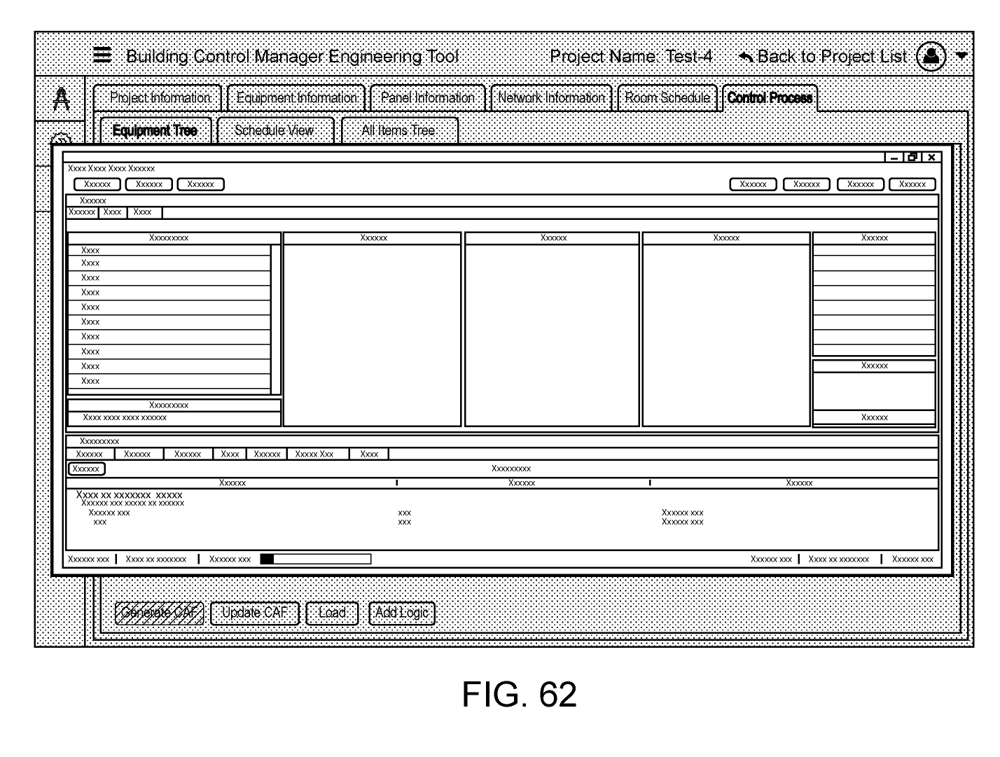

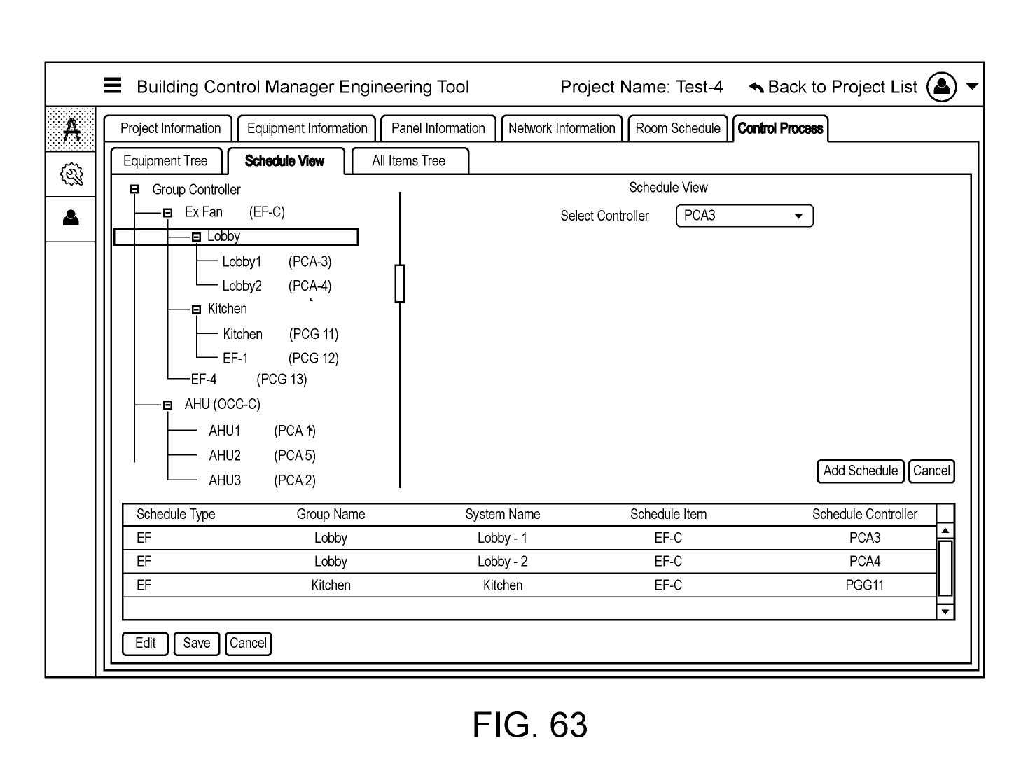

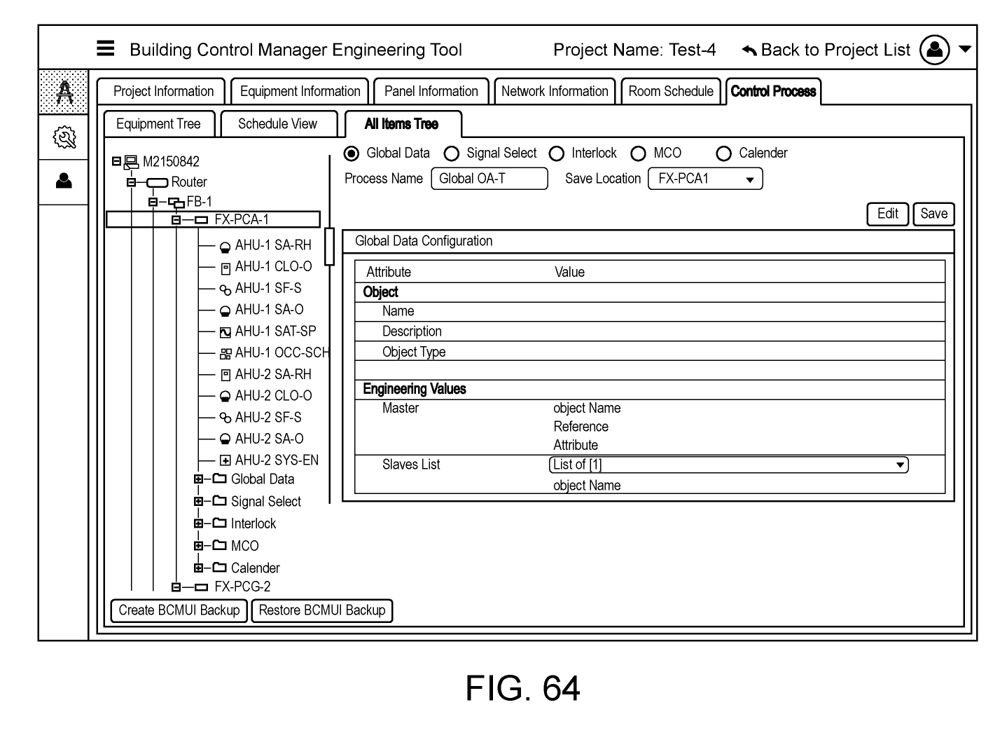

By selecting the add logic button, the CAF file may be opened in a PCT window, and the user may be able to manually add logic as per the sequence of operations, as shown in FIG. 62. FIG. 63 illustrates the schedule view tab. The schedule view tab allows a user to generate an equipment tree as per groups of systems and/or equipment. Each equipment type may have a standard schedule item. When any equipment from the group tree is selected, the user may get the facility to select a controller where the respective equipment's schedule will get added as well. FIG. 64 illustrates the all items tree tab. The all items tree may have a complete network tree view with routers, controllers, equipment and all hardware as well as software points. The user may further be able to add multiple control objects, such as Global Data, Signal Select, Interlocks, Calendars, and/or MCO objects. Further, the user may be able to add references in all control objects. The references may be hardware/software points from JCI and third party controllers. The user may also be able to add empty control objects without any references, and a user can edit those from the online ET from the CBM UI. The user may further be able to backup the ET user tree and restore the same using the Create BCM UI backup and restore BCM UI backup buttons, respectively.

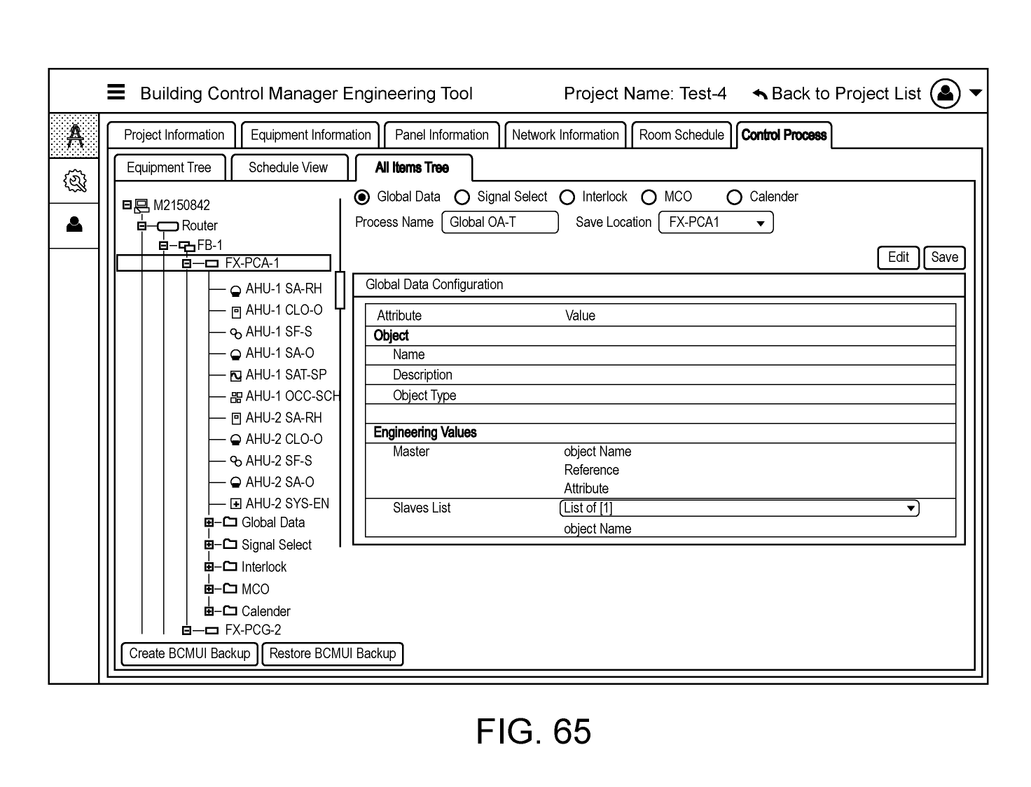

Turning now to FIG. 65, the global data sharing object interface of the all items tab is shown, according to some embodiments. The global data sharing object interface may provide a means for distributing information about changes in a single attribute value to other attribute reference points. For example, a project might have multiple AHUs on its network, but only one has an outdoor air sensor. The global data sharing object may share the value from the single sensor with the other AHUs. The user may be able to configure new global data objects. The user may further be able to view/edit added global data objects.

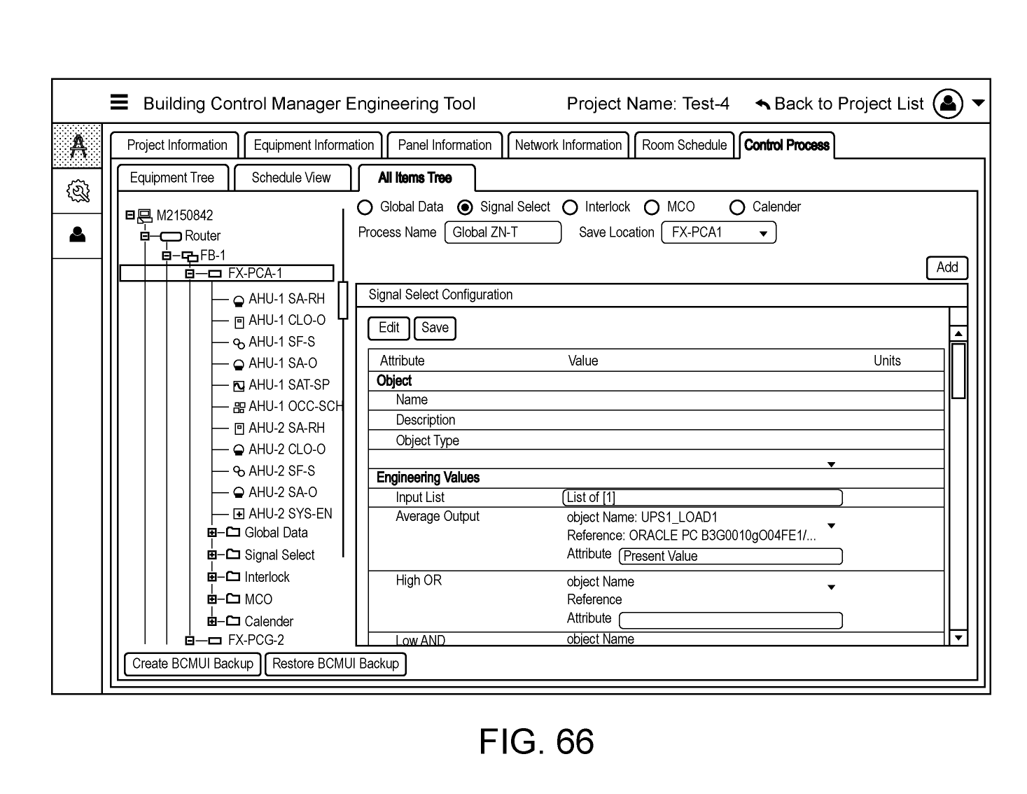

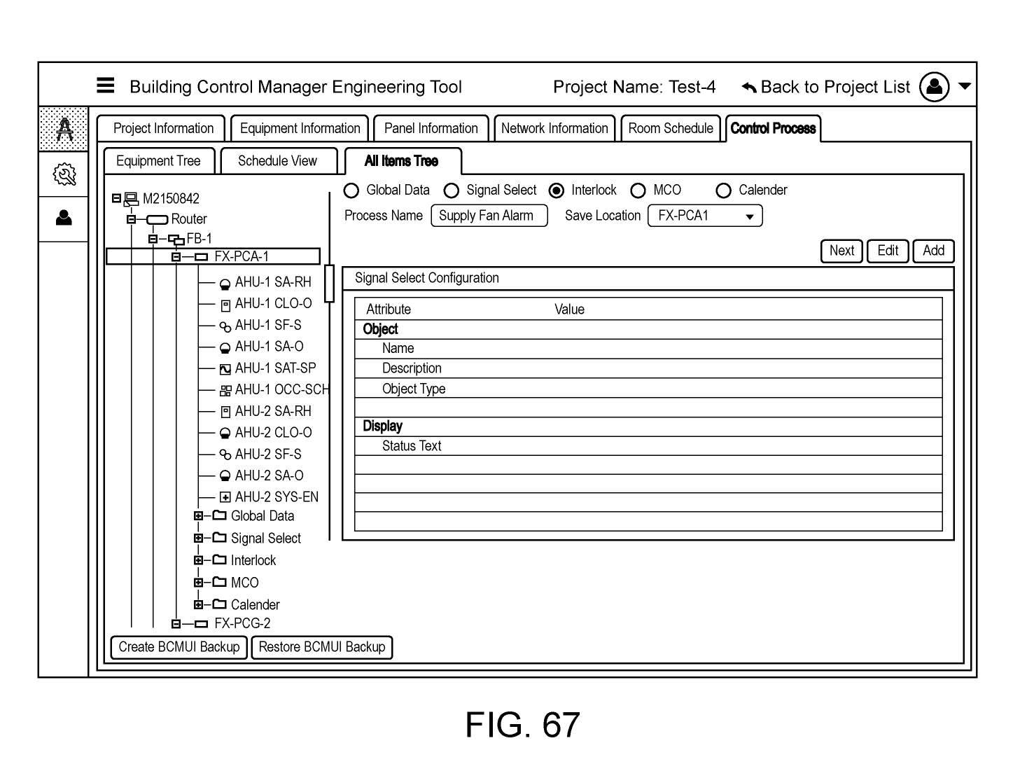

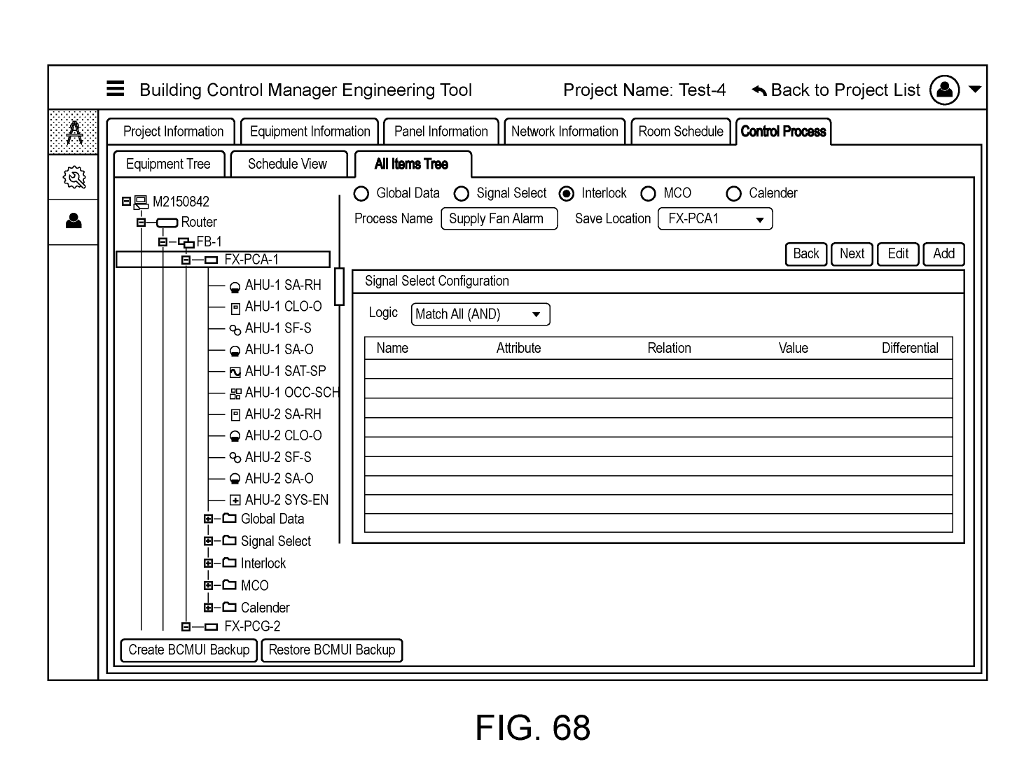

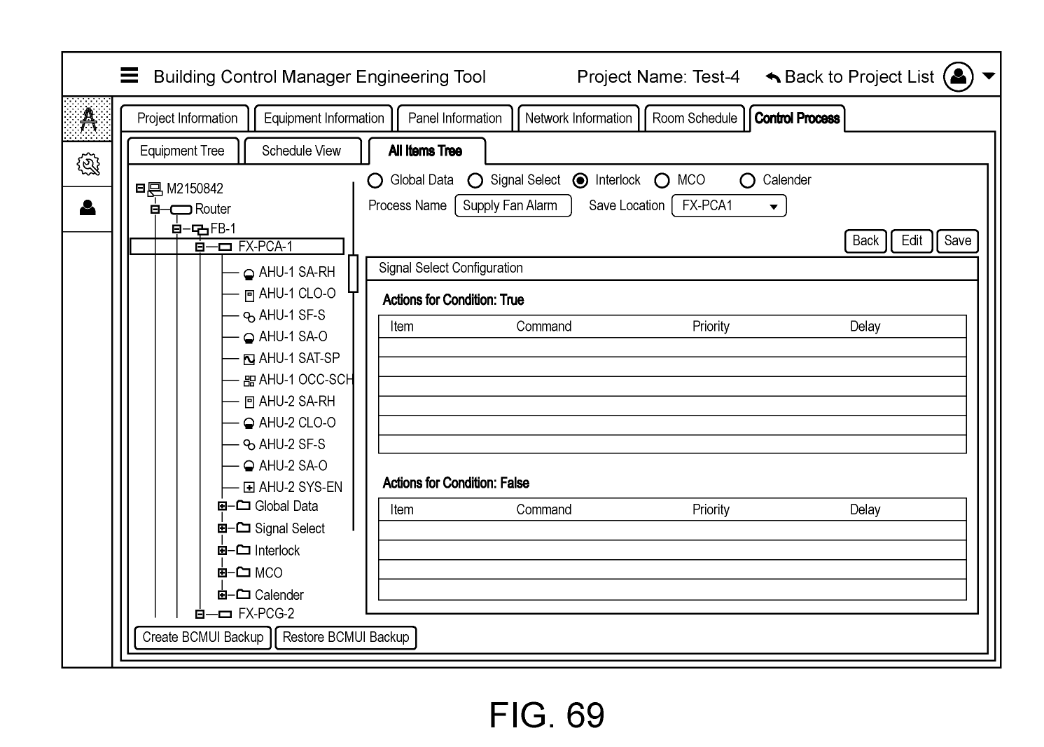

Turning now to FIG. 66, the signal select object interface of the all items tab is shown, according to some embodiments. The signal select object may process values from multiple zones to adjust various set points and can function with either analog or binary points. The user should be able to configure new signal select objects and can further view and/or edit added signal select objects. FIG. 67 illustrates the interlock object interface of the all items tab, according to some embodiments. The interlock object provides a means to establish conditional control over one or more other objects. The user may select the type of logic associated with the interlock, such as AND logic, OR logic, or complex logic, as shown in FIG. 68. FIG. 69 illustrates the user of an IF conditional statement, true-command statements, and false command statements. Through these statements, the user may specify a set of conditional checks (using one or more points) for which a series of commands is used to control a collection of one or more objects.

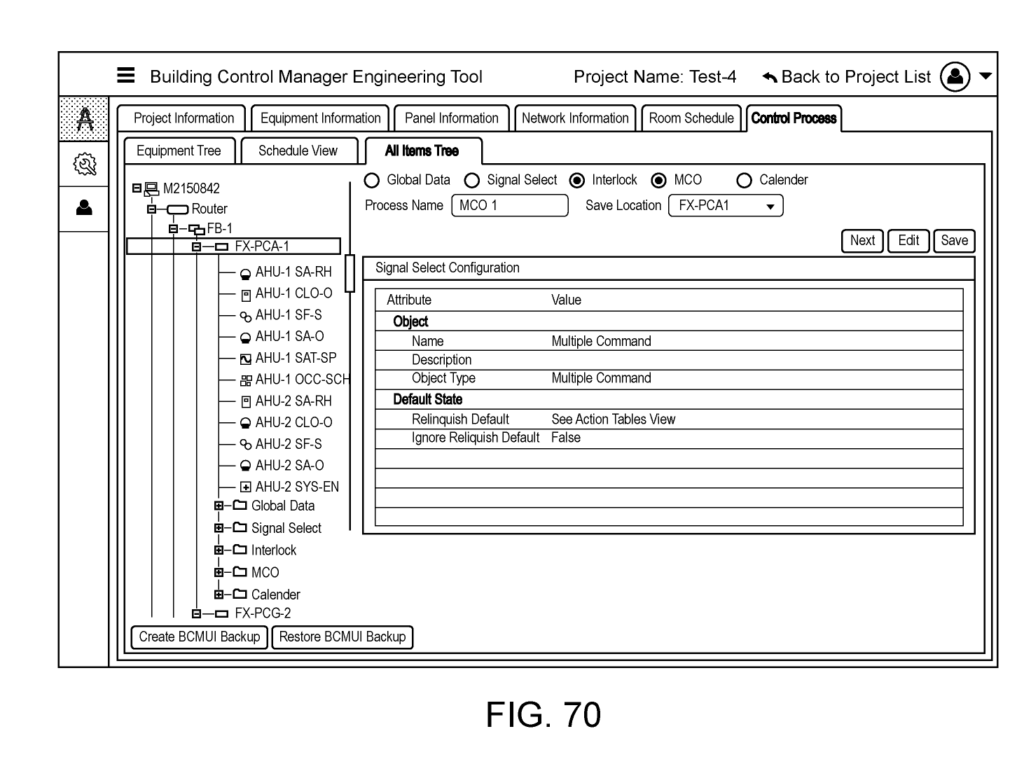

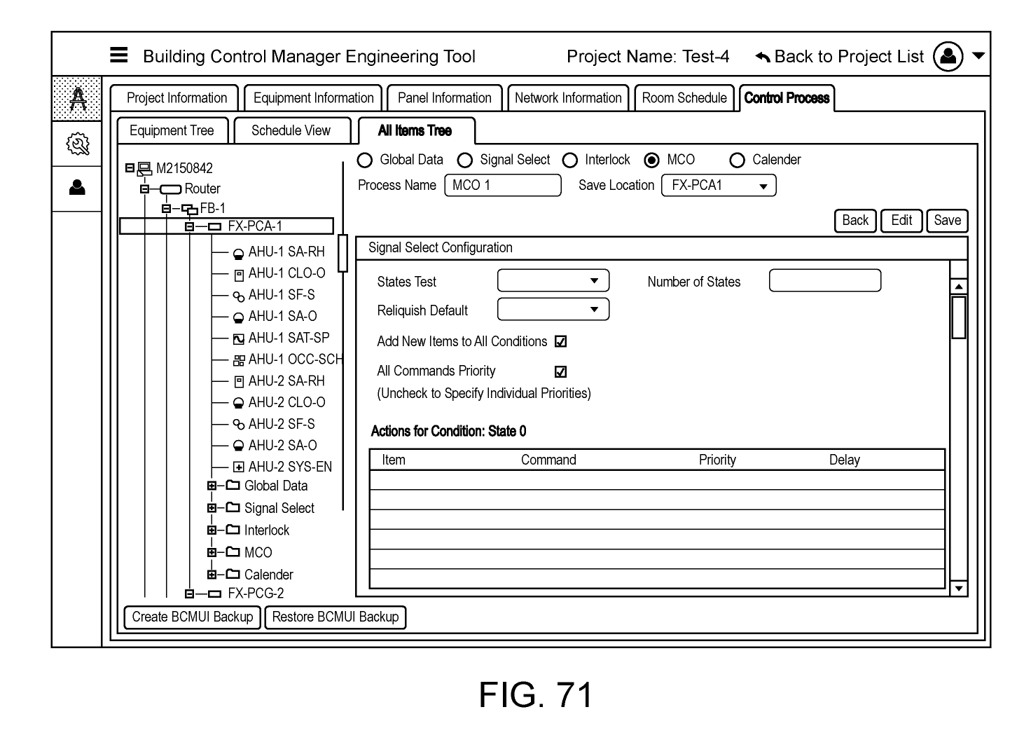

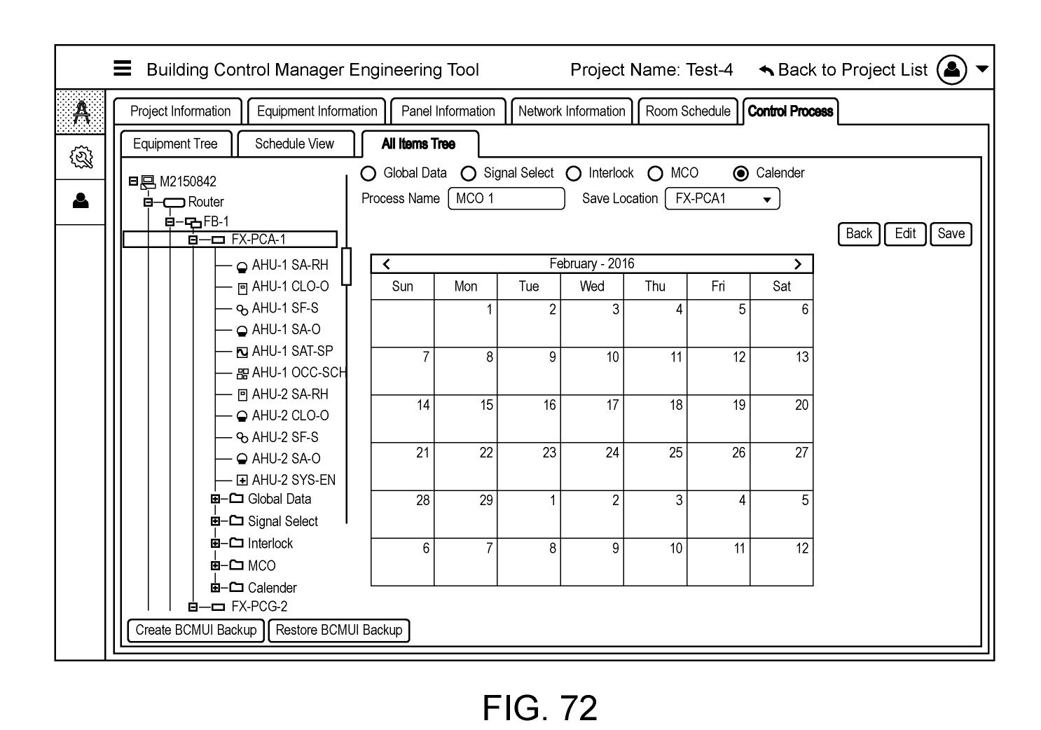

FIG. 70 illustrates the MCO object interface of the all items tree, according to one embodiment. The MCO object may issue a series of commands to multiple objects by means of a single command action. Commanding this object may result in the execution of commands for a given state. The MCO object may support states 1-4. In one embodiment, the user may be able to configure an MCO object using the MCO object interface. The user may further be able to view/edit the MCO object as shown in FIG. 71. FIG. 72 illustrates the calendar object interface of the all items tree. The calendar object may be used behind the scenes by the scheduling feature by maintaining a list of dates designated as exceptions to the normal schedule. The user may be able to add calendar objects, as well as view or edit added calendar objects via the calendar object interface.

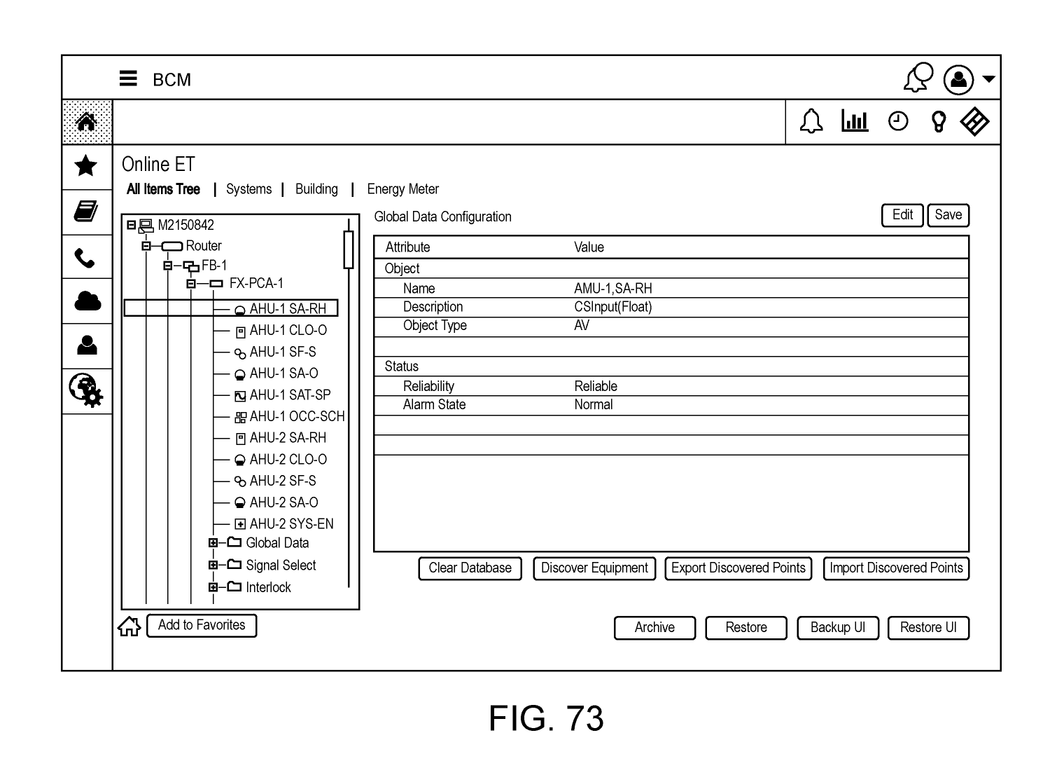

FIG. 73 is a screen shot illustrating a BCM UI home screen, according to some embodiments. In some embodiments, the BCM UI may be accessed via a web browser. FIG. 73 further illustrates the user interface associated with the Online ET tab, associated with the engineering tool. The Online ET screen can allow for a user to rename a setup module as an Admin module, thereby only allowing user with administrative access to view it. A user can further add user roles, add user details, and add customer details, such as by renaming contract information to match what is shown in the BCM ET. Further, the Online ET tab interface may allow a user to add an Online Engineering Tool, which can allow the user to add point discover, add online engineering tools, add buildings, add systems, energy meters, and the like. In some embodiments, only super users may be able to access the Online ET tab interface.

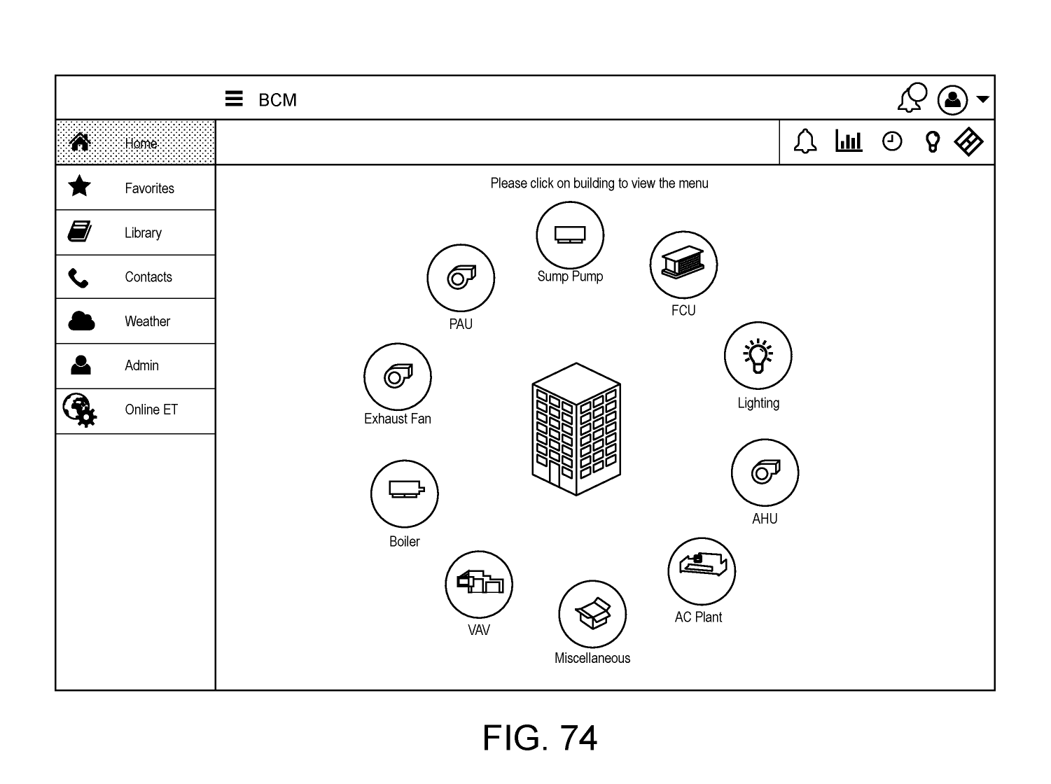

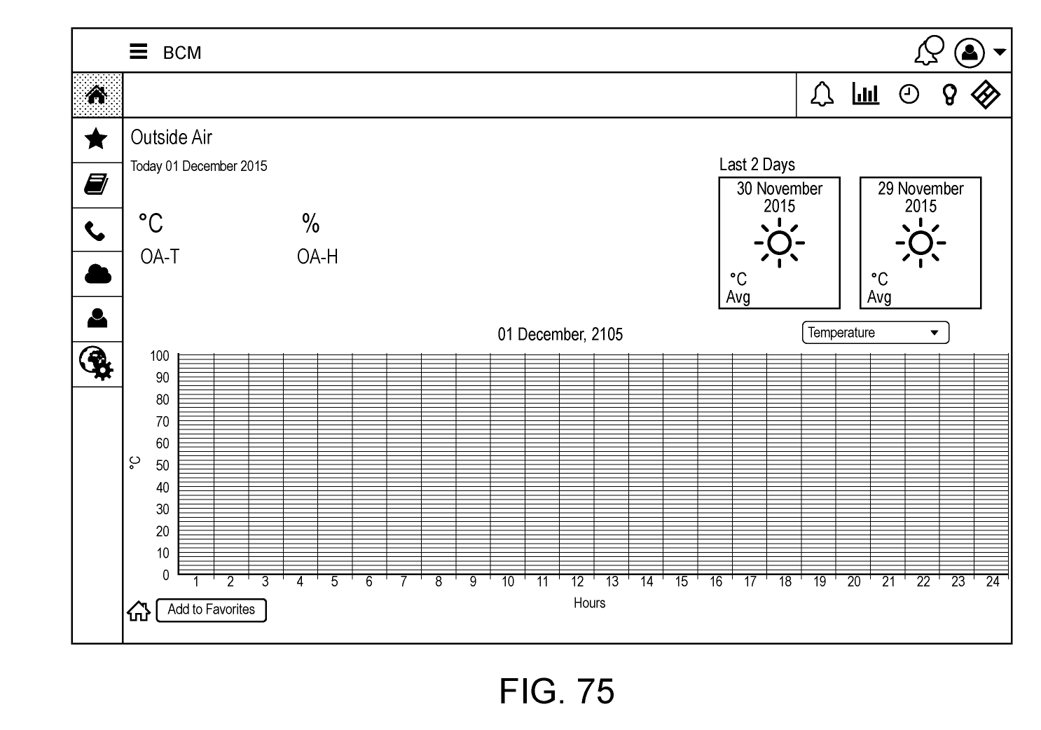

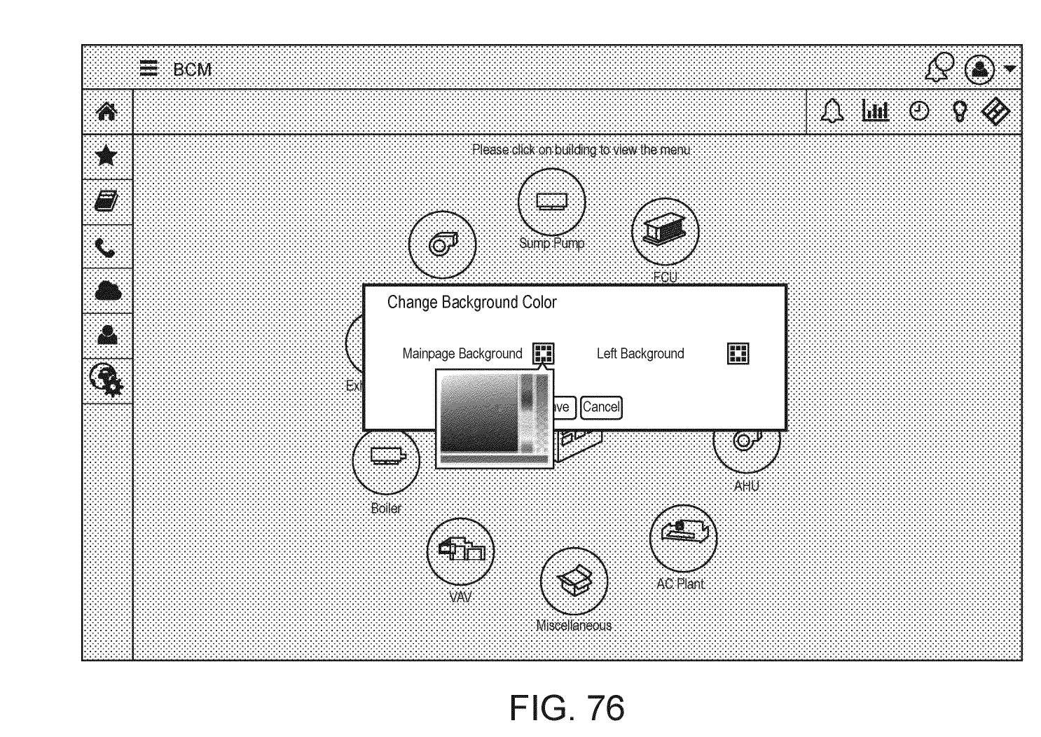

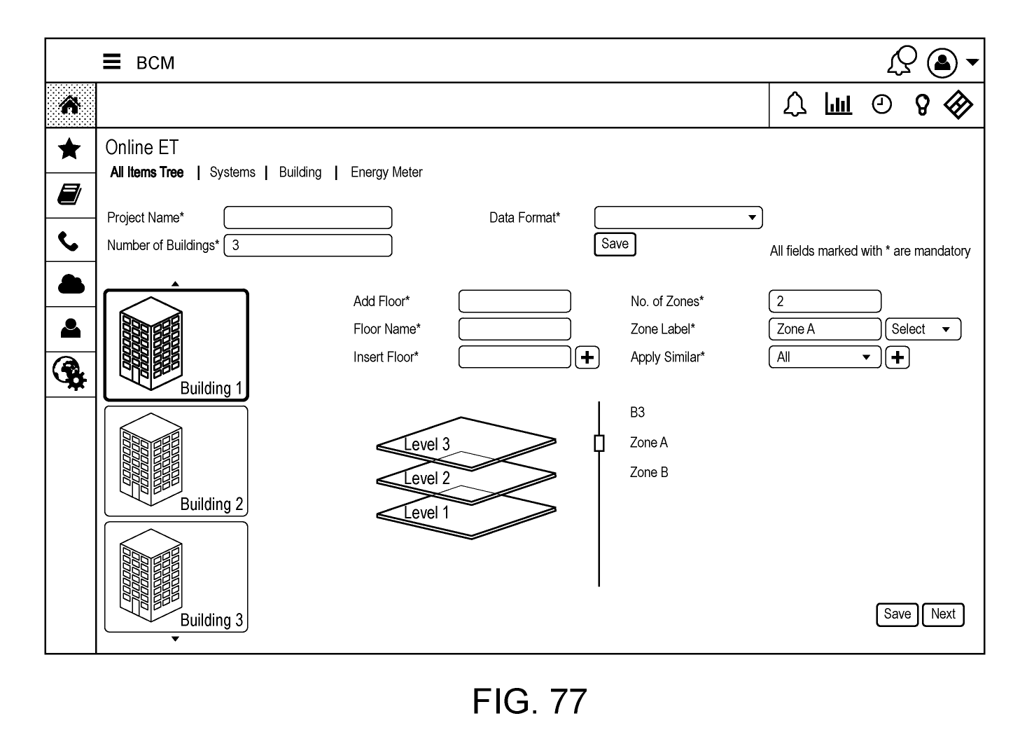

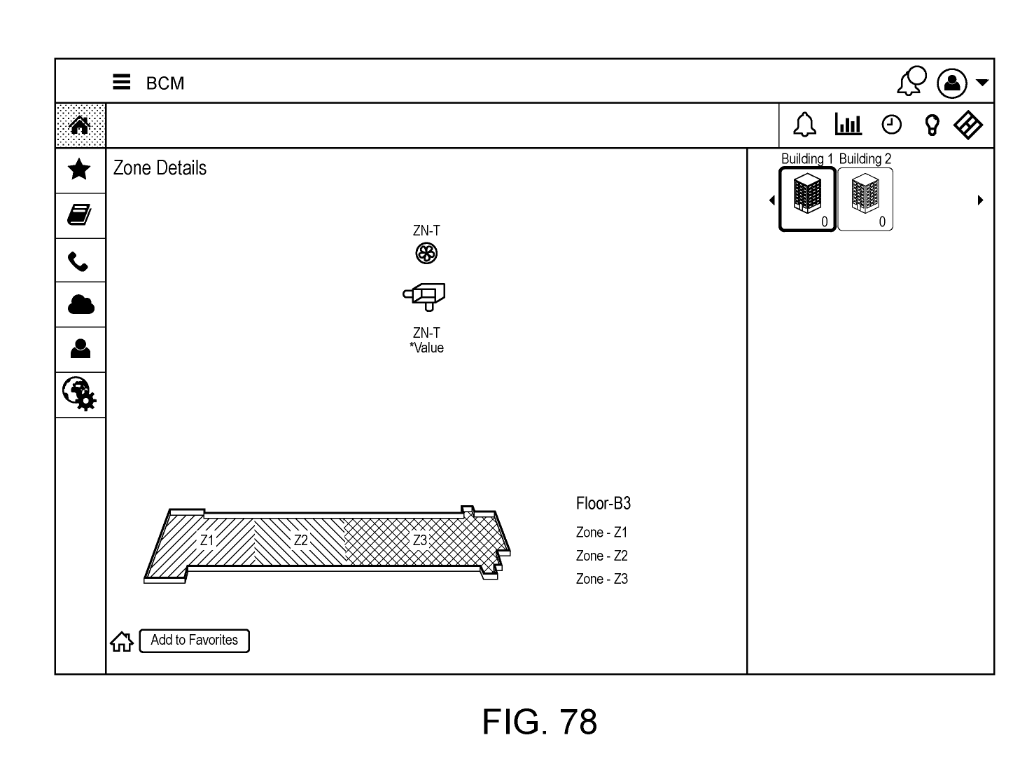

FIG. 74 is a screenshot of a floor plan interface of the BCM UI. The floor plan interface of the BCM UI can allow a user to select one or more devices associated with a certain floor of a building. FIG. 75 is a screenshot illustrating a detailed equipment view. The detailed equipment view of FIG. 75 shows outside air and weather information, such as a weather forecast. Further, the detailed equipment view may have the ability to provide trending of temperature over time, in a trending portion. Turning now to FIG. 76, a change background user interface of the BCM UI is shown, according to some embodiments. The change background user interface may be used to allow a user to modify the background color of the BCM UI. Turning now to FIG. 77, a screen shot illustrating a floor summary interface of the BCM UI is shown, according to some embodiments. The floor summary interface may allow a user to modify information associated with a given floor, such as providing a name of the floor, a number of zones, zone labels, etc. Turning now to FIG. 78, a zone details interface of the BCM UI is shown, according to some embodiments, the zone details interface can provide a user with various information related to a selected zone.

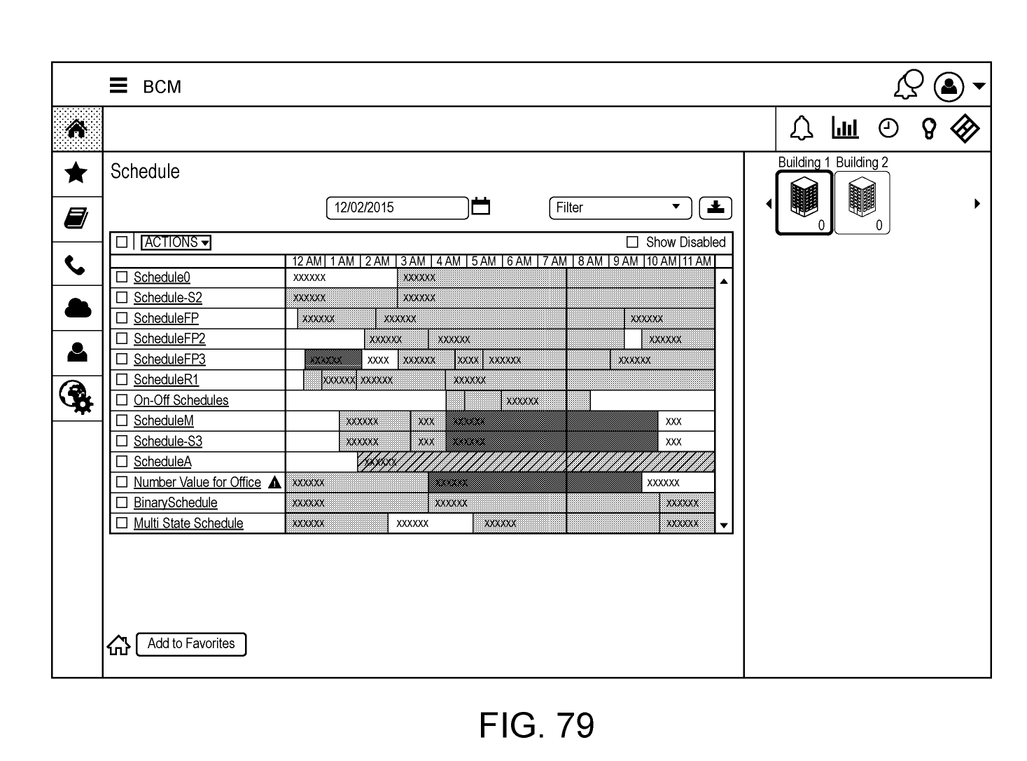

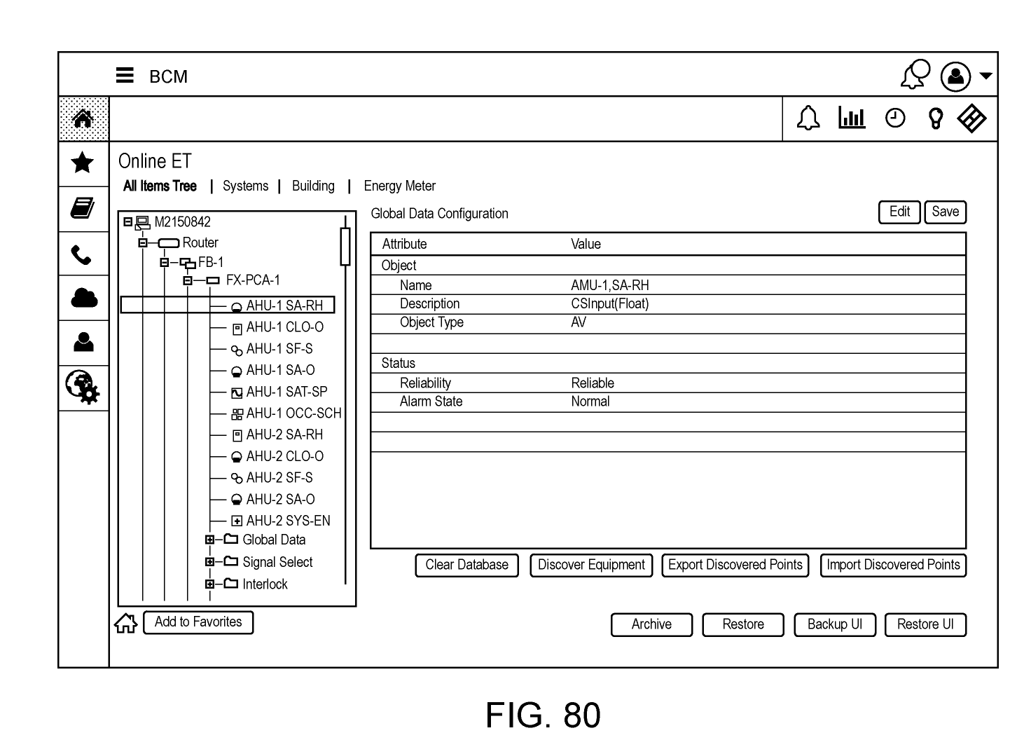

Turning now to FIG. 79, a screenshot illustrating a schedule interface of the BCM UI is shown, according to some embodiments. The schedule interface can allow a user to see the schedule for one or more pieces of equipment in a building. The schedules can be enabled and disabled via the BCM UI, and a user may be able to mass edit all schedules from the schedule interface. The schedule interface may support MV point, and may allow for DCOM settings to be automated. FIG. 80 is a screenshot illustrating a global data configuration interface of the BCM UI. The global data configuration interface can allow for a user to modify various global data points within the BCM. For example, a user may be able to add/edit references for all control objects, such as interlocks, MCOs, signal selections, global data and calendaring functions. Further, the global data configuration interface may allow for a user to commission all control processes. Where the engineering tool is an offline engineering tool, the user may be able to add empty objects or dummy references for all control objects.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building control system, the system comprising:
a database;
a processing circuit in communication with the database, comprising:
an engineering tool comprising:
a controller application file manager configured to generate one or more controller application files, wherein the controller application file manager includes a controller application file application programming interface, the interface configured to use one or more dynamic-link libraries to share redistributable packages of at least one of data and logic needed to generate controller application files.

2. The system of claim 1, wherein the controller application file application programming interface is configured to allow internal and third-party tools to access and modify controller application files.

3. The system of claim 1, wherein the dynamic-link libraries include at least one of a classes library, an objects library, a control application logic library, and a packages library.

4. The system of claim 1, wherein the engineering tool further comprises an object engine configured to manage a plurality of object data types.

5. The system of claim 1, wherein the data object types are at least one of point objects, multi command objects, schedule objects, interlock objects, signal select objects, global data objects, and calendar objects.

6. The system of claim 1, wherein the engineering tool further comprises an object engine configured to manage a plurality of object data types.

7. The system of claim 1, further comprising a user interface.

8. The system of claim 7, wherein the user interface is a workstation.

9. A building control system, the system comprising:
a database;
a processing circuit in communication with the database, comprising:
an engineering tool comprising:
a load manager configured to load one or more controller application files onto one or more control devices, wherein the load manager includes a controller application file application programming interface, the interface configured to use one or more dynamic-link libraries to share redistributable packages of at least one of data and logic needed to load controller application files onto one or more control devices.

10. The system of claim 9, wherein the controller application file application programming interface is configured to allow internal and third-party tools to load controller application files.

11. The system of claim 9, wherein the dynamic-link libraries include at least one of a classes library, an objects library, a control application logic library, and a packages library.

12. The system of claim 9, wherein the engineering tool further comprises an object engine configured to manage a plurality of object data types.

13. The system of claim 9, wherein the data object types are at least one of point objects, multi command objects, schedule objects, interlock objects, signal select objects, global data objects, and calendar objects.

14. The system of claim 9, wherein loading controller application files onto one or more control devices includes compressing controller application files, checking the firmware version of one or more control devices, and possibly updating the firmware of the one or more control devices.

15. The system of claim 9, further comprising a user interface.

16. The system of claim 15, wherein the user interface is a workstation.

17. A method for configuring a building control system, the system comprising:
determining a list of parameters associated with the building management system;
importing the list of parameters into an engineering tool;
generating one or more controller application files based on the imported parameters using the engineering tool; and
loading the one or more controller application files onto on or more field devices.

18. The method of claim 17, further comprising receiving information from at least one of a third party engineering tool and a commissioning tool via a controller application file API.

19. The method of claim 17, wherein the controller application files are configured to operate one or more field controllers.

20. The method of claim 17, further comprising modifying logic associated with the one or more field devices using the engineering tool.
